(19) United States
(12) Patent Application Publication
(10) Pub. No.: US 2010/0027244 A1
(43) Pub. Date: Feb. 4, 2010

(54) FLUORESCENT LAMP, AND LIGHT EMITTING DEVICE AND DISPLAY DEVICE USING FLUORESCENT LAMP

(76) Inventors: Hideki Wada, Osaka (JP); Kazuhiro Matsuo, Osaka (JP); Toshihiro Terada, Hyogo (JP); Yoshinari Fuchida, Osaka (JP); Masakazu Yamaguchi, Kyoto (JP); Ryo Minamihata, Kyoto (JP); Mitsuharu Kawasaki, Kyoto (JP); Kazuhiro Kumada, Hyogo (JP); Hiroshi Sakurai, Osaka (JP); Shigeru Ido, Osaka (JP); Masanobu Murakami, Osaka (JP); Taku Ikeda, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/520,982

(22) PCT Filed: Jan. 31, 2008
(86) PCT No.: PCT/JP2008/051486

§ 371 Date: Jun. 23, 2009

(30) Foreign Application Priority Data
Feb. 1, 2007 (JP) 2007-023338
Feb. 9, 2007 (JP) 2007-030565
Mar. 2, 2007 (JP) 2007-053161
Mar. 14, 2007 (JP) 2007-065588
Mar. 30, 2007 (JP) 2007-094445

(51) Int. Cl. G09F 13/08; H01J 63/04; H01J 61/52; H01J 61/94

(52) U.S. Cl. 362/97.1; 313/485; 313/486; 313/493; 313/40; 313/1

(57) ABSTRACT

A fluorescent lamp has a glass container that has a phosphor layer formed on an inner surface of the glass container, and that is hermetically sealed, wherein phosphors of the phosphor layer include a blue phosphor, a green phosphor, and a red phosphor, a main luminescence peak of the blue phosphor exists in a wavelength region in a range of 430 nm to 460 nm inclusive, a half-value width of a spectrum of the main luminescence peak of the blue phosphor is less than or equal to 50 nm, a main luminescence peak of the green phosphor exists in a wavelength region in a range of 510 nm to 530 nm inclusive, a half-value width of a spectrum of the main luminescence peak of the green phosphor is less than or equal to 30 nm, and a main luminescence peak of the red phosphor exists in a wavelength region in a range of 600 nm to 780 nm inclusive, and a difference between a wavelength of the main luminescence peak of the blue phosphor and a wavelength of the main luminescence peak of the green phosphor is in a range of 70 nm to 90 nm inclusive.

### TECHNICAL FIELD

The present invention relates to a fluorescent lamp, a light emitting device having the fluorescent lamp, and a display device having the fluorescent lamp.

### BACKGROUND ART

While color reproducibility in liquid crystal display devices such as liquid crystal color televisions has been improved as part of the developments of the image quality in the liquid crystal display devices in recent years, there has been a demand for increasing the reproducible chromaticity range in cold cathode fluorescent lamps, external electrode fluorescent lamps, or hot cathode fluorescent lamps that are used as a light source of a backlight unit of a liquid crystal display device.

In response to such a demand, a fluorescent lamp is proposed that uses, for example, a blue phosphor having a luminescence peak in a wavelength region in the range of 430 nm to 460 nm inclusive, a green phosphor having a luminescence peak in a wavelength region in the range of 510 nm to 530 nm inclusive, and a red phosphor having a luminescence peak in a wavelength region in the range of 600 nm to 620 nm inclusive (Patent Document 1), as a light source of a backlight unit. The use of such an improved three-wavelength light-emitting fluorescent lamp was expected to increase the chromaticity range. Specifically, in CIE 1931 chromaticity diagram, the area of a triangle created by connecting the three chromaticity coordinate values of the improved three-wavelength light-emitting phosphors was expected to be larger than the area of a triangle created by connecting the three chromaticity coordinate values of conventional three-wavelength light-emitting phosphors. The following describes this point with use of FIGS. 8 and 9.

FIG. 8 schematically shows the luminescence spectrum of each of the improved three-wavelength light-emitting fluorescent lamp (hereinafter referred to as “improved fluorescent lamp”) and the conventional three-wavelength light-emitting fluorescent lamp (hereinafter referred to as “conventional fluorescent lamp”) and the conventional three-wavelength light-emitting fluorescent lamp (hereinafter referred to as “convention fluorescent lamp”). In FIG. 8, Bp, Gp2, and Rp represent the luminescence spectra of the phosphors in the improved fluorescent lamp, wherein Bp represents the luminescence spectrum of a blue phosphor having a luminescence peak at 450 nm, Gp2 represents the luminescence spectrum of a green phosphor having a luminescence peak at 519 nm, and Rp represents the luminescence spectrum of a red phosphor having a luminescence peak at 618 nm. A difference between the luminescence peak wavelength of the blue phosphor and the luminescence peak wavelength of the green phosphor in the improved fluorescent lamp is 69 nm.

In FIG. 8, the conventional fluorescent lamp has the same blue phosphor and the red phosphor as the improved fluorescent lamp. However, the conventional fluorescent lamp has a green phosphor that is different from the improved fluorescent lamp, such as a phosphor having the luminescence peak of 550 nm as shown in Gp1. A difference between the luminescence peak wavelength of the blue phosphor and the luminescence peak wavelength of the green phosphor in the conventional fluorescent lamp is greater than or equal to 95 nm.

In FIG. 9 is the CIE 1931 chromaticity diagram showing the luminescence of the improved fluorescent lamp and that of the conventional fluorescent lamp. Specifically, R represents the chromaticity coordinates of the light of a fluorescent lamp that only uses the red phosphor and emits red light, after the light has transmitted through a red filter of a liquid crystal display device (herein referred to as “red filter”). B1 represents the chromaticity coordinates of the light of a fluorescent lamp that only uses the blue phosphor and emits blue light, after the light has transmitted through a blue filter of the liquid crystal display device (hereinafter referred to as “blue filter”). Also, G1 represents the chromaticity coordinates of the light of a fluorescent lamp that only uses the green phosphor used for the conventional fluorescent lamp and emits green light, after the light has transmitted through a green filter of the liquid crystal display device (hereinafter referred to as “green filter”), and G2 represents the chromaticity coordinates of the light of a fluorescent lamp that only uses the green phosphor used for the improved fluorescent lamp and emits green light, after the light has transmitted through the green filter. Hereinafter, a fluorescent lamp that only uses a red phosphor is referred to as a red fluorescent lamp, a fluorescent lamp that only uses a blue phosphor is referred to as a blue fluorescent lamp, a fluorescent lamp that only uses a green phosphor is referred to as a green fluorescent lamp, and a fluorescent lamp that uses all the phosphors and emits white light is referred to as a white fluorescent lamp.

As shown in FIG. 9, the area of a triangle B1-G2-R created by connecting the three chromaticity coordinate values of the improved fluorescent lamp is larger than the area of a triangle B1-G1-R created by connecting the three chromaticity coordinate values of the conventional fluorescent lamp is larger than that of the conventional fluorescent lamp, thereby improving the color reproducibility.
Patent Document 1: Japanese Patent Application Publication No. 10-334854.

### DISCLOSURE OF THE INVENTION

### The Problems the Invention Is Going to Solve

As described above, it is possible to increase the chromaticity range of the improved fluorescent lamp if the evaluation is performed for a luminescence of each of the colors, namely red, blue, and green. However, the inventors of the present invention have found that, when the improved fluorescent lamp is actually used as the light source of a backlight unit of a liquid crystal display device, the chromaticity range of the light emitted from the liquid crystal display device is smaller than the chromaticity range shown by the above-mentioned triangle B1-G2-R.

The following describes this point with use of FIG. 9. In FIG. 9, B2 represents the chromaticity coordinates of light after the white light emitted from the improved fluorescent lamp has transmitted through the blue filter. Note that, in FIG. 9, R represents the chromaticity coordinates of light after the white light has transmitted through the red filter, and G2 represents the chromaticity coordinates of light after the white light has transmitted through the green filter, since the chromaticity coordinates thereof are not significantly different from the above-described R and G2. Therefore, in FIG. 9, the area of the triangle B2-G2-R represents the color gamut area of luminescence of the improved fluorescent lamp after the light emitted from the improved fluorescent lamp has transmitted through the color filters of the liquid crystal display device.

As shown in FIG. 9, the color gamut area of the triangle B2-G2-R is smaller than that of the triangle B1-G2-R. Here, the triangle B2-G2-R is obtained by having the white light of the improved fluorescent lamp transmit through each of the color filters, and the triangle B1-G2-R is obtained by having the lights of the respective single-color fluorescent lamps transmit through the corresponding color filters. The color gamut area of the triangle B2-G2-R is smaller because the chromaticity coordinates of blue light that transmits through the blue filter have shifted toward the longer wavelength due to an overlap area D in FIG. 8 where the light emission area of the blue phosphor overlaps the light emission area of the green phosphor.

The present invention solves the above-described problem, and provides a fluorescent lamp having higher color reproducibility than a conventional fluorescent lamp, even after white light that is actually used transmits through the color filters, a light emitting device having the fluorescent lamp, and a display device having the fluorescent lamp.

### Means to Solve the Problems

The present invention provides a fluorescent lamp having a glass container that has a phosphor layer formed on an inner surface of the glass container, and that is hermetically sealed, wherein phosphors of the phosphor layer include a blue phosphor, a green phosphor, and a red phosphor, a main luminescence peak of the blue phosphor exists in a wavelength region in a range of 430 nm to 460 nm inclusive, a half-value width of a spectrum of the main luminescence peak of the blue phosphor is less than or equal to 50 nm, a main luminescence peak of the green phosphor exists in a wavelength region in a range of 510 nm to 530 nm inclusive, a half-value width of a spectrum of the main luminescence peak of the green phosphor is less than or equal to 30 nm, and a main luminescence peak of the red phosphor exists in a wavelength region in a range of 600 nm to 780 nm inclusive, and a difference between a wavelength of the main luminescence peak of the blue phosphor and a wavelength of the main luminescence peak of the green phosphor is in a range of 70 nm to 90 nm inclusive.

Also, the present invention provides a light emitting device comprising a plurality of the fluorescent lamps.

Furthermore, the present invention provides a display device including a screen unit and the light emitting device.

### Effects of the Invention

With the above-described construction, the fluorescent lamp according to the present invention has a smaller overlap portion in which the luminescence peak spectrum of the blue phosphor overlaps the luminescence peak spectrum of the green phosphor, compared to the overlap portion of a conventional lamp. Therefore, it is possible to reduce the above-described negative effect caused by the overlay portion, thereby having improved color reproducibility after the light of the fluorescent lamp has transmitted through the color filters.

Also, it is possible to realize a display device having high color reproducibility, by forming a light-emitting device with use of a plurality of the fluorescent lamps according to the present invention and using the light-emitting device for a liquid crystal display device, etc.

### BRIEF DESCRIPTION OF THE DRAWING

FIG. 1 is an enlarged sectional view showing one example of a fluorescent lamp according to an embodiment 1 of the present invention;

FIG. 2 is a partial cutaway perspective view showing one example of a display device having the fluorescent lamp according to the embodiment 1 of the present invention;

FIG. 3 is a schematic perspective view showing one example of a light emitting device having the fluorescent lamp according to the embodiment 1 of the present invention;

FIG. 4 shows the luminescence spectrum of each color phosphor used for the fluorescent lamp according to the embodiment 1;

FIG. 5 shows the luminescence spectrum of each color phosphor used for a fluorescent lamp according to a comparative example 1;

FIG. 6 shows the luminescence spectrum of a green phosphor used for a fluorescent lamp according to an embodiment 2;

FIG. 7 shows the luminescence spectrum of a green phosphor used for a fluorescent lamp according to an embodiment 3;

FIG. 8 schematically shows the luminescence spectrum of each color phosphor used for an improved fluorescent lamp and a conventional fluorescent lamp;

FIG. 9 shows CIE 1931 chromaticity diagram of each of the luminescence of the improved fluorescent lamp and the luminescence of the conventional fluorescent lamp;

FIG. 10 shows the spectral distribution transmission characteristics of color filters used in the embodiment 1;

FIG. 11 shows the CIE 1931 chromaticity diagram before and after the light of the fluorescent lamp of the embodiment 1 transmits through the color filters;

FIG. 12 shows the CIE 1931 chromaticity diagram before and after the light of the fluorescent lamp of the comparative example 1 transmits through the color filters;

FIG. 13 is a half-sectional view showing a general construction of an external electrode fluorescent lamp according to an embodiment 2-1;

FIG. 14 shows a part of a manufacturing process of the external electrode fluorescent lamp;

FIG. 15 shows a part of the manufacturing process of the external electrode fluorescent lamp;

FIG. 16 shows a part of the manufacturing process of the external electrode fluorescent lamp;

FIG. 17 shows a part of the manufacturing process of the external electrode fluorescent lamp;

FIG. 18 is a partial cutaway perspective view showing a general construction of a cold cathode fluorescent lamp according to an embodiment 2-2;

FIG. 19 is a vertical sectional view showing an end portion of the cold cathode fluorescent lamp according to the embodiment 2-2;

FIG. 20A is a vertical sectional view showing an end portion of a cold cathode fluorescent lamp according to an embodiment 2-3-1, FIG. 20B is a magnified view of A part in FIG. 20A, and FIG. 20C is a magnified view of B part in FIG. 20A;

FIG. 21 is a perspective view of a metal sleeve included in the cold cathode fluorescent lamp according to the embodiment 2-3-1;

FIG. 22A is a vertical sectional view showing an end portion of a cold cathode fluorescent lamp according to an embodiment 2-3-2, FIG. 22B is a sectional view taken along the line C-C in FIG. 22A;

FIG. 23A is a vertical sectional view showing an end portion of a cold cathode fluorescent lamp according to an embodiment 2-3-3, FIG. 23B is a sectional view taken along the line D-D in FIG. 23A;

FIG. 24A is a vertical sectional view showing an end portion of a cold cathode fluorescent lamp according to a variation 1 of the embodiment 2-3-3, and FIG. 24B is a vertical sectional view of an end portion of a cold cathode fluorescent lamp according to a variation 2 of the embodiment 2-3-3;

FIG. 25 is an exploded perspective view showing the construction of a backlight unit according to the embodiment;

FIG. 26 is a vertical sectional view showing a general construction of a cold cathode fluorescent lamp according to an embodiment 3;

FIG. 27 shows a part of a formation process of a phosphor layer, which is included in a manufacturing process of the cold cathode fluorescent lamp according to the embodiment 3;

FIG. 28 shows a particle size distribution chart of a red phosphor (YOX) and a conventional particle size distribution of a blue phosphor (SCA);

FIG. 29 mainly shows a conventional particle size distribution of the blue phosphor (SCA), and particle size distributions of the blue phosphor (SCA) according to the embodiment;

FIG. 30 shows a tube-end chromaticity difference between the case of using each of the blue phosphors according to the embodiment 3 and the case of using the conventional blue phosphor;

FIGS. 31A and 31B show microscopic pictures of the front surface of a phosphor layer in the cold cathode fluorescent lamp according to the embodiment 3;

FIG. 32 is a graph showing a change of luminance efficiency for each phosphor, with respect to a lamp current;

FIG. 33 shows the spectra of green phosphors;

FIG. 34 is a partial cutaway perspective view showing a general construction of a backlight unit of a directly-below type according to the embodiment 3;

FIG. 35 is a block diagram showing the construction of a lighting device for the backlight unit;

FIG. 36 is a perspective view showing the main construction of a liquid crystal display device according to an embodiment 4 of the present invention;

FIG. 37 is a schematic perspective view showing the construction of a backlight unit 2102 according to the embodiment 4 of the present invention;

FIG. 38 is a partial cutaway view showing a general construction of a cold cathode fluorescent lamp 2220 according to the embodiment 4 of the present invention;

FIG. 39 is a graph showing the spectral characteristic of an infrared cut film 2308 according to the embodiment 4 of the present invention;

FIGS. 40A to 40D are schematic views each showing a positional relationship among a cold cathode fluorescent lamp 2501, an outer tube having an infrared cut film, and an infrared sensor 503;

FIGS. 41A to 41B each show (i) a positional relationship among a cold cathode fluorescent lamp 2601, an outer tube having an infrared cut film, and an infrared sensor 2603, and (ii) the number of the outer tubes 2602 each having an infrared cut film;

FIG. 42 is a table showing a change of an infrared cut ratio caused by a change of a duty ratio and the presence and absence of the infrared cut film;

FIG. 43 is a picture of a cold cathode fluorescent lamp that is taken by an infrared camera, over a liquid crystal panel;

FIG. 44 is a graph showing the spectral intensity of light emitted from the cold cathode fluorescent lamp, when the infrared cut film is not used;

FIG. 45 is a graph showing the spectral sensitivity of each commercial infrared sensor in the infrared wavelength region and the peak positions of the spectral intensity of the cold cathode fluorescent lamp;

FIG. 46 is a graph representing the spectrum characteristic of the infrared cut film according to the embodiment 4 of the present invention;

FIG. 47 is a graph that compares the amount of infrared rays reduced in a conventional technique and the amount of infrared rays reduced in the present invention;

FIG. 48 is a table showing a relationship between the sizes of a liquid crystal display and the amount of infrared rays;

FIG. 49 is a sectional view that schematically shows the construction of an infrared cut plate according to a modification (3) of the present invention;

FIG. 50 shows a liquid crystal display device according to an embodiment, part of which is cut away so as to show the inside of the liquid crystal display device;

FIG. 51 is an exploded perspective view showing a general construction of a backlight unit according to the present embodiment;

FIG. 52 is a plane view showing the backlight unit without a fixing frame and a translucent plate;

FIG. 53 shows a cross section seen from the arrow direction, the cross section being taken along the line A-A in FIG. 52;

FIG. 54 is a perspective view showing a bushing 3021 provided at one end of a discharge lamp 3008;

FIG. 55 shows a cross section seen from the arrow direction, the cross section being taken along the line B-B in FIG. 53;

FIG. 56 is a magnified sectional view of an end portion of a lamp according to an embodiment 5-2;

FIG. 57 is a backlight unit according to the embodiment 5-2;

FIG. 58 shows a modification (1) of the embodiment 5-2; and

FIG. 59 shows a modification (2) of the embodiment 5-2.

### DESCRIPTION OF CHARACTERS

10 fluorescent lamp

13 phosphor

20 cold cathode fluorescent lamp

101 display device

102 fluorescent lamp unit

103 liquid crystal display unit

### BEST MODE FOR CARRYING OUT THE INVENTION

### Embodiment 1

### Embodiment 1-1

The following describes an embodiment 1-1 of a fluorescent lamp of the present invention. The phosphor of the fluorescent lamp of the present invention includes a blue phosphor, a green phosphor, and a red phosphor. The blue phosphor has a luminescence peak in a wavelength region in the range of 430 nm to 460 nm inclusive. The green phosphor has a luminescence peak in a wavelength region in the range of 510 nm to 530 nm inclusive. The red phosphor has a luminescence peak in a wavelength region in the range of 600 nm to 780 nm inclusive. These phosphors increase the color gamut area of luminescence of the fluorescent lamp, thereby realizing the high color reproducibility of the lamp per se. The luminescence peak of the blue phosphor is preferably in a wavelength region in the range of 435 nm to 447 nm inclusive, and the luminescence peak of the green phosphor is preferably in a wavelength region in the range of 515 nm to 520 nm inclusive. Note that the wavelength of a luminescence peak for each phosphor can be adjusted in accordance with the ratio of components that is described below, etc. However, with respect to a desired wavelength, the wavelength of a phosphor of a lamp that is actually manufactured varies in the range of ±2 nm.

Also, in the fluorescent lamp of the present invention, a difference between (i) the wavelength of the main luminescence peak of the blue phosphor and (ii) the wavelength of the main luminescence peak of the green phosphor is set to be in the range of 70 nm to 90 nm inclusive. This either eliminates or reduces an overlap region in which a luminescence region of the blue phosphor overlaps a luminescence region of the green phosphor. Accordingly, the color gamut area of luminescence in a display device per se can be maintained even after the white light of the fluorescent lamp of the present invention transmits through the color filters of a liquid crystal display device and such, thereby preventing a decrease in color reproducibility. In the present specification, the main luminescence peak refers to a luminescence peak whose luminescence intensity is the highest. Note here that it is even more preferable that a difference between (i) the wavelength of the main luminescence peak of the blue phosphor and (ii) the wavelength of the main luminescence peak of the green phosphor is set to be in the range of 80 nm to 90 nm inclusive.

As the blue phosphor having the luminescence peak in the wavelength region in the range of 430 nm to 460 nm inclusive, it is possible to use, for example, europium-activated strontium chloroapatite [Sr₁₀(PO₄)₆Cl₂:Eu²⁺] (Abbreviation: SCA), europium-activated strontium calcium phosphate [(Sr, Ca)₂P₂O₇:Eu²⁺] (Abbreviation: SPO), etc.

Here, typical luminescence peak wavelengths of SCA and SPO are 447 [nm] and 435 [nm], respectively.

Also, in the SCA and SPO, it is possible to change the wavelength of a luminescence peak and the below-described half-value width, by adding coactivators Ca and Ba and changing the mole ratio [mol %] of the coactivators Ca and Ba.

As the green phosphor having the luminescence peak in the wavelength region in the range of 510 nm to 530 nm inclusive, it is possible to use, for example, manganese-activated cerium-magnesium zinc aluminate [Ce(Mg,Zn)Al₁₁O₁₉:Mn²⁺] (abbreviation: CMZ), europium-and-manganese-activated barium magnesium aluminate [BaMg_{2 Al}₁₆O₂₇:Eu²⁺,Mn²⁺], [BaMgAl₁₀O₁₇:Eu²⁺,Mn²⁺] (Abbreviation: BAM-G), manganese-activated magnesium gallate [MgGa₂O₄:Mn²⁺], manganese-activated magnesium gallate [MgGa₂O₄:Mn²⁺] (Abbreviation: MGM), manganese-activated zinc silicate [Zn₂SiO₄:Mn²⁺] (Abbreviation: ZSM), etc.

Here, typical luminescence peak wavelengths of CMZ, BAM-G, and ZSM are 519 [nm], 515 [nm] and 525 [nm], respectively.

As the red phosphor having the luminescence peak in the wavelength region in the range of 600 nm to 780 nm inclusive, it is possible to use, for example, europium-activated yttrium oxysulfide [Y₂O₂S:Eu³⁺] (Abbreviation: YOS), and europium-activated yttrium phosphovanadate [Y(P,V)O₄:Eu³⁺] (Abbreviation: YPV), manganese-activated magnesium fluoro-germanate [3.5 MgO.0.5 MgF₂.GeO₂:Mn⁴⁺] (Abbreviation: MFG), europium-activated yttrium vanadate [YVO₄:Eu³⁺] (Abbreviation: YVO), europium-activated yttrium oxide [Y₂O₃:Eu²⁺] (Abbreviation: YOX), etc.

Here, typical luminescence peak wavelengths of YOS, YPV, MFG, YVO, and YOX are 625 [nm], 619 [nm] and 655 [nm], 619 [nm], and 611 [nm], respectively.

A difference between (i) the main luminescence peak wavelength of the blue phosphor and (ii) the main luminescence peak of the green phosphor can be set in the range of 70 nm to 90 nm inclusive, by combining the blue phosphor and the green phosphor described above.

Furthermore, the half-value width of the main luminescence peak spectrum of the green phosphor is preferably less than or equal to 30 nm. This minimizes the overlap between the green spectrum and the blue spectrum, thereby widening the range of color reproducibility. In the green phosphors described above, phosphors having the half-value width of the main luminescence peak spectrum in the range of less than or equal to 30 nm include MGM, BAM-G, CMZ, etc.

Also, the half-value width of the main luminescence peak spectrum of the blue phosphor is preferably less than or equal to 50 nm. This minimizes the overlap between the green spectrum and the blue spectrum, thereby widening the range of color reproducibility. In the blue phosphors described above, phosphors having the half-value width of the main luminescence peak spectrum in the range of less than or equal 50 nm include SCA, SBCA, SPO, etc. Note that, as described above, it is possible to adjust the half-value widths of SBCA and SPO by changing the mole ratio [mol %] of the coactivators Ca and Ba in the entire phosphor.

In the case of using europium-and-manganese-activated barium magnesium aluminate (BAM-G) as the above-described green phosphor, the ratio of europium and manganese included in BAM-G is preferably in the range of 4:6 to 1:9 inclusive, so as to further improve brightness. This is because a comparison between the below-described embodiment 2 and embodiment 3 shows that, when the mole ratio of the coactivators is in the above-described range, (i) the luminescence spectrum peak of BAM-G is substantially a single peak, (ii) the overlap of the green spectrum and the blue spectrum is reduced, and (iii) a range of color reproducibility is wider. Note here that the half-value width of the luminescence spectrum peak of BAM-G is 30 [nm] when the luminescence spectrum has a substantially single peak.

Also, at least one of the blue, green, and red phosphors that is selected is preferably covered with one of yttrium oxide (Y₂₃) and lanthanum oxide (La₂O₃). Especially when BAM-G is used as the green phosphor, the surface thereof is preferably covered with one of yttrium oxide and lanthanum oxide. This is because covering the surface with one of yttrium oxide and lanthanum oxide is considered to prevent a reaction between BAM-G and sodium included in sodium gas, which is widely used for the glass container of a fluorescent lamp. It is considered that the reaction is likely to change the composition of BAM-G and chromaticity,

The following describes an embodiment of the fluorescent lamp of the present invention, with reference to the drawings. The following embodiment shows an example of a cold cathode fluorescent lamp. However, the fluorescent lamp of the present invention is applicable to an external electrode fluorescent lamp and the like.

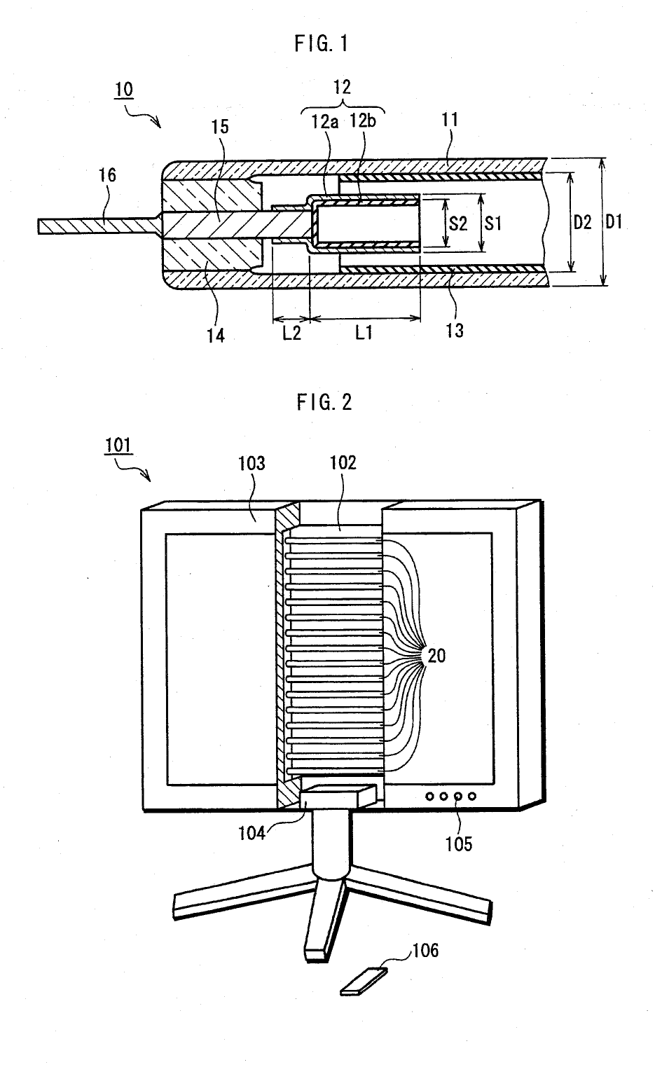

FIG. 1 is an enlarged sectional view showing one example of the fluorescent lamp of the present invention. Note that FIG. 1 only shows one end of the fluorescent lamp. The other end thereof is not shown in the figure since it is the same as the one end shown in FIG. 1.

As shown in FIG. 1, a fluorescent lamp 10 includes a glass container 11, and a pair of electrodes 12 that is provided inside the glass container 11.

The glass container 11 is made of, for example, borosilicate glass, and a phosphor 13 is applied to the inside of the glass container 11. Each end of the glass container 11 is sealed with a glass bead 14. The inside the glass container 11 is filled with 2 mg of mercury, and 60 Torr of a rare gas, such as argon or neon. Note that a mixed gas of argon and neon (Ar—5%, Ne—95%) is used as the rare gas in the present invention.

The phosphor 13 is a phosphor of a three-wavelength type, including a blue phosphor having a luminescence peak in the wavelength region in the range of 430 nm to 460 nm inclusive, a green phosphor having a luminescence peak in the wavelength region in the range of 510 nm to 530 nm inclusive, and a red phosphor having a luminescence peak in the wavelength region in the range of 600 nm to 780 nm inclusive. A difference between (i) the wavelength of the main luminescence peak of the blue phosphor and (ii) the wavelength of the main luminescence peak of the green phosphor is set to be in the range of 70 nm to 90 nm inclusive.

The following describes the electrodes 12. Each of the electrodes 12 includes a metal sleeve 12a and an emitter 12b provided for at least a part of the metal sleeve 12a. The metal sleeve 12a is made of a metal that withstands a temperature that is higher or equal to a firing temperature of the emitter 12b (550° C., for example). The metal sleeve 12a is made of, for example, nickel, molybdenum, tungsten, titanium, niobium, and such. One end of the metal sleeve 12a is inserted in an inner lead wire 15 that is made of tungsten, etc. and is sealed. The inner lead wire 15 is connected to an outer lead wire 16 through the glass bead 14. The emitter 12b is formed by performing a heat treatment after applying an emitter application fluid for the emitter 12b to the metal sleeve 12a. The emitter application fluid is made by mixing microparticulate magnesium oxide, etc., a binder, and a solution. Note here that the emitter 12b may be provided on the outer peripheral surface of each electrode 12.

Also, FIG. 1 shows an example of forming each of the electrodes 12 by inserting the base of the metal sleeve 12a into the inner lead wire 15 and connecting the base of the metal sleeve 12a and the inner lead wire 15 by welding. However, the electrodes 12 may also be formed with use of a metal sleeve having a bottomed cylindrical shape, and by connecting the outer bottom surface of the metal sleeve and the inner lead wire.

Note that the material of the glass container 11 is not limited to borosilicate glass, and may be lead glass, lead-free glass, soda-lime glass, and the like. This improves the in-dark start characteristic. In other words, glasses as described above are high in alkali metal oxide as typified by sodium oxide (Na₂O). For example, in a case where the alkali metal oxide is sodium oxide, natrium (Na) component leaches from the sodium oxide to the inner surface of the glass container 11 over time. It is considered that natrium that leaches into the inner end of the glass container 11 improves the in-dark start characteristic because of its low electronegativity.

In the external electrode fluorescent lamp, the content ratio of alkali metal oxide in the material of a glass container is preferably in the range of 3 [mol %] to 20 [mol %] inclusive.

For example, in a case where the alkali metal oxide is sodium oxide, the content ratio of the sodium oxide is preferably in the range of 5 [mol %] to 20 [mol %] inclusive. If the content ratio of the sodium oxide is less than 5 [mol %], the probability of the in-dark start time exceeding 1 second becomes high (in other words, the probability becomes high of the in-dark start time being within one second when the content ratio is greater than or equal to 5 [mol %]), and if exceeding 20 [mol %], prolonged use causes problems such as blackening (browning) or whitening of the glass container, resulting in a decline in brightness, a decline in the strength of the glass container, etc.

Also, using lead-free glass is preferable in consideration of environmental protection. However, there are cases in the manufacturing process of lead-free glass in which lead is included as an impurity. Therefore, glass that contains an impurity level of lead that is less than or equal to 0.1 [Wt %] is also defined as lead-free glass.

Note that adjusting the thermal expansion coefficient of the glass makes it possible to increase the sealing strength of the glass with the sealing material, such as the lead wire, of the cold cathode fluorescent lamp. For example, if the sealing material is made of tungsten (W), the thermal expansion coefficient of the glass is preferably in the range of 36×10⁻⁷ K⁻¹ to 45×10⁻⁷K⁻¹ inclusive. In such a case, setting the sum of the alkali metal component and the alkali earth metal component in the glass to be in the range of 4 [mol %] to 10 [mol %] inclusive enables the thermal expansion coefficient of the glass to be in the above-described range.

Also, when the sealing material is made of Kovar or molybdenum (Mo), the thermal expansion coefficient of the glass is preferably in the range of 45×10⁻⁷ K⁻¹ to 56×10⁻⁷ K⁻¹ inclusive. In such a case, setting the sum of the alkali metal component and the alkali earth metal component in the glass to be in the range of 7 [mol %] to 14 [mol %] inclusive enables the thermal expansion coefficient of the glass to be in the above-described range.

Also, when the sealing material is made of Dumet, the value of the thermal expansion coefficient of the glass is preferably in the vicinity of 94×10⁻⁷K⁻¹. In such a case, setting the sum of the alkali metal component and the alkali earth metal component in the glass to be in the range of 20 [mol %] to 30 [mol %] inclusive enables the thermal expansion coefficient of the glass to be in the above-described range.

Also, doping the glass with a transition metal oxide of a predetermined amount which varies depending on the type of oxide, makes it possible to absorb a 254 [nm] ultraviolet ray or a 313 [nm] ultraviolet ray. Specifically, when using titanium oxide (TiO₂) for example, doping the glass with titanium oxide at a composition ratio of greater than or equal to 0.05 [mol %] makes it possible to absorb a 254 [nm] ultraviolet ray, and doping the glass with titanium oxide at a composition ratio of greater than or equal to 2 [mol %] makes it possible to absorb a 313 [nm] ultraviolet ray. However, doping the glass with titanium oxide at a composition ratio of greater than 5.0 [mol %] causes the glass to devitrify. Therefore, it is preferable to dope the glass with titanium oxide at a composition ratio in the range of 0.05 [mol %] to 5.0 [mol %] inclusive.

Also, when cerium oxide (CeO₂) is used, doping it at a composition ratio greater than or equal to 0.05 [mol %] makes it possible to absorb a 254 [nm] ultraviolet ray. However, since doping cerium oxide at a composition ratio of greater than 0.5 [mol %] stains the glass, doping cerium oxide at a composition ratio in the range of 0.05 [mol %] to 0.5 [mol %] inclusive is preferable. Note that it is possible to dope cerium oxide at a composition ratio of up to 5.0 [mol %] inclusive since doping tin oxide (SnO) in addition to cerium oxide suppresses staining of the glass that is caused by the cerium oxide. In such a case, doping cerium oxide at a composition ratio of greater than or equal to 0.5 [mol %] makes it possible to absorb a 313 [nm] ultraviolet ray. However, even in such a case, doping cerium oxide at a composition ratio of greater than 5.0 [mol %] causes the glass to devitrify.

Also, when zinc oxide (ZnO) is used, doping it at a composition ratio of greater than or equal to 2.0 [mol %] makes it possible to absorb a 254 [nm] ultraviolet ray. However, doping zinc oxide at a composition ratio of greater than 10 [mol %] causes the thermal expansion coefficient of the glass to increase. As a result, when the sealing material is made of tungsten (W), the thermal expansion coefficient of the sealing material (approximately 44×10⁻⁷K⁻¹) is different from the thermal expansion coefficient of the glass, which makes the sealing difficult. Therefore, doping zinc oxide at a composition ratio in the range of 2.0 [mol %] to 10 [mol %] inclusive is preferable. However, when the sealing material is made of Kovar or molybdenum (Mo), zinc oxide can be doped at a composition ratio of up to 14 [mol %] inclusive, since the thermal expansion coefficient of the sealing material (approximately 51×10⁻⁷K⁻¹) is larger than when tungsten is used. However, even in such a case, doping zinc oxide at a composition ratio of greater than 20 [mol %] causes the glass to devitrify. Therefore, doping zinc oxide at a composition ratio in the range from 2.0 [mol %] to 20 [mol %] inclusive is preferable.

Also, when iron oxide (Fe₂O₃) is used, doping it at a composition ratio of greater than or equal to 0.01 [mol %] makes it possible to absorb a 254 [nm] ultraviolet ray. However, since doping iron oxide at a composition ratio of greater than 2.0 [mol %] stains the glass, doping iron oxide at a composition ratio in the range of 0.01 [mol %] to 2.0 [mol %] inclusive is preferable.

Also, an infrared transmission coefficient that indicates the water content in the glass is adjusted to be preferably in the range of 0.3 to 1.2 inclusive, and particularly in the range of 0.4 to 0.8 inclusive. When the infrared transmission coefficient is less than or equal to 1.2, it is more likely to obtain a low dielectric loss tangent that is applicable to a high-voltage impressed lamp such as an external electrode fluorescent lamp (EEFL), a long-type cold cathode fluorescent lamp or such. If the infrared transmission coefficient is less than or equal to 0.8, the dielectric loss tangent is sufficiently small, and even more applicable to a high-voltage impressed lamp.

Note that the infrared transmission coefficient (X) can be represented by the formula (1) below.

[Formula 1]

X=[log(a/b)]/t (1) wherein
a: transmission rate [%] at local minimum point in the vicinity of 3840 [cm⁻¹]
b: transmission rate [%] at local minimum point in the vicinity of 3560 [cm⁻¹]
t: thickness of the glass

In FIG. 1, a description is provided of the fluorescent lamp 10 in the shape of a straight tube. However, the fluorescent lamp of the present invention is not limited to this, and the tube of the fluorescent lamp 10 may be a curved tube having a U-shape, a squared U-shape, or the like. Also, the fluorescent lamp 10 is not limited to being a cylindrical type lamp having a circular cross section, and may be, for example, a flat lamp having an elliptical cross section.

### Embodiment 1-2

The following describes a light emitting device and a display device of the present invention according to the embodiment 1-2, with reference to the drawings. FIG. 2 describes an outline of a display device 101 having the fluorescent lamp of the present invention, such as a liquid crystal television.

As shown in FIG. 2, the display device 101 is, for example, a 32 inch liquid crystal television, and includes a liquid crystal display unit 103, and a fluorescent lamp unit 102 that is the light emitting device of the present invention. The liquid crystal display unit 103 includes, for example, a color filter substrate, a liquid crystal, a TFT substrate, a drive module, etc. (not shown), and forms color images based on image signals from outside. At the bottom of the liquid crystal display unit 103, a high-frequency electronic ballast 104 is provided so as to cause a plurality of cold cathode fluorescent lamps 20 (each corresponding to the fluorescent lamp 10 of the present invention in FIG. 1) that are provided in the fluorescent lamp unit 102 to be all lit up. Note that, in FIG. 2, a reference number 105 denotes operation buttons, and a reference number 106 denotes a remote controller.

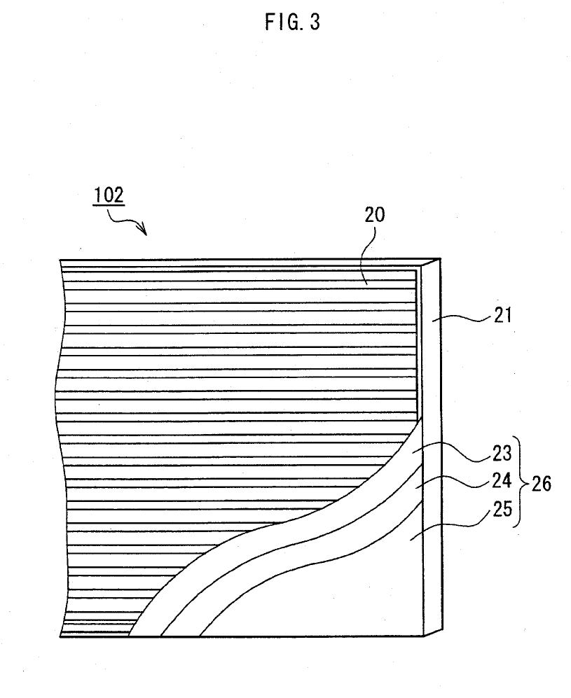

FIG. 3 is a schematic perspective view showing the structure of the fluorescent lamp unit 102 of a directly-below type. In FIG. 3, part of a front panel 26 is cut away so as to show the inner structure of the fluorescent lamp unit 102. The fluorescent lamp unit 102 includes the plurality of cold cathode fluorescent lamps 20, a case 21 in the shape of a box whose one main surface is open, and the front panel 26 that covers the case 21. The plurality of cold cathode fluorescent lamps 20 are in the shape of a straight tube, and are provided in parallel in the shorter direction of the case 21 in a state where the axis of the cold cathode fluorescent lamp 20 extends horizontally. Note that these cold cathode fluorescent lamps 20 are lit by a drive circuit (not shown) that is connected thereto.

The case 21 is made of a resin such as polyethylene terephthalate (PET), and has a reflective surface, which is formed by metal, such as silver, being vapor-deposited on the inner surface of the case 21. The opening of the case 21 is covered with the front panel 26 that is translucent, and sealed so as to prevent foreign substances such as particles from entering inside the case 21. Note that the case 21 may be made of a material other than resin. For example, the case 21 may be made of a metal material such as aluminum. The front panel 26 is formed by a diffusion plate 23, a diffusion sheet 24, and a lens sheet 25 laminated thereon.

The diffusion plate 23 and the diffusion sheet 24 disperse and diffuse light emitted from the cold cathode fluorescent lamp 20, and the lens sheet 25 aligns light in the normal direction of the lens sheet 25. The above-described diffusion plate 23, diffusion sheet 24, and lens sheet 25 cause light emitted from the cold cathode fluorescent lamp 20 to irradiate the entire front panel 26 evenly in the front direction.

The diffusion plate 23 is made of a resin such as polycarbonate (PC). The PC resin is excellent in moisture resistance, mechanical strength, heat resistance, and optical transparency, and a plate made of the PC resin is not easily warped by moisture absorption. Therefore, the PC resin can be advantageously used for a diffusion plate of a liquid crystal television having a large screen (larger than 17 inches, for example).

### Practical Example

The following provides a detailed description of a cold cathode fluorescent lamp, which is an example of the fluorescent lamp of the present invention, with use of a practical example.

### Practical Example 1

In the practical example 1, a description is provided of an example of the fluorescent lamp 10 that is described in the above embodiment 1. As shown in FIG. 1, in the fluorescent lamp 10, one end of the metal sleeve 12a is connected to the inner lead wire 15 such that the one end of the metal sleeve 12a is pressure-welded with the inner read wire 15 inserted therein. The metal sleeve 12a is made of nickel, and has a 1.7 [mm] outer diameter (S1), a 1.5 [mm] inner diameter (S2), a 5.5 [mm] cup length (L1), and a 1.5 [mm] base part length (L2). The inner lead wire 15 is made of tungsten and has a 0.6 [mm] outer diameter.

The glass container 11 is formed of borosilicate glass, and has a 2.4 [mm] outer diameter (D1), and a 2.0 [mm] inner diameter (D2). The electrode 12 is provided on each end of the glass container 11. The electrode 12 includes the emitter 12b that is made of magnesium oxide microparticles.

Also, both ends of the glass container 11 are sealed by the glass beads 14 that is made of borosilicate glass, and the inner lead wire 15 passes through the glass bead 14 and is connected to the outer lead wire 16 that is made of stainless steel and has a 0.5 [mm] outer diameter. The distance between the ends of the pair of electrodes 12 is 720 [mm]. Also, the phosphor 13 is applied on the inner surface of the glass container 11, and the interior thereof is filled with mercury and a mixed gas of argon and neon to a pressure of 8 [kPa].

A phosphor of a three wavelength type is used as the phosphor 13. The phosphor of the three wavelength type is obtained by mixing (i) europium-activated strontium chloroapatite [Sr₁₀(PO₄)₆Cl₂:Eu²⁺] (SCA) as a blue phosphor, (ii) manganese-activated cerium-magnesium zinc aluminate [Ce(Mg,Zn)Al₁₁O₁₉:Eu²⁺,Mn²⁺] (CMZ) as a green phosphor, and (iii) europium-activated yttrium vanadate [YVO₄:Eu³⁺] (YVO) as a red phosphor, at the weight ratio of SCA:CMZ:YVO=4:2:4.

The fluorescent lamp of the practical example 1 was manufactured by the following method.

To begin with, the emitter 12b was formed on the inner surface of the metal sleeve 12a by the following method. First, the emitter application fluid was prepared by dispersing 10 [kg] of the magnesium oxide particles into 20 liters of a mixed solution (the nitrocellulose being 1.5 [Wt %] of the butyl acetate solution) of nitrocellulose (the binder) and butyl acetate (the solvent) Next, the emitter application fluid was applied using a spray method to the inner surface of the metal sleeve 12a, and allowed to dry naturally in the air.

After that, the electrode 12 including the emitter 12b was formed, by firmly fixing the magnesium oxide microparticles to the metal sleeve 12a by heating the metal sleeve 12a to which the emitter application fluid had been applied to approximately 550[° C.] in an argon atmosphere reduction furnace, and by removing the binder and solvent.

Next, the phosphor 13 was applied to the inner surface of the glass container 11 in the following method. First, an application fluid for the phosphor 13 was prepared by dispersing 1 [kg] of the phosphor of the three wavelength type into 0.6 liters of a mixed solution (the nitrocellulose being 1.5 [Wt %] of the butyl acetate solution) of nitrocellulose (the binder) and butyl acetate (the solvent). Subsequently, the glass container 11 was held vertically so as to apply the phosphor application fluid by a suction method, and dried by sending hot air in the glass container 11.

Then, the electrodes 12 were disposed on the respective ends of the glass container 11 to which the phosphor 13 was applied, and only one of the electrodes 12 was heat-sealed via the glass bead 14 at first. Next, mercury and a mixed gas of argon and neon was introduced to the inside of the glass container 11 to 8 [kPa], and finally the other electrode 12 and the glass container 11 were heat-sealed via the glass bead 14, thereby completing the fluorescent lamp of the practical example 1.

### Comparative Example 1

The fluorescent lamp of the comparative example 1 was manufactured in the same manner as the practical example 1, except that the lamp of the comparative example 1 was manufactured with use of a phosphor of a three wavelength type obtained by mixing blue, red, and green phosphors at the weight ratio of BAM-B:CMZ:YVO=4:2:4, the blue phosphor being europium-activated barium-magnesium aluminate [BaMg₂Al₁₆O₂₇:Eu²⁺] (BAM-B), instead of SCA.

<Measurement of Luminescence Spectrum of Fluorescent Lamp>

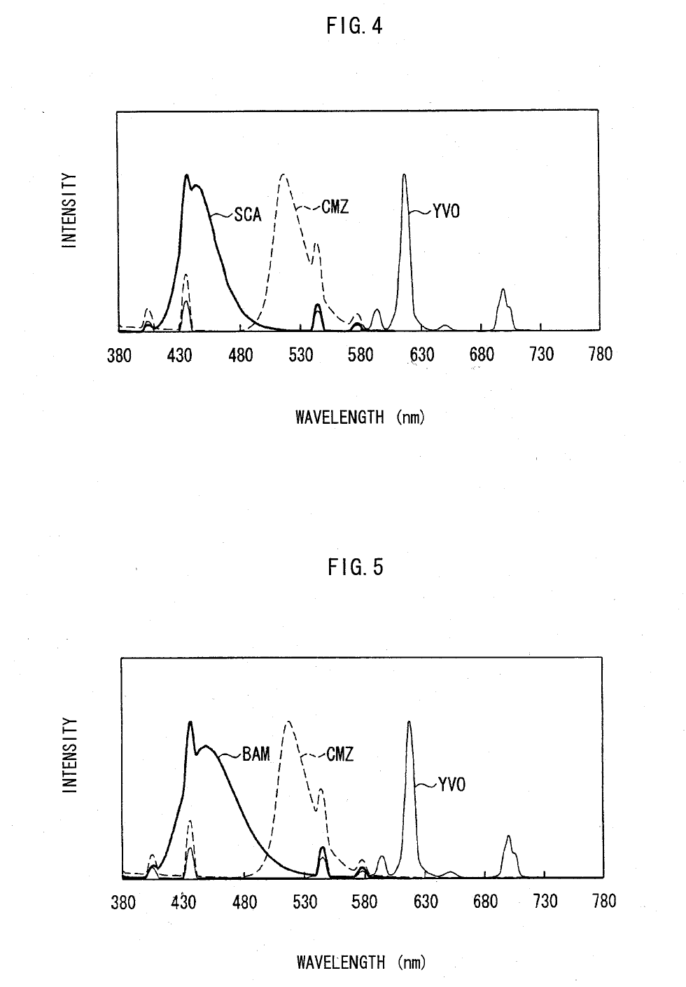

Single-color fluorescent lamps, which include a blue fluorescent lamp, a green fluorescent lamp, and a red fluorescent lamp, were manufactured by using color phosphors of the fluorescent lamp of the practical example 1. Also, single-color fluorescent lamps, which also include a blue fluorescent lamp, a green fluorescent lamp, and a red fluorescent lamp, were manufactured by using color phosphors of the fluorescent lamp of the comparative example 1. Then, the luminescence spectrum of each of the single-color fluorescent lamps was measured with use of a spectrometer (made by TOPCON, Model No. SR-3). The results of the measurement are shown in FIG. 4 (practical example 1) and FIG. 5 (comparative example 1).

As shown in FIG. 4 (practical example 1), the wavelength of the main luminescence peak of the blue phosphor SCA is 447 nm, the wavelength of the main luminescence peak of the green phosphor CMZ is 519 nm, and the wavelength of the main luminescence peak of the red phosphor YVO is 618 nm. Therefore, a difference between the wavelength of the main luminescence peak of the blue phosphor SCA and the wavelength of the main luminescence peak of the green phosphor CMZ is 72 nm.

Also, the half-value width of the main luminescence peak spectrum of the blue phosphor SCA is 35 [nm], and the half-value width of the main luminescence peak spectrum of the green phosphor CMZ is 30 [nm].

As shown in FIG. 5 (comparative example 1), the wavelength of the main luminescence peak of the blue phosphor BAM-B is 450 nm, the wavelength of the main luminescence peak of the green phosphor CMZ is 519 nm, and the wavelength of the main luminescence peak of the red phosphor YVO is 618 nm. Therefore, a difference between the wavelength of the main luminescence peak of the blue phosphor BAM-B and the wavelength of the main luminescence peak of the green phosphor CMZ is 69 nm.

Also, the half-value width of the main luminescence peak spectrum of the blue phosphor BAM-B is 50 [nm].

<Measurement of Chromaticity Coordinate Value>

The chromaticity coordinate values in the CIE 1931 chromaticity diagram were measured of the blue fluorescent lamp, green fluorescent lamp, and the red fluorescent lamp that are each manufactured with use of a corresponding one of the phosphors of the practical example 1, and the blue fluorescent lamp, green fluorescent lamp, and the red fluorescent lamp that are each manufactured with use of a corresponding one of the phosphors of the comparative example 1. The values were measured with use of the spectrophotometer “MCPD-3000” (Otsuka. Electronics Co., Ltd.). The results of the measurement are shown in the table 1 (practical example 1) and the table 2 (comparative example 1).

TABLE 1

| Using Phosphors of Practical Example 1 | x | y |
|---|---|---|
| Blue Fluorescent Lamp | 0.1600 | 0.0501 |
| Green Fluorescent Lamp | 0.1809 | 0.6361 |
| Red Fluorescent Lamp | 0.5722 | 0.3162 |

TABLE 2

| Using Phosphors of Comparative Example 1 | x | y |
|---|---|---|
| Blue Fluorescent Lamp | 0.1541 | 0.0730 |
| Green Fluorescent Lamp | 0.1809 | 0.6361 |
| Red Fluorescent Lamp | 0.5722 | 0.3162 |

<Measurement of Chromaticity Coordinate Value after Transmission through Color Filters>

The chromaticity coordinate values in the CIE 1931 chromaticity diagram were measured, with respect to the light of the white fluorescent lamp of the practical example 1 and the white fluorescent lamp of the comparative example 1, after the lights had transmitted through the color filters included in the liquid crystal display device. The values were measured with use of the spectrophotometer “MCPD-3000” (Otsuka. Electronics Co., Ltd.). The results of the measurement are shown in the table 3 (practical example 1) and the table 4 (comparative example 1).

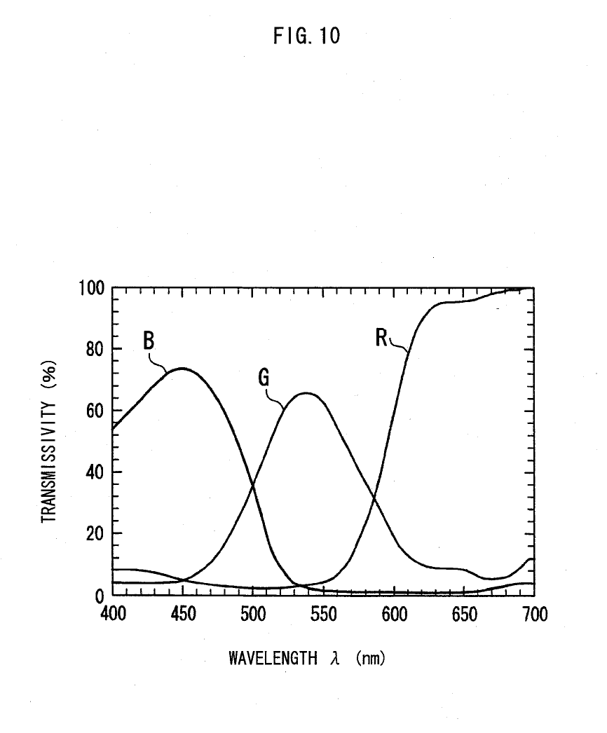

Here, FIG. 10 shows the spectral distribution transmission characteristics of the color filters used for the measurement. In FIG. 10, B denotes the spectral distribution transmission characteristics of the blue filter. Also, G and R respectively denote the spectral distribution transmission characteristics of the green filter and the red filter.

TABLE 3

| Fluorescent Lamp of Practical Example 1 | x | y |
|---|---|---|
| Blue filter | 0.1469 | 0.0932 |
| Green filter | 0.1907 | 0.6970 |
| Red filter | 0.6403 | 0.3086 |

TABLE 4

| Fluorescent Lamp of Comparative Example 1 | x | y |
|---|---|---|
| Blue filter | 0.1421 | 0.0983 |
| Green filter | 0.1821 | 0.6700 |
| Red filter | 0.6378 | 0.3079 |

<Evaluation with Use of NTSC Ratio>

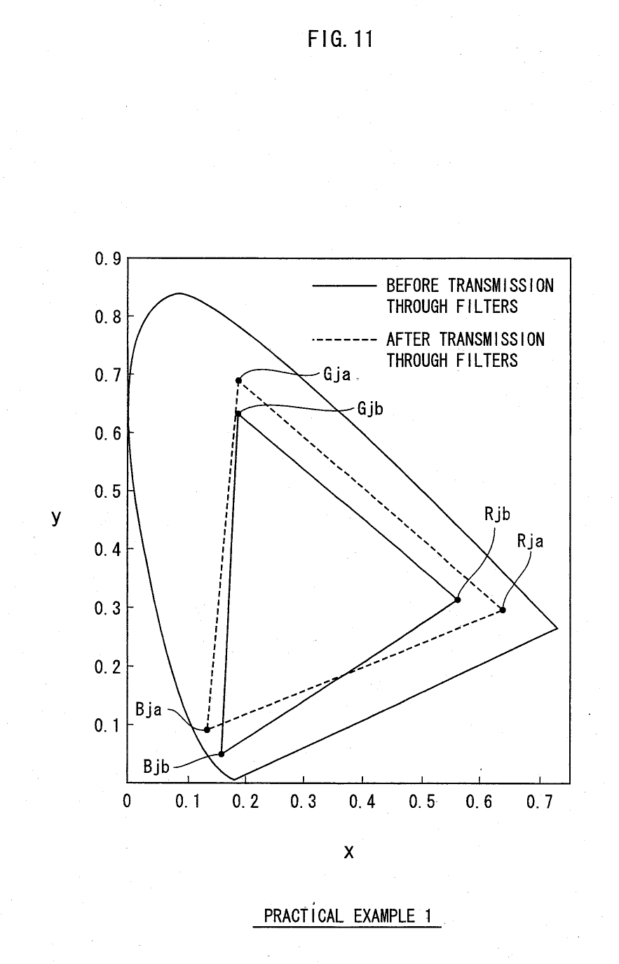

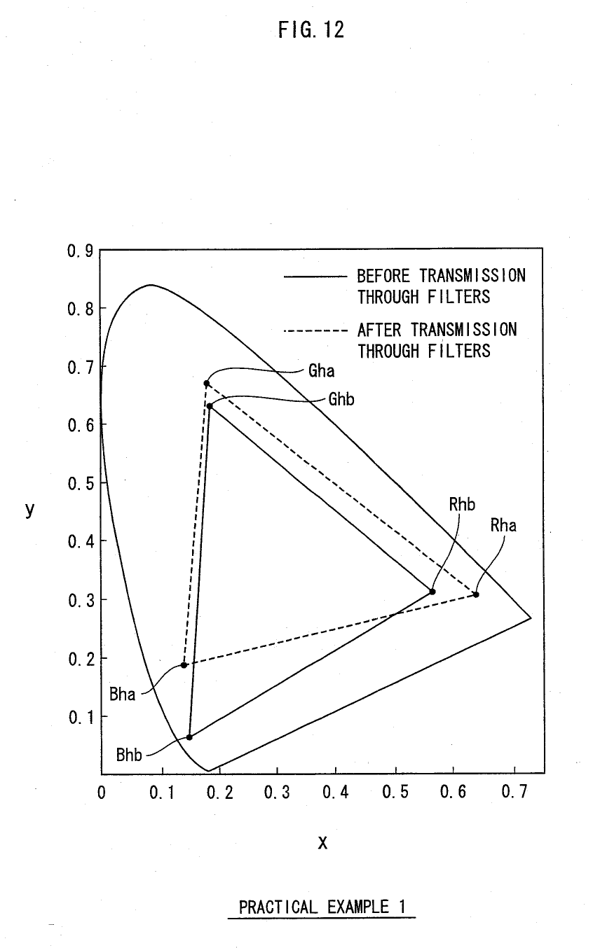

Based on the measurement results shown in FIGS. 1 to 4, the chromaticity coordinates of blue, green, and red were plotted in the CIE 1931 chromaticity diagram. Then, the chromaticity coordinates of blue, green, and red (three points) were connected by either a solid line or a broken line, for each of the measurement results. FIG. 11 shows the chromaticity coordinates based on the tables 1 and 3, and FIG. 12 shows the chromaticity coordinates based on the tables 2 and 4. In the FIGS. 11 and 12, the chromaticity coordinates before the light transmits through the color filters (tables 1 and 2) are connected by a solid line, and the chromaticity coordinates after the light has transmitted through the color filters (tables 3 and 4) are connected by a broken line.

As for blue in the comparative example 1 shown in FIG. 12, the chromaticity coordinates after the light has transmitted through the color filters (Bha) is largely displaced from the chromaticity coordinates before the light transmits through the color filters (Bhb). This prevents the area of the triangle in the chromaticity diagram from becoming large (i.e. the range of color reproducibility does not become large) as described above. On the contrary, in the practical example 1 of FIG. 11, the chromaticity coordinates after the light has transmitted through the color filters (Bja) is not considerably displaced from the chromaticity coordinates before the light transmits through the color filters (Bjb), and therefore the area of the triangle in the chromaticity diagram is not significantly reduced.

As for green and red in the practical example 1 and the comparative example 1, the chromaticity coordinates after the light has transmitted through the color filters (Gja), (Gha), (Rja), and (Rha) are displaced from the chromaticity coordinates (Gjb=Ghb) before the light transmits through the color filters, in the direction in which the area of the triangle in the chromaticity diagram is increased.

Here, the areas of the triangles shown in FIGS. 11 and 12 are shown by an area ratio (NTSC ratio) in which the area of an NTSC triangle formed by connecting chromaticity coordinate values of the three NTSC standard primary colors in the CIE 1931 chromaticity diagram is used as a reference (100%). The area ratio is shown in Table 5 below.

TABLE 5

| | Before Transmission | After Transmission |
|---|---|---|
| | through Color | through Color |
| | Filters (%) | Filters (%) |
| Practical Example 1 | 74.6 | 91.2 |
| Comparative Example 1 | 72.3 | 86.9 |

It can be seen from the table 5 that the fluorescent lamp of the practical example 1 has a large color gamut area before and after the light transmits through the color filters, thereby maintaining high color reproducibility, whereas the fluorescent lamp of the comparative example 1 has a smaller color gamut area after the light transmits through the color filters, thereby deteriorating color reproducibility.

### Practical Example 2

The fluorescent lamp of the practical example 2 was manufactured in the same manner as the practical example 1, except that the lamp of the practical example 2 was manufactured with use of a phosphor of a three wavelength type obtained by mixing blue, red, and green phosphors at the weight ratio of SCA:BAM-G:YVO=4:2:4, the green phosphor being europium-and-manganese-activated barium magnesium aluminate [BaMg₂Al₁₆O₂₇:Eu²⁺,Mn²⁺] (BAM-G) for a green phosphor instead of CMZ. Note here that the mole ratio of europium (Eu²⁺) and manganese (Mn²⁺) that are included in BAM-G was 1:9.

### Practical Example 3

The fluorescent lamp of the practical example 3 was manufactured in the same manner as the practical example 2, except that the mole ratio of europium (Eu²⁺) and manganese (Mn²⁺) that are included in BAM-G was 5:5.

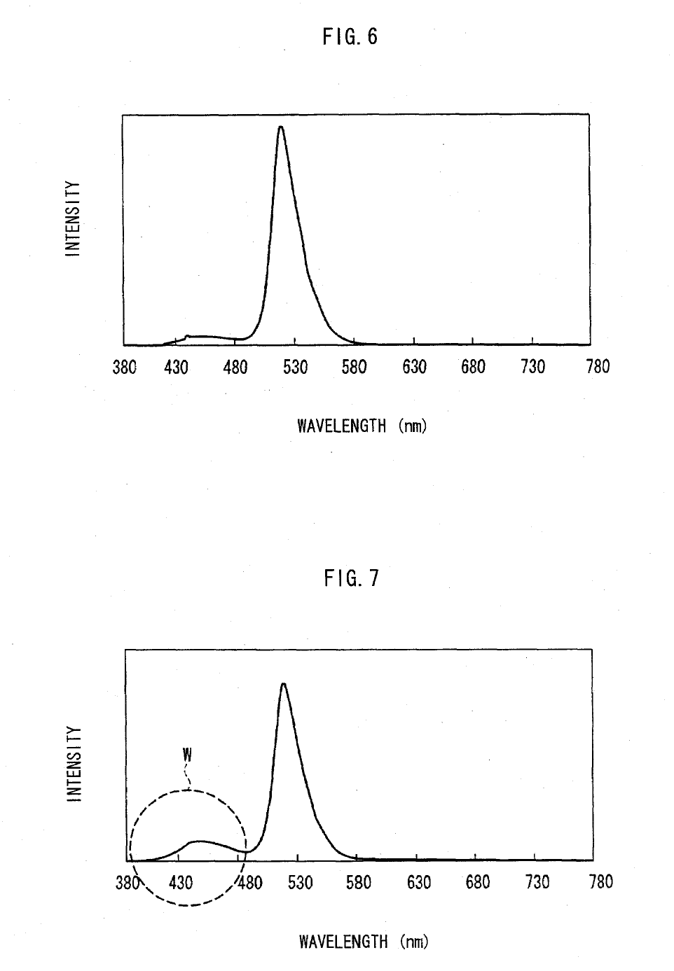

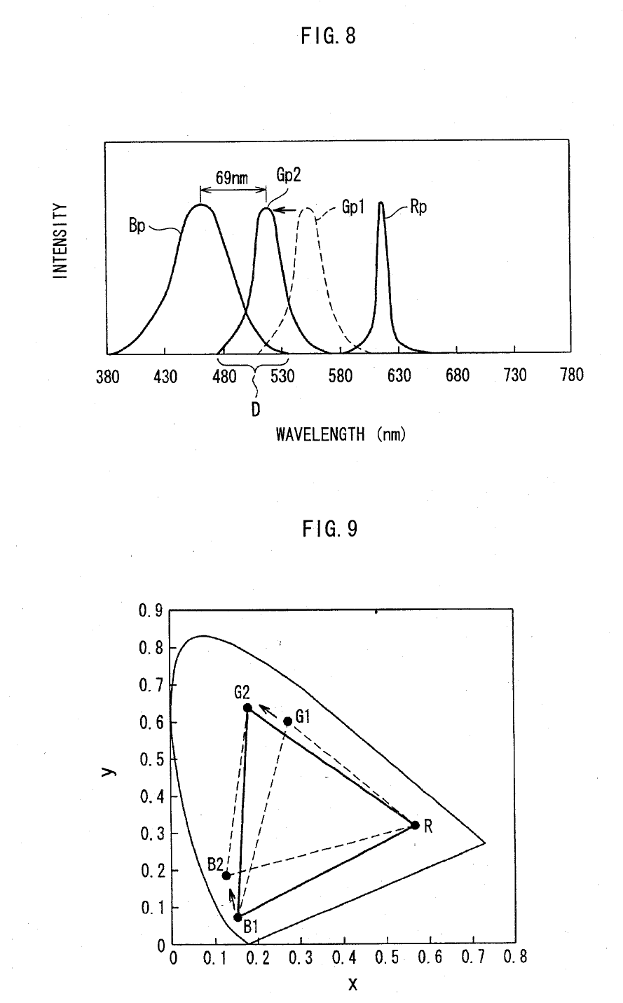

The luminescence spectra of the fluorescent lamps of the practical examples 2 and 3 were measured in the same manner as described above. The results of the measurement are shown in FIGS. 6 and 7. Note that each of FIGS. 6 and 7 only shows the spectrum of green (light of green fluorescent lamp), and does not show the spectra of blue and red.

Here, the luminescence peak wavelength of the practical example 2 shown in FIG. 6 is 515 [nm], the half-value width of the luminescence peak wavelength is 30 [nm]. Also, the luminescence peak wavelength of the practical example 3 shown in FIG. 7 is 515 [nm], the half-value width of the luminescence peak wavelength is 30 [nm].

Next, the brightness of each of the white fluorescent lamps of the practical examples 2 and 3 was measured with use of the spectrometer “SR-3” made by TOPCON. As a result, the brightness of the white fluorescent lamp of the practical example 2 was 19325 cd/m², and that of the white fluorescent lamp of the practical example 3 was 18339 cd/m². This is presumably because of the following reasons. As shown in FIGS. 6 and 7, the spectrum of green in the practical example 2 has a substantially single peak, whereas the spectrum of green in the practical example 3 has a sub-peak in addition to the main peak as shown by the W portion of FIG. 7. This double peak including the single peak and sub-peak is assumed to have caused the brightness to slightly decrease.

Also, the fluorescent lamps of the practical examples 2 and 3 were evaluated in the same manner as the evaluation of the lamp of the practical example 1, with use of the NTSC radio. As a result, it has been recognized that the fluorescent lamps of the practical examples 2 and 3 achieve high color reproducibility that is greater than or equal to the fluorescent lamp of the practical example 1.

### Embodiment 2

In the embodiment 1, the present invention provides a fluorescent lamp that is suitable for a light source of a backlight unit. Compared to conventional lamps, this fluorescent lamp has a wide range of color reproducibility after the light has transmitted through the color filters. The embodiment 2 relates to an external electrode fluorescent lamp that is suitable for miniaturization among fluorescent lamps, and thus is suitable for a light source of a backlight unit that is required to be thinner (smaller). In particular, the embodiment 2 relates to a technique for improving a conductive film that is formed on the outer surface of a glass container and used as an external electrode, in view of the background art described below.

Conventionally, borosilicate glass (hard glass) is used as a material for a narrow glass container included in the external electrode fluorescent lamp, since the borosilicate glass is high in strength. Also, the external electrode is formed by winding a metal tape around the periphery of the glass container.

However, it is difficult to uniformly attach the metal tape to a narrow glass container having an outer diameter of, for example, 4 mm. In order to solve the problem, the external electrode can be a solder layer that is formed on the surface of the glass container by immersing the end portions of the glass container in melted solder (dipping). However, typical solder is mainly made of tin and lead, and does not easily stick to glass. Therefore, it is difficult to form a uniform external electrode with use of the typical solder.

In view of the problem described above, Japanese Patent Application Publication No. 2004-146351 discloses a technique for forming an external electrode by a dipping method, with use of solder including antimony, zinc, etc., in addition to tin as a main component (hereinafter referred to as “first conventional technique”).

Since antimony is environmentally harmful, Japanese Patent Application Publication No. 2007-26798 discloses a technique for forming an external electrode without using antimony (hereinafter referred to as “second conventional technique”). According to the second conventional technique, a paste including silver powder and glass frit (hereinafter referred to as “Ag paste”) is coated around the periphery of each end of the glass container and the paste is fired to form a silver coating film. Then, a solder layer is formed on the silver coating film by laminating a solder on the silver coating film with use of a dipping method, the solder including silver and copper in addition to tin as a main component. In this way, an external electrode having a two-layer structure is formed. The reason why the solder layer is formed on the silver coating film is because if the silver coating film is exposed, the silver coating film reacts with a sulfur component in air to form silver sulfide, thereby lowering conductivity.

As described above, the glass container of the external electrode discharge lamp is usually made of borosilicate glass because of its strength. However, there is a demand for the use of soft glass because the soft glass is cheaper.

However, neither the first technique nor the second technique is suitable for a glass container made of soft glass since the external electrode includes the solder layer. Soft glass has a large thermal expansion coefficient, and therefore breaks as soon as being dipped in melted solder due to a sudden change in temperature.

Note that the above-described problem is also common to a cold cathode discharge lamp having a feed terminal on the outer surface of each of the ends of the glass container. In the cold cathode discharge lamp, a conductive film formed on the outer surface of each of the ends of the glass container is electrically connected to a lead wire that is connected to an internal electrode, and the conductive film is used as the feed terminal.

Therefore, an object of the embodiment 2 is to provide a discharge lamp in which a conductive film does not include a solder layer. Another object of the embodiment 2 is to provide a backlight unit having the discharge lamp, and a liquid crystal display unit having the backlight unit.

Note that a soldering process can be omitted if the conductive film does not include the solder layer. Therefore, the embodiment 2 of the present invention is useful for a discharge lamp having a glass container made of borosilicate glass (hard glass).

In order to achieve the above-described object, in the embodiment 2, the present invention provides a discharge lamp having a glass container that is hermetically sealed and a conductive film that has been formed on an outer surface of the glass container, wherein the conductive film is a fired material applied to the outer surface of the glass container, the fired material obtained by firing a paste and including (i) one of mixed metal powder and atomized alloy powder and (ii) glass frit, the mixed metal powder including aluminum powder as a primary material and silver powder as a secondary material, the atomized alloy powder including aluminum as a main component and silver as a secondary component.

Also, the conductive film includes silver in a range of 6 to 40 [Wt %] inclusive.

Furthermore, the glass container is made of soft glass.

In order to achieve the above-described object, a backlight unit according to the embodiment 2 has the above-described discharge lamp as a light source.

In order to achieve the above-described object, a liquid crystal display device according to the embodiment 2 includes a liquid crystal display panel and the above-described backlight unit which has been provided on the back surface of the liquid crystal display panel.

According to the discharge lamp of the embodiment 2, the conductive film is made of the fired material obtained by firing the paste and does not include any solder layer. Therefore, it is possible to use soft glass as a material for the glass container.

The following describes the discharge lamp according to the embodiment 2, with reference to drawings.

### Embodiment 2-1

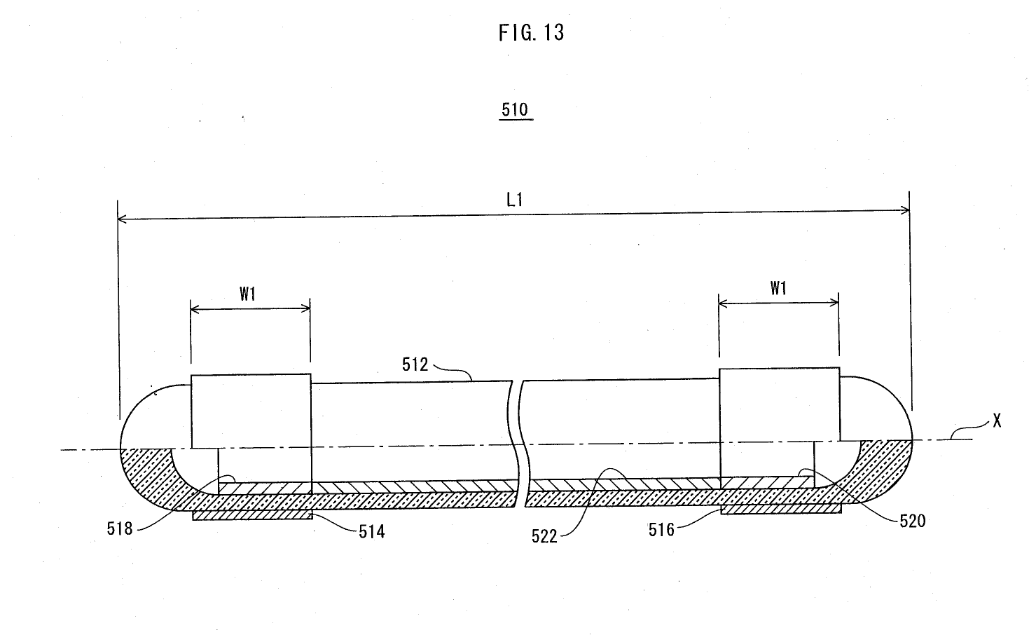

FIG. 13 is a schematic half-sectional view showing an external electrode fluorescent lamp 510 (hereinafter simply referred to as “fluorescent lamp 510”), which is one example of discharge lamps. Note that in all figures including FIG. 13, the contraction scale between each component is not unified.

The fluorescent lamp 510 includes a glass container 512 formed by a glass tube whose ends have been sealed. The glass container 512 has, for example, a 740 [mm] entire length (L1), a 4.0 [mm] outer diameter, and a 3.0 [mm] inner diameter.

The glass container 512 is formed from lead glass, lead-free glass, soda-lime glass, or another soft glass. Soft glass is a glass material containing sodium oxide (Na₂O) in the range of 5 [mol %] to 20 [mol %] inclusive. The thermal expansion coefficient of soft glass is in the range of 92×10⁻⁷ [k⁻¹] to 102×10⁻⁷ [k⁻¹] inclusive. In this example, lead-free glass (the content ratio of Na₂O being in the range of 5 to 12 [mol %] inclusive) is used as the glass container 512. The thermal expansion coefficient of the lead-free glass is 92.5×10⁻⁷ [K⁻¹], and the softening point thereof is 680° C. The lead-free glass is used in this embodiment in consideration of environmental protection. However, even lead-free glass may include lead as an impurity in the manufacturing process. Therefore, glass that contains an impurity level of lead that is less than or equal to 0.1 [Wt %] is also defined as lead-free glass.

The glass container 512 has a first external electrode 514 and a second external electrode 516 that have been formed on the periphery of each end of the glass container 512. Each of the first and second external electrodes 514 and 516 has been formed on the entire periphery of the respective ends of the glass container 512, with a width of, for example, W1=20 [mm].

Each of the first and second electrodes 514 and 516 is formed from mixed metal powder and a conductive film. In the mixed metal powder, the primary material and the secondary material are aluminum powder and silver powder, respectively. The conductive film is formed from a fired material obtained by firing the paste including glass frit (hereinafter referred to as “Al—Ag paste”). The glass frit is of a phosphoric acid type. When the paste is fired, the mixed metal powder melts and joins together to form a network-like film. The glass frit melts and enters the gaps of the network-film, and also enters the microscopic recessed parts on the surface of the glass container 512, thereby achieving a so-called anchor effect. This makes it possible to firmly fix the fired material to the surface of the glass container 512. Note that the type of the glass frit is not limited to the phosphoric acid type, but can also be a bismuth type.

The Al—Ag paste is formed by mixing the mixed metal powder, the glass frit, ethylcellulose as a dispersant, and terpineol as a solvent.

The ratio of each of the material in the paste is as follows: the ratio of the aluminum powder having an average particle diameter of 5 [μm] is greater than or equal to 30 [Wt %], the ratio of the silver powder having an average particle diameter of 3 [μm] is in the range of 5 to 30 [Wt %] inclusive, the ratio of frit glass is in the range of 15 to 25 [Wt %] inclusive, and the rest of the materials in the paste includes the dispersant, solvent and such. In other words, the mixed metal powder included in the paste has the aluminum powder as a primary material, and the silver powder as a secondary material. Note that a description of an average particle diameter is provided below.

Here, the reason why aluminum is selected as a primary material is because conductivity and cost efficiency are taken into consideration.

In view of conductivity, if the ratio of the aluminum powder in the paste is less than 30 [Wt %], the resistance value of the conductive film, which is a pair of the first external electrode 514 and the second external electrode 516), exceeds 1×10⁻³[Ω] This makes it difficult for the fluorescent lamp to be lit.

Furthermore, when conductivity and cost efficiency are taken into consideration, it is desirable to only use aluminum as a metal material. However, the use of only aluminum causes a poor firing result. In other words, the use of only aluminum is likely to cause the paste to form an aluminum oxide film when fired, which prevents an excellent firing result. The aluminum oxide film is decomposed at a temperature of 750° C. or higher. However, the softening point of soft glass is lower than the above-mentioned temperature. Therefore, firing at the temperature of 750° C. or higher causes the glass container to be deformed.

Because of the above-described reason, the present embodiment adopts paste that includes silver as a material thereof. Compared to aluminum, silver is easy to be joined together with oxygen. Therefore, it is possible to prevent aluminum from joining together with oxygen by adding silver to the paste. Note that silver oxide is decomposed at a temperature of approximately 150° C. Therefore, silver oxide film is not formed on the paste, and therefore is not a hindrance to firing.

Here, it is known that excellent firing is realized when the paste includes 5 [Wt %] or more of silver. In other words, poor firing occurs when the content of silver in the paste is less than 5 [Wt %]. Specifically, when the content of silver in the paste is less than 5 [Wt %], an oxide film is formed on aluminum on the surface of a paste film, which causes so-called half-firing on the inside of the paste film. As a result, glass frit is not sufficiently melt, and the above-described anchor effect cannot be obtained. Accordingly, the fixing strength of the conductive film (fired film) with respect to the surface of the glass container 512 becomes insufficient.

Note that, as can be seen in the second conventional technique that is described above as the background art, silver sulfide becomes problematic if the content of silver in the paste exceeds 30 [Wt %].

Therefore, it is preferable that the content of silver in the paste is in the range of 5 [Wt %] to 30 [Wt %] inclusive.

The following describes an appropriate range for each of the average particle diameter of silver and the average particle diameter of aluminum. Here, the “average particle diameter” denotes a particle diameter measured by a micro-track particle size analyzer, at 50 volume % in an accumulation graph.

An appropriate range of the average particle diameter of silver is 0.2 [μm] to 10 [μm] inclusive, and more preferably 1 [μm] to 5 [μm] inclusive. When the average particle diameter is less than 0.2 [μm], the conductive film, which is a pair of the first external electrode 514 and second external electrode 516, decreases in density, causing a deterioration in the conductivity of the conductive film. As a result, it becomes difficult to light the fluorescent lamp. When the average particle diameter exceeds 10 μm], it becomes difficult to fire the paste. As a result, time required for firing becomes longer, which decreases the productivity.

An appropriate range of the average particle diameter of aluminum is 0.5 [μm] to 20 [μm] inclusive, and more preferably 1.5 [μm] to 10 [μm] inclusive. When the average particle diameter is less than 0.5 [μm], the conductive film, which is made by a pair of the first external electrode 514 and second external electrode 516, decreases in density, causing a deterioration in the conductivity of the conductive film. As a result, it becomes difficult to light the fluorescent lamp. When the average particle diameter exceeds 20 [μm], it becomes difficult to fire the paste. As a result, time required for firing becomes longer, which decreases the productivity.

The following describes the reason why the ratio of the frit glass in the paste is in the range of 15 [Wt %] to 25 [Wt %] inclusive. When the ratio of the frit glass is less than 15 [Wt %], the above-described anchor effect cannot be sufficiently obtained, resulting in the fixing strength of the conductive film (fired film) with respect to the surface of the glass container 512 becomes insufficient. Also, when the ratio of the frit glass exceeds 25 [Wt %], the conductivity required for the conductive film cannot be obtained.

Note that, since the dispersant and the solvent in the paste are dissipated during firing, the fired material (external electrode) is mainly composed of aluminum, silver and glass. Here, the ratio of aluminum in the external electrode (fired material) is greater than or equal to 35 [Wt %], the ratio of silver therein is in the range of 6 [Wt %] to 40 [Wt %] inclusive, and the rest of the materials therein includes glass and such.

When focusing only on the metal components of the external electrode (fired material), the ratio of aluminum is greater or equal to 50 [Wt %], and the ratio of silver is in the range of 7 [Wt %] to 50 [Wt %] inclusive.

As can be clearly seen from the components described above, each of the first external electrode 514 and the second external electrode 516 does not include environmentally harmful substances such as antimony (Sb), lead-based glass frit, and such.

Also, since the external electrodes are a fired material, a glass container made of soft glass (a glass container described below) does not get damaged by a so-called heat crack. As described below, the firing temperature is approximately 620° C., which is higher than 250° C. that is a general temperature of melted solder. However, when fired, the paste on the glass container is not heated to 620° C. at once. Instead, the paste is heated gradually, and therefore the glass container does not suffer from the heat crack.

On the inner peripheral surface of the glass container 512, at least one part of an area that faces the first external electrode 514 has a first protective film 518 formed thereon, and at least one part of an area that faces the second external electrode 516 has a second protective film 520 formed thereon. Each of the first protective film 518 and the second protective film 520 is made of an assembly of metal oxide particles. In the present embodiment, yttrium oxide (Y₂O₃) is used as the metal oxide. Note that it is also possible to use alumina (Al₂O₃) as the metal oxide. As shown in FIG. 13, the protective film may be formed across almost entire length of the glass container 512 in addition to the parts corresponding to the external electrodes (in this case, the below-described phosphor layer is formed on the protective film). The function of the protective films 518 and 520 is described below.

A phosphor layer 522 is formed between the first protective film 518 and the second protective film 520, in the x-direction (longer direction) of the tube axis of the glass container 512. The phosphor layer 522 includes three kinds of rare-earth phosphor, namely blue (B), green (G), and red (R), and emits white light as a whole. As the three kinds of rare-earth phosphor, it is possible to use, for example, the same substances used in the embodiment 1.

Also, the glass container 512 that has been sealed is filled with a predetermined amount of mercury and a mixed rare gas having a predetermined pressure. In the present embodiment, the glass container 512 is filled with approximately 2000 μg mercury and approximately 7 kPa (20° C.) neon-argon mixed gas (Ne 90%+Ar 10%).

In the fluorescent lamp 510 having the structure described above, when a high-frequency voltage is applied to the first external electrode 514 and the second external electrode 516 via an inverter that is not shown in figures, a discharge phenomenon occurs in a sealed space (discharge space) of the glass container 512, causing ultraviolet rays to be generated. Then, the emitted ultraviolet rays are converted into visible light by the phosphor layer 522, thereby being emitted outside the glass container 512. The inverter may have, for example, a maximum applied voltage of 2.5 kV, and an operation frequency of 60 kHz. The above-mentioned “discharge” is a dielectric barrier discharge. In other words, when an alternating voltage having a high frequency and a high voltage is applied to the first external electrode 514 and the second external electrode 516, dielectric polarization occurs in the parts of the glass container 512 that is dielectric, the parts being directly below the first and second external electrodes 514 and 516. Then, the inner walls of the parts of the glass container 512 act as electrodes. This introduces a high voltage inside the glass container 512, resulting in the dielectric barrier discharge being generated in the glass container 512. As described above, the dielectric barrier discharge is a discharge in which electrodes are not directly exposed to plasma since a discharge space is surrounded by a dielectric material (glass container 512).

Although the electrodes (external electrodes) are not directly exposed to plasma, most of the inner peripheral parts of the glass container that correspond to the areas in which the external electrodes are arranged are subject to the impact of mercury ion, neon ion, and argon ion. Therefore, the protective films 518 and 520 are provided on the glass container so as to protect the, glass container from the impact.

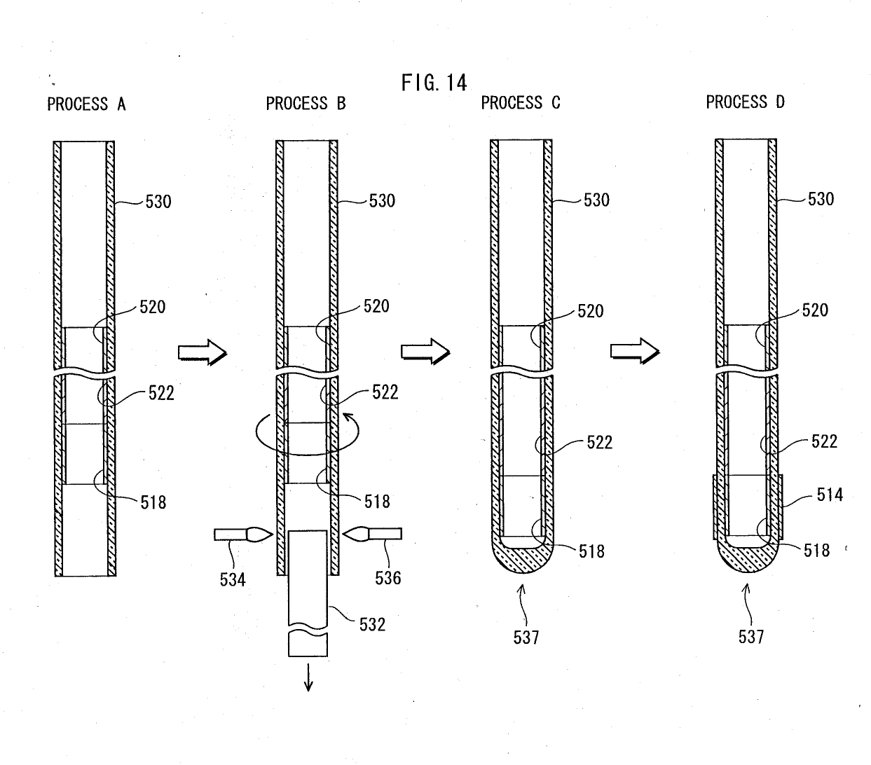

The following describes the manufacturing method of the fluorescent lamp 510, with reference to FIGS. 14, 15, 16, and 17.

First, as shown in FIG. 14, a glass tube 530 is prepared. The glass tube has a 776 [mm] entire length and a circular cross section perpendicular to the tube axis, and the protective films 518, 520 and the phosphor layer 522 have been formed on the inner peripheral surface of the glass tube 530 except for the ends thereof (process A). The reason why the films 518, 520, and 522 have been formed except for the ends of the glass tube 530 is because if a substance other than glass exists on both ends of the glass tube 530, the substance adversely affects a sealing process that is described below.

Next, one end (lower end) of the glass tube 530 is sealed by a so-called drop-seal method (process B and C). First, a metal rod 532 is inserted from the one end of the glass tube 530, and then burners 534 and 536 are used to externally heat the glass tube 530 in the vicinity of the top of the metal rod 532. At this time, the glass tube 530 is rotated around its tube axis, and the metal rod 532 is moved downward (process B). Since the outer diameter of the metal rod 532 is adjacent to the inner diameter of the glass tube 530, the heated parts of the glass tube 530 are first softened and stick to the metal rod 532. As the metal rod 532 is pulled, the softened and melted parts of the glass tube 530 are stretched and eventually separated. When the lower end of the glass tube 530 is continuously heated, the melted glass is pulled by surface tension to form a hemispherical shape and seals the lower end of the glass tube 530 (Process C). The part that has been sealed first is referred to as a first sealed part 537. Note that the first sealing process (processes B and C) is performed while the inside and outside of the glass tube 530 is at atmospheric pressure.

Subsequently, the first external electrode 514 is formed on the outer peripheral surface of an end portion of the glass tube 530, the end being on the side of the first sealed part 537 (process D). First, the Al—Ag paste is applied to the outer peripheral surface of the glass tube 530 with use of screen printing that is well-known.

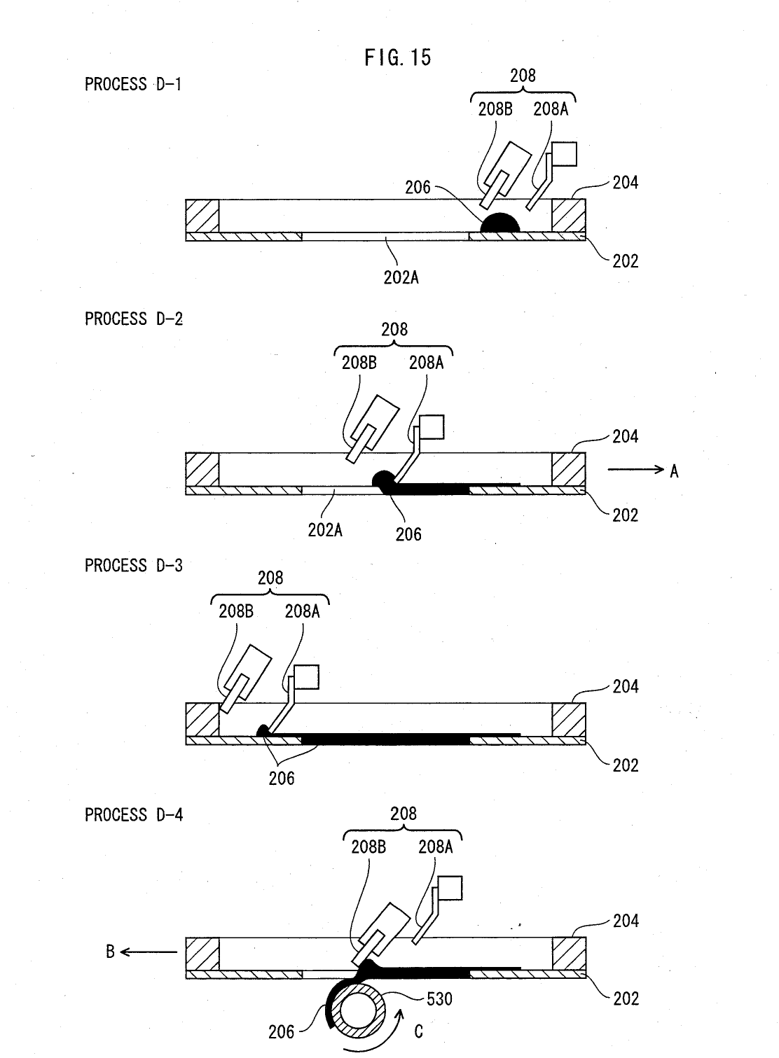

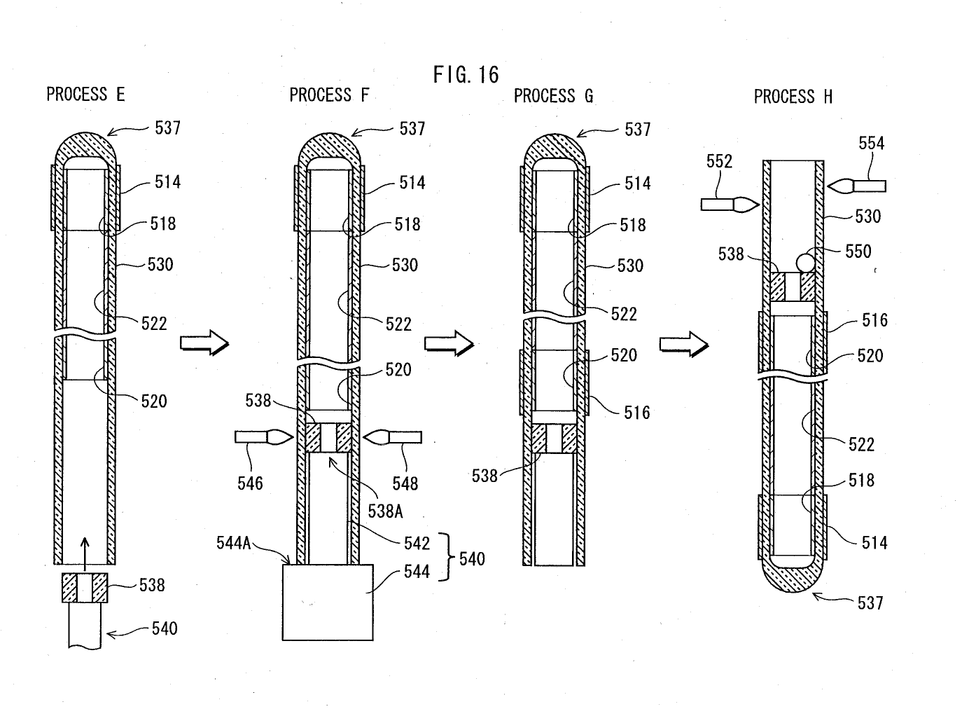

The following briefly describes the application process of the Al—Ag paste with use of screen printing, with reference to FIG. 15.

First, Al—Ag paste 206 is placed in a frame 204 to which a screen 202 is attached (process D-1).

While the frame 204 is moved forward in the direction of the arrow A, with respect to a squeegee 208 having a pair of rubber scrapers 208A and 208B, the scraper 208A is used to fill a portion 202A (hereinafter referred to as “hollow part 202A”) with the Al—Ag paste 206 (Processes D-2 and D-3). Here, the portion 202A is a portion of the screen 202 that has no printing film.

Next, the frame 204 is moved backward in the direction of the arrow B, while the screen 202 is maintained to be pressed against the outer peripheral surface of the glass tube 530 that is supported such that the glass tube 530 is rotatable. While the frame 204 is moved backward, the scraper 208B is used to squeeze the Al—Ag paste 206 out of the screen 202 (hollow part 202A), so as to transfer the Al—Ag paste 206 onto the outer peripheral surface of the glass tube 530 (process D-4). At this time, the glass tube 530 rotates along the screen 202 in the direction of the arrow C, so that the Al—Ag paste 206 is applied on the outer peripheral surface of the glass tube 530 with a predetermined thickness. The predetermined thickness is determined in a range of approximately 40 [μm] to 110 [μm] inclusive.

Next, the glass tube 530 on which the Al—Ag paste has been applied is fired in a heating furnace (not shown). In this firing process, the temperature is first elevated from room temperature to approximately 620° C. over several tens of minutes, maintained at the temperature of approximately 620° C., and then cooled back to room temperature over several tens of minutes. This process makes it possible to form the first external electrode 514 having an average thickness in the range of 20 [μm] to 80 [μm] inclusive.

Conventionally, for example in the above-described second conventional technique, the formation of the external electrodes by firing is performed after both ends of the glass tube 530 have been sealed. In other words, the formation of the external electrodes is performed after a vacuuming process (exhausting process) of the glass tube 530. However, it has been discovered that when the firing is performed with use of the Al—Ag paste after the vacuuming process, the parts of the glass tube on which the paste has been applied are dented inward. This phenomenon does not occur when the conventional Ag paste is used (the above second conventional technique). It is considered that the application of the Al—Ag paste on the parts of the glass tube causes the parts of the glass tube to be overheated for some reasons, resulting in the parts of the glass tube being pushed and dented by atmospheric pressure since the inside of the glass tube is under negative pressure. Therefore, in the present embodiment, the protective films 518 and 520, and the second external electrode 516 are formed before the vacuuming process (exhausting process), as described below.

As shown in FIG. 16, after the process D, the first sealed part 537 is turned upward. Then, a bead 538 that is made of lead-free glass is inserted from the lower end of the glass tube 537 that has yet to be sealed (process E). The bead 538 is in a hollow cylindrical shape and has a 2.0 [mm] entire length, a 2.7 [mm] outer diameter, and a 1.05 [mm] inner diameter. The bead 538 is inserted into the glass tube 530, by placing the bead 538 on the upper end surface of an insert rod 540 that is made of metal and pushing the insert rod 540 into the glass tube 530. The insert rod 540 has a narrow-diameter part 542 that is narrower than the inner diameter of the glass tube 530, and a wide-diameter part 544 that is wider than the outer diameter of the glass tube 530. The insert rod 540 that has the bead 534 on the upper end surface of the narrow-diameter part 542 is inserted into the glass tube 530 until an upper end 544A of the wide-diameter part 544 contacts the lower end of the glass tube 530. With the upper end 544A and the lower end of the glass tube 530 in contact, the upper end (the top in the insertion direction) of the bead glass 538 is positioned at a predetermined distance from the protective film 520.

With the bead 538 inserted into the glass tube 530 and positioned at a predetermined position, the bead 538 is tentatively fixed (process F). The tentative fixing refers to using burners 546 and 548 to heat outer peripheral parts of the glass tube 530 where the bead 538 is located, so as to firmly fix a part or the entirety of the outer periphery of the bead 538 to the inner peripheral surface of the glass tube 530. A hollow part 538A of the bead 538 maintains the air permeability of the glass tube 530 in the tube axial direction even if the entire outer periphery of the bead 538 is fixed to the glass tube 530.

Then, the second external electrode 516 is formed (process G). A description of a method for forming the second external electrode 516 is omitted, since the method is the same as the method for forming the first external electrode 514 (process D) Note that the first external electrode 514 may be formed at the same time as the second external electrode 516 in this process G, instead of the process D described above.

After the process G, the glass tube 530 is inverted upside down, so as to insert a mercury pellet 550, fill a rare gas, and tentatively seal an upper end of the glass tube 530. First, the mercury pellet 550 is inserted from the upper end of the glass tube 530. The mercury pellet 550 is a titanium-tantalum-iron sintered material that has been impregnated with mercury. Next, air inside the the glass tube 530 is exhausted, and the rare gas is filled into the glass tube 530. Specifically, a head of a supply/exhaust apparatus, which is not shown in figures, is placed on the upper end of the glass tube 530, and after exhausting air from the inside of the glass tube 530 to create a vacuum, the rare gas is filled until the inner pressure of the glass tube 530 becomes approximately 7 [kPa]. With the rare gas filled in the glass tube 530, burners 552 and 554 are used to heat and tentatively seal parts of the upper end of the glass tube 530 (process H). Since the inside of the glass tube 530 is under a negative pressure (6.8 [kPa]), parts of the glass tube 530 that have been either softened or melted by the heating of the burners 552 and 554 are contracted and combined by being pushed by atmospheric pressure, so as to seal the unsealed end of the glass tube 530.

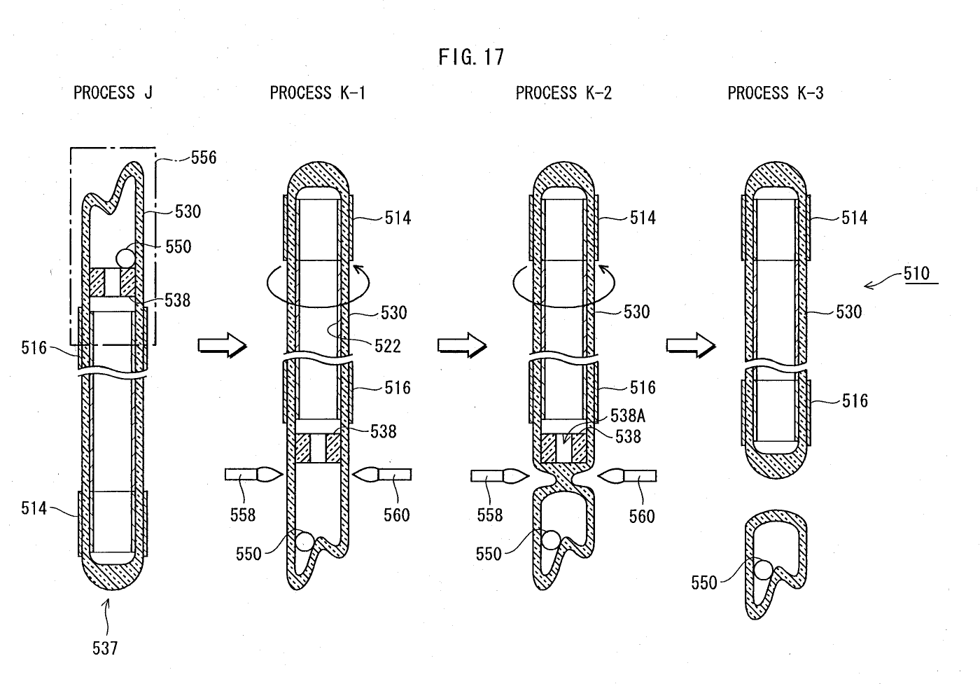

As shown in FIG. 17, after the tentative sealing, the mercury pellet 550 is induction-heated with use of a high-frequency oscillating coil (not shown) that is arranged in the vicinity of the glass tube 530, so as to expel mercury from the sintered material. The expelled mercury moves to a region that is to be the discharge space of the glass tube 530 (space between the bead 538 and the first sealed part 514) (process J). Here, the discharge space has a lower temperature than other parts of the glass tube 530.

When the process J ends, the glass tube 530 is inverted upside down, so as to cause the mercury pellet 550 to drop inside the glass tube 530 and distance the mercury pellet 550 from the bead 538. While the glass tube 530 is maintained in the above-described state, the second sealing process of the glass tube 530 is performed (processes K-1 to K-3). First, while the glass tube 530 is rotated around the tube axial direction, parts of the glass tube 530, which are in the vicinity of the lower end of the bead 538, are externally heated by burners 558 and 560 (process K-1). Since the inside of the glass tube 530 is under a negative pressure, parts of the glass tube 530 that have been heated to be melted are pushed and contracted by atmospheric pressure (process K-2). When the parts of the glass tube 530 are continuously heated, the heated parts melt with the bead 538 and the melted part of the glass tube 530 is sucked into the hollow part 538A of the bead 538, thereby contracting the hollow part 538A. Then, the melted part of the glass tube 530 is united with the melted bead 538 and seals the lower end of the glass tube 530, thereby completing the glass container 512 whose ends are sealed (process K-3) and also completing the fluorescent lamp 510.

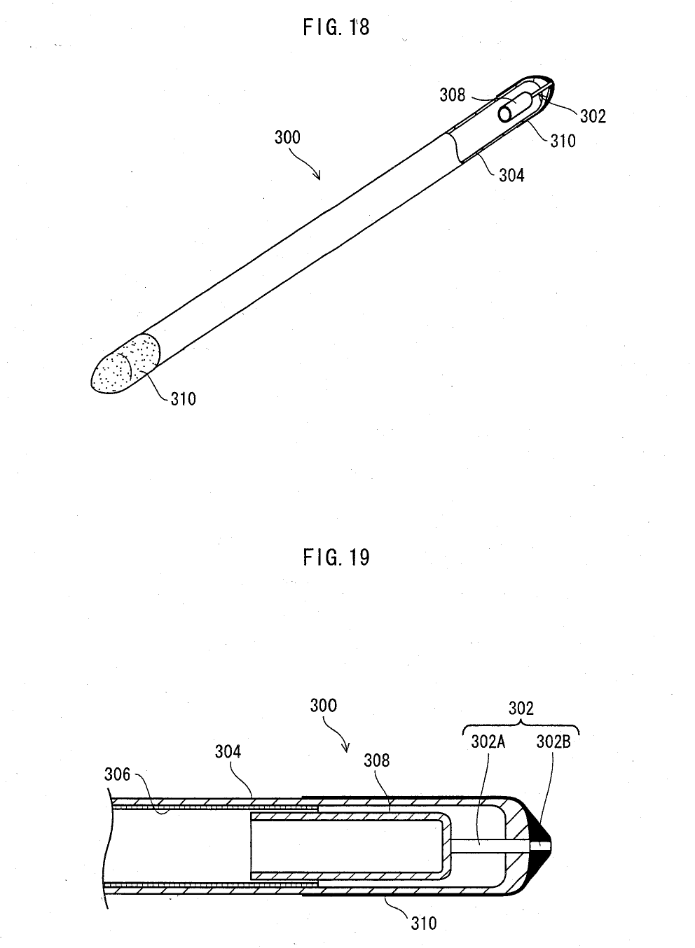

The following describes an embodiment where the discharge lamp according to the present invention is applied to a cold cathode fluorescent lamp, with reference to FIGS. 18 and 19.

### Embodiment 2-2

FIG. 18 is a perspective view in which a part of a cold cathode fluorescent lamp 300 (hereinafter simply referred to as “fluorescent lamp 300”) according to the present embodiment is cut away, and FIG. 19 is a vertical sectional view showing an end portion of the fluorescent lamp 300.

The fluorescent lamp 300 has a glass container 304 that is in the shape of a tube. The glass container 304 has a glass tube having a circular cross section whose ends have been sealed by lead wires 302. The glass container 304 is made of soft glass as seen in the fluorescent lamp 10 (see FIG. 13), and has, for example, a 730 [mm] entire length, a 4.0 [mm] outer diameter, and a 3.0 [mm] inner diameter.

The inside of the glass container 304 is filled with a mixed gas (not shown) composed of a plurality of rare gases including approximately 1200 [μg] mercury (not shown), argon (Ar) gas and neon (Ne) gas.

The inner surface of the glass container 304 has a phosphor layer 306 formed thereon. The phosphor layer 306 is formed from phosphors that are the same as the phosphors used for the fluorescent lamp 510 (see FIG. 13).

Each of the lead wires 302 is formed by connecting an inner lead wire 302A that is made of tungsten and an outer lead wire 302B that is made of nickel. The glass tube is sealed at the inner lead wire 302A. The inner lead wire 302A and the outer lead wire 302B each have a circular cross section. The inner lead wire 302A has a 20.8 [mm] diameter and a 3.0 [mm] entire length, and the outer lead wire 302B has a 0.6 [mm] diameter and a 1.0 [mm] entire length.

The inner lead wire 302A is supported by one end of the glass container 304. One end of the inner lead wire 302A, which is located at the inner end of the glass container 304, is bonded to an electrode 308 by laser welding or the like. The electrode 308 is a so-called hollow electrode in the shape of a tube having a closed end, and formed by processing a niobium rod. The hollow electrode is adopted as the electrode 308 because it is effective to prevent the sputtering of the electrode generated by discharge that occurs while the lamp is lit (see Japanese Patent Application Publication No. 2002-289138, etc. for detail).

A feed terminal 310 having an average thickness of 50 [μm] is formed on the outer surface of each of the ends of the glass container 304. Here, the “average thickness” refers to an average of thicknesses at part of the outer peripheral surface of the glass container 304. In the part thereof, the cylindrical shape is stable. The feed terminal 310 is bonded to the lead wire 302 (outer lead wire 302B) and electrically connected thereto. The feed terminal 310 is formed from a conductive film that is made of a fired material having the same components as those that constitute each of the first and second external electrodes 514 and 516 (FIG. 13) of the fluorescent lamp 510.

Discharge is generated between the electrodes 308 by supplying power via the feed terminals 310.

Note that in the fluorescent lamp 300, the Al—Ag paste is applied on the outer surface of the glass container 304 with use of a brush or such, to form the conductive film. It is also possible to use the above-described screen printing (see FIG. 15) to apply the paste on the outer peripheral surface (straight portion) of the glass container 304, and use a brush to apply the paste on the end surfaces of the glass container 304.

### Embodiment 2-3

Compared to the fluorescent lamp 300 according to the embodiment 2-2, a cold cathode fluorescent lamp according to the embodiment 2-3 further includes metal sleeves that are each attached to the respective ends of the glass container 304, so as to use the metal sleeves as feed terminals.

The metal sleeves are provided mainly because of the following reasons. Current required for a cold cathode fluorescent lamp has been increasing due to the advancement in high brightness of back light units in recent years. As the current increases, the heat value of an electrode becomes larger. When the electrode is overheated, various problems arise such as an increase in the sputtering of the electrode and a crack generated in parts of a glass container where lead wires have been sealed. Therefore, metal sleeves made of a material having high heat conductivity are provided, so as to appropriately release heat via a socket 608 (see FIG. 25) described below to prevent the overheat of the electrode.

### Embodiment 2-3-1

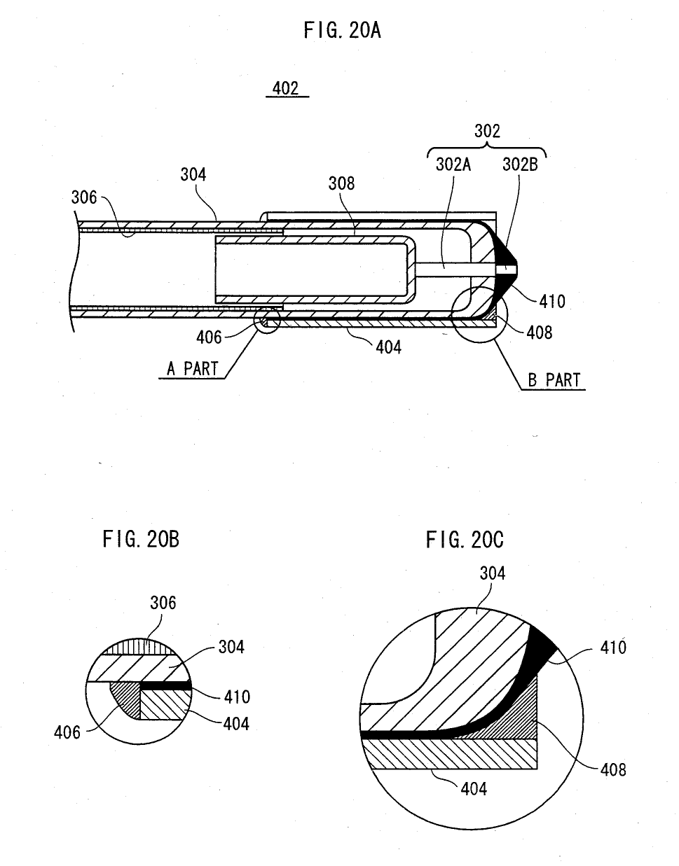

FIG. 20A is a vertical sectional view showing an end portion of a cold cathode fluorescent lamp 402 (hereinafter referred to as “fluorescent lamp 402”) according to the embodiment 2-3-1. Note that, in FIGS. 20A to 20C, components that are substantially the same as the components of the fluorescent lamp 300 according to the embodiment 2-2 have the same reference numbers shown in FIG. 19, and detailed descriptions thereof are omitted. Also note that although having a different reference number, a fired film 410 shown in FIG. 20 is the same conductive film as the feed terminal 310 in FIG. 19. Since the below-described metal sleeves are feed terminals in the embodiment 2-3-1, the name and reference number of the metal sleeves are changed.

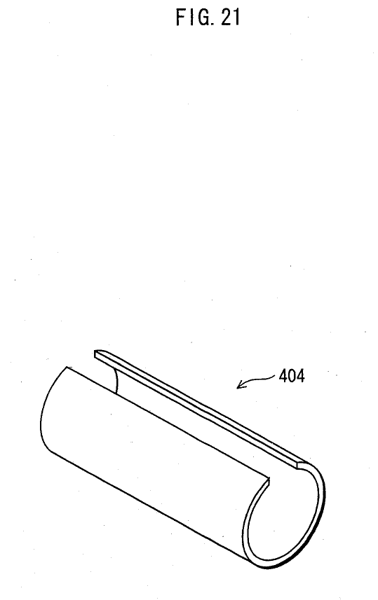

The fluorescent lamp 402 has a metal sleeve 404 as shown in FIG. 21. As shown in FIG. 20A, the metal sleeve 404 is attached to the glass container 304, having the fired film 410 therebetween. It is preferable that the metal sleeve 404 is made of copper or alloy 42 (Fe—Ni alloy 42) in view of heat conductivity. However, it is also possible to use molybdenum, tungsten, Kovar, etc.

The metal sleeve 404 is formed by a metal strip that is rolled to have a C-shaped cross section. Before the metal sleeve 404 is attached to the glass container 304, the inner diameter of the metal sleeve is smaller than the outer diameter of the glass container 304. When fixed to the glass container 304, the metal sleeve 404 is elastically deformed outward in the radial direction and attached firmly to the fired film 410 with its restoring force, and thereby fixed to the glass container 304.

The metal sleeve 404 may move in the tube axial direction of the glass container 304, if just attached to the glass container 304. Therefore, a stopper is provided for each end of the metal sleeve 404. The stoppers are made by melting solder alloy, and stop the metal sleeves 404 from moving.

FIG. 20B is a magnified view of A part in FIG. 20A, and FIG. 20C is a magnified view of B part in FIG. 20A.

As shown in FIG. 20B, one end of the metal sleeve 404 has a solder alloy part 406 that is formed by melting solder alloy. Also, as shown in FIG. 20C, the other end of the metal sleeve 404 has a solder alloy part 408 that is formed by melting solder alloy. The solder alloy part 406 is provided such that the solder alloy part 406 slightly projects from the straight portion, which is stable and cylindrical-shaped, of the glass container 304. The solder alloy part 408 is provided so as to fill the gap between the metal sleeve 404 and the fired film 410 in the radial direction of the glass container 304.

Each of the solder alloy parts 406 and 408 is formed from low-melting solder that is composed of bismuth in the range of 30 to 70 [Wt %] inclusive, copper in the range of 0.01 to 2.0 [Wt %] inclusive, and tin that constitutes the rest. Here, the low-melting solder has a melting point of less than or equal to 250[° C.]. The low-melting solder is used so as to prevent a heat crack that occurs when soft glass is used for the glass container.

The low-melting solder is a creamy mixture. This low-melting creamy solder is applied to the corresponding parts shown in FIGS. 20A to 20C with use of a brush, which is then placed in a reflow furnace to be heated from room temperature to approximately 270[° C.], so as to melt the low-melting creamy solder to be deposited on the metal sleeve 404.

The solder alloy parts 406 and 408 deposited on both ends of the metal sleeve 404 function as stoppers for stopping the metal sleeve 404 from moving in the axial direction of the glass container 304.

### Embodiment 2-3-2

In the embodiment 2-3-1, the metal sleeve 404 is stopped from moving by providing the solder alloy parts 406 and 408 at both ends of the metal sleeve 404. However, in the embodiment 2-3-2, a deposition layer of solder alloy is formed between almost the entirety of the inner surface of the metal sleeve 404 and the fired film 410.

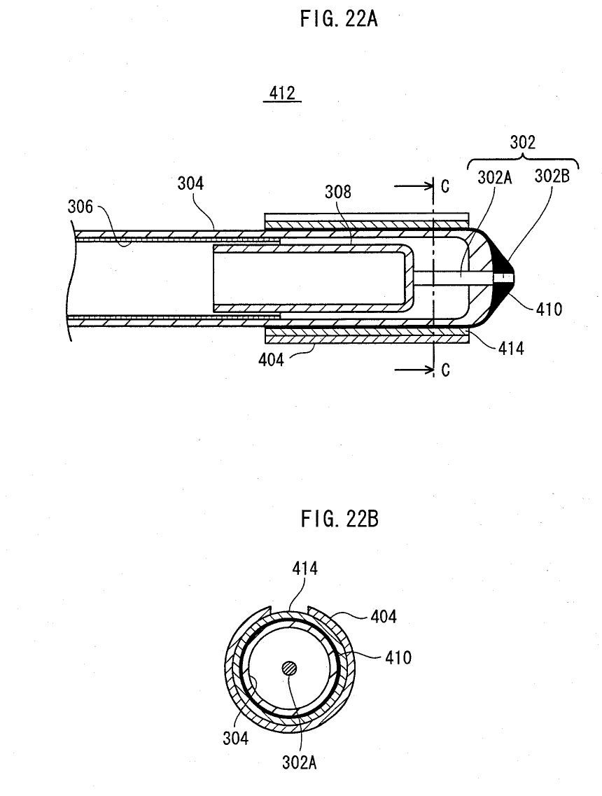

FIG. 22A is a vertical sectional view showing an end portion of a cold cathode fluorescent lamp 412 (hereinafter simply referred to as “fluorescent lamp 412”) according to the embodiment 2-3-2. FIG. 22B is a sectional view taken along the line C-C in FIG. 22A. Note that in FIGS. 22A and 22B, components that are substantially the same as the components of the fluorescent lamp 402 according to the embodiment 2-3-1 have the same reference numbers shown in FIG. 20, and detailed descriptions thereof are omitted.

The fluorescent lamp 412 has a solder alloy layer 414 between the metal sleeve 404 and the fired film 410. The solder alloy layer 414 is formed by depositing solder alloy, which has a low melting point as seen in the embodiment 2-3-1.

The low-melting solder is in the form of a sheet. The metal sleeve 404 is attached to an end of the glass container 304, after this low-melting solder sheet is wound around the glass container 304. Then, as in the embodiment 2-3-1, the glass container 304 having the low-melting solder sheet and metal sleeve 404 is placed in the reflow furnace to be heated from room temperature to approximately 270[° C.], so that the low-melting solder sheet is melt and deposited on the metal sleeve 404.

Since the main component of the fired film 410 is aluminum, the low-melting solder does not adhere to the fired film 410 firmly. However, since the melted low-melting solder enters the microscopic recessed parts of the surface of the fired film 410 and is solidified to be the solder alloy layer 414, the solder alloy layer 414 functions as a stopper for stopping the metal sleeve 404 from moving in the axial direction of the glass container 304.

### Embodiment 2-3-3

Having a C-shaped cross section, the metal sleeve 404 described in the embodiments 2-3-1, and 2-3-2 does not cover the entire periphery of the glass container 304. However, a metal sleeve in the embodiment 2-3-3 covers the entire periphery of the glass container 304.

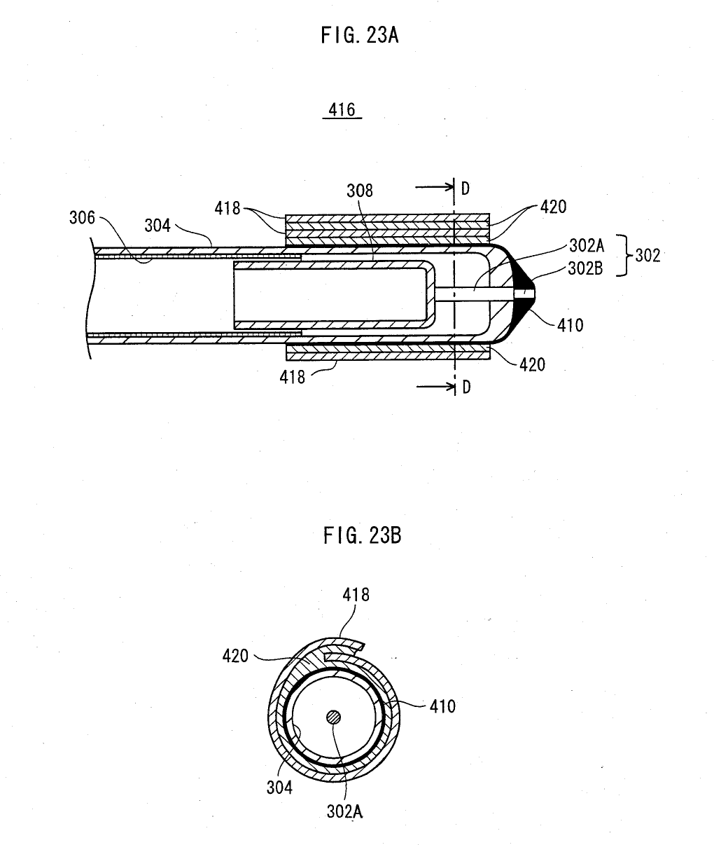

FIG. 23A is a vertical sectional view showing an end portion of a cold cathode fluorescent lamp 416 (hereinafter simply referred to as “fluorescent lamp 416”) according to the embodiment 2-3-3. FIG. 23B is a sectional view taken along the line D-D in FIG. 23A. Note that, in FIG. 23, components that are substantially the same as the components of the fluorescent lamp 402 according to the embodiment 2-3-1 have the same reference numbers shown in FIG. 20, and detailed descriptions thereof are omitted.

As shown in FIG. 23B, a metal sleeve 418 of the embodiment 2-3-3 completely covers the entire periphery of the glass container 304 such that one end portion of the metal sleeve 418 in the circumferential direction of the glass container 304 overlaps with the other end portion thereof. This improves thermal dissipation.

A solder alloy layer 420 is formed on a substantially entire surface of the inner periphery of the metal sleeve 418.

The solder alloy layer 420 can be formed with use of a low-melting solder sheet, in the same manner as the embodiment 2-3-2. In this case, the low-melting solder sheet is adhered to the inner peripheral surface of the metal sleeve 418 before the metal sleeve 418 is attached to the glass container 304, and then the metal sleeve 418 having the solder sheet is attached to the glass container 304. After that, as seen in the embodiments 2-3-1 and 2-3-2, the glass container 304 having the solder sheet is placed in a reflow furnace to be heated from room temperature to approximately 270[° C.], so as to melt the solder sheet to be deposited on the metal sleeve 418.

Note that the solder alloy layer 420 functions as a stopper for stopping the metal sleeve 418 from moving in the axial direction of the glass container 304, in the same manner as the embodiment 2-3-2.

(Variation 1)

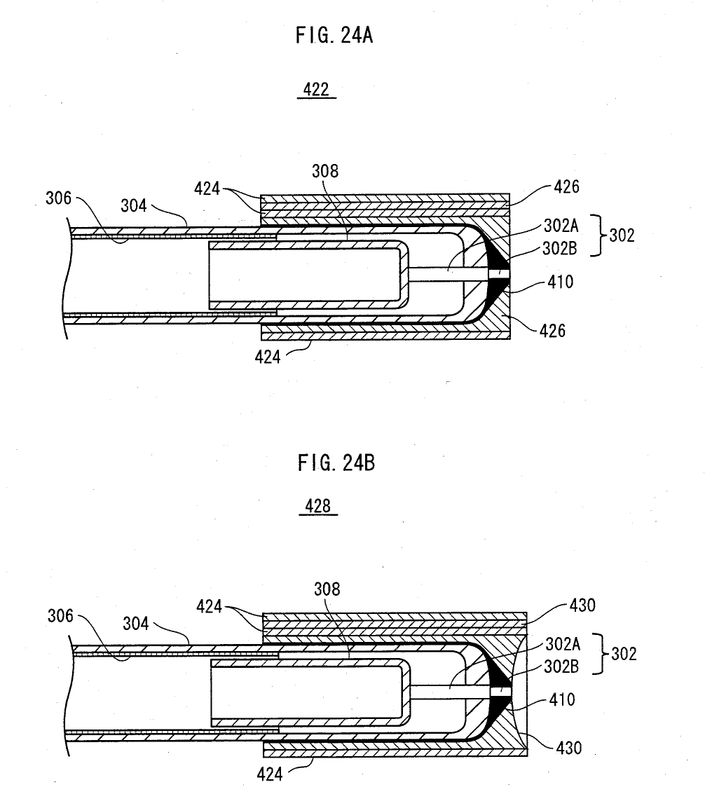

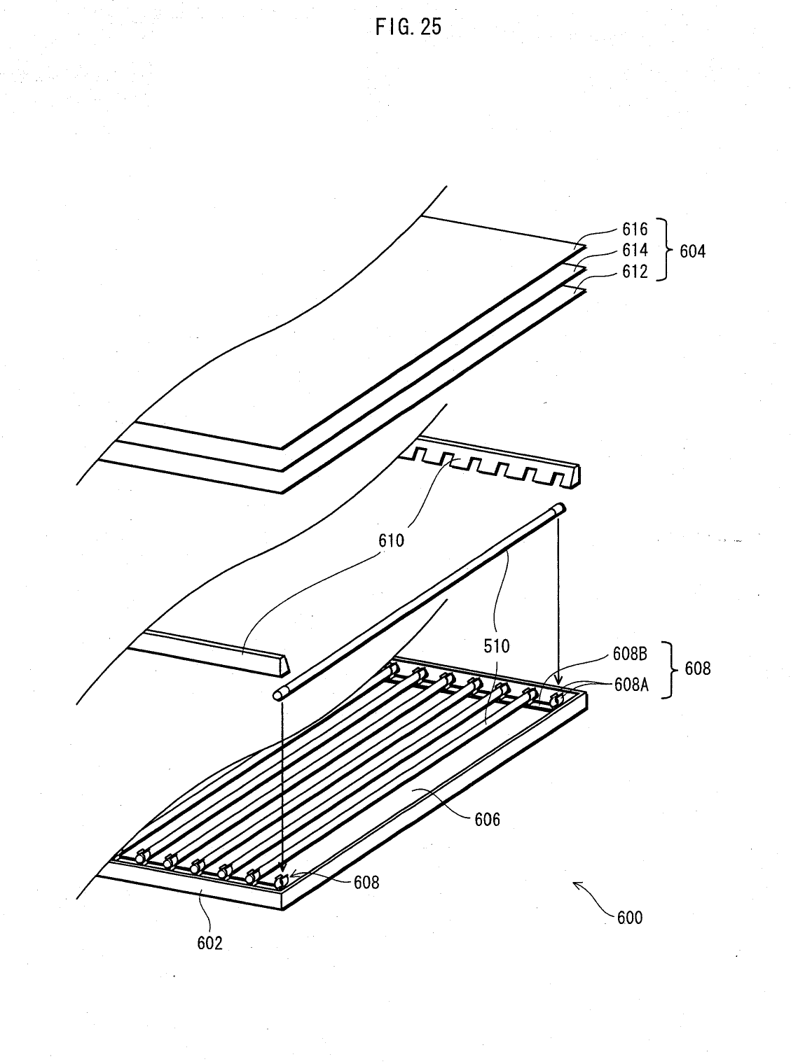

FIG. 24A shows a vertical sectional view showing an end portion of a cold cathode fluorescent lamp 422 (hereinafter referred to as “fluorescent lamp 422”) according to the variation 1 of the embodiment 2-3-3.

The fluorescent lamp 422 is different from the fluorescent lamp 416 (FIG. 23) on the point that a metal sleeve 424 is extended longer than the end of the glass container 304, and the inside of the extended part is filled with a solder alloy layer 426.

This improves thermal dissipation from the ends of the glass container 304.

Note that in the variation 1, the inside of the end of the metal sleeve 424 cannot be filled with the solder alloy layer 426 if only the low-melting solder sheet is used. Therefore, part that does not have the solder alloy layer 426 is filled with the above-mentioned low-melting creamy solder.

Note that the shape of the cross section of the metal sleeve 424 is the same as that of the metal sleeve 418 of the embodiment 2-3-3 shown in FIG. 23B.

(Variation 2)

FIG. 24B is a vertical sectional view of an end portion of a cold cathode fluorescent lamp 428 (hereinafter simply referred to as “fluorescent lamp 428”) according to the variation 2 of the embodiment 2-3-3.

In the fluorescent lamp 422 of the variation 1, the end surface of the solder alloy layer 426 is flat (see FIG. 24A). However, the fluorescent lamp 428 of the variation 2, the end surface of a solder alloy layer 430 is in the shape of a concave.

When the end surface is in the shape of a concave as described above, the area for thermal dissipation is increased and thereby thermal dissipation via air is improved.

### Embodiment 2-4

FIG. 25 is an exploded perspective view of a backlight unit 600 according to the present embodiment. As shown in FIG. 25, the backlight unit 600 is of a directly-below type, and includes a case 602, a plurality of fluorescent lamps 60, and an optical sheet lamination 604. The case 602 is in the shape of a flat rectangular parallelepiped whose one face is open, the plurality of fluorescent lamps 60 are housed in the case 602, and the optical sheet lamination 604 covers the opening of the case 602. The backlight unit 600 is provided on the back of a liquid crystal panel (not shown) and used as a light source device in a liquid crystal display device.

The case 602 is made of, for example, polyethylene terephthalate (PET). The case 602 has a reflection surface 606 on the inner surface thereof, the reflection surface 606 being formed by metals such as silver and aluminum being evaporated on the inner surface of the case 602. Note that the case 602 may be made of materials other than resin. For example, the case 602 may be made of metals such as aluminum, cold rolled steel (SPCC, for example), and the like. Also, the reflection surface 606 formed on the inner surface does not necessarily need to be a film formed by evaporating metal. Instead, the reflection surface 606 can be formed by, for example, adhering a reflection sheet having an improved reflectivity to the case 602. The reflectivity of the reflection sheet is improved by adding calcium carbonate, titanium dioxide (TiO₂), and such to polyethylene terephthalate (PET) resin.

Arranged inside the case 602 are, for example, the fluorescent lamp 510 according to the embodiment 2-1, a pair of sockets 608, and a pair of covers 610.

The pair of sockets 608 are arranged substantially in parallel, with a space therebetween in the lengthwise direction of the case 602.

The socket 608 is formed by processing a plate material (strip material) that is made of copper alloy, such as phosphor-bronze plate. The socket 608 is formed by a pair of nipping members 608A and a connecting member 608B that are arranged in series in the shorter direction of the case 602. The pair of nipping members 608A are provided so as to place the external electrode 514 (516) of the fluorescent lamp 510 therein, and the connecting member 608B is provided at the bottom edge of the pair of nipping members 608A so as to electrically connect the pair of nipping members 608A to an adjacent pair of nipping members 608A. When the external electrode 514 (516) of the fluorescent lamp 510 is placed between the pair of nipping members 608A, the fluorescent lamp 510 is held by the pair of nipping members 608A, and the pair of nipping members 608A is electrically connected to the external electrode 514 (516). Then, power is supplied via the socket 608 from a lighting circuit (not shown) of the backlight unit 600 to the fluorescent lamp 510 attached to the pair of sockets 608.

The cover 610 is provided to secure insulation between the pairs of nipping members 608A that are adjacent to each other.

The optical sheet lamination 604 is formed by, for example, a diffusion plate 612, a diffusion sheet 614, and a lens sheet 616. The diffusion plate 612 has, for example, a plate-like body made of polymethylmethacrylate (PMMA) resin, and is arranged so as to close the opening of the case 602. The diffusion sheet 614 is made of, for example, polyester resin. The lens sheet 616 is formed, for example, by bonding an acrylic resin to polyester resin. The sheets of the optical sheet lamination 604 are arranged in a manner that each sheet thereof is laminated on the diffusion plate 612 in series.

Note that the liquid crystal display device of the present embodiment can be formed with use of the backlight unit 600, in the same manner as the embodiment 1.

The above explains the present invention based on the embodiment 2. However, it is not limited to the embodiment described above. For example, the following embodiments are also acceptable.
(1) In the above-described embodiment, the glass container is made of soft glass. However, the glass container can be made of hard glass such as borosilicate glass.

It has already been realized in the above-described conventional techniques 1 and 2 that, in the case of using hard glass, the external electrode is formed by a material other than a metal tape.

However, the external electrode in the technique of the present embodiment does not include any environmentally harmful substances while the external electrode according to the conventional technique 1 does. Also, the technique of the present embodiment only needs one firing process while the conventional technique 2 requires two processes, which are a firing process and a dipping process. Therefore, the technique of the present embodiment is highly advantageous even when hard glass is used.
(2) It is possible to improve the in-dark start characteristic when soft glass is used to form the glass container. In other words, soft glass includes a large amount of alkali metal oxide typified by sodium oxide (Na₂O), as described above. For example, in a case where the alkali metal oxide is sodium oxide, natrium (Na) component leaches from the sodium oxide to the inner surface of the glass container over time. It is considered that natrium that leaches into the inner end of the glass container improves the in-dark start characteristic because of its low electronegativity.

In the external electrode fluorescent lamp, the content ratio of alkali metal oxide in the material of a glass container is preferably in the range of 3 [mol %] to 20 [mol %] inclusive.

For example, in a case where the alkali metal oxide is sodium oxide, the content ratio of the sodium oxide is preferably in the range of 5 [mol %] to 20 [mol %] inclusive. If the content ratio of the sodium oxide is less than 5 [mol %], the probability of the in-dark start time exceeding 1 second becomes high (in other words, the probability becomes high of the in-dark start time being within one second when the content ratio is greater than or equal to 5 [mol %]), and if exceeding 20 [mol %], prolonged use causes problems such as blackening (browning) or whitening of the glass container, resulting in a decline in brightness, a decline in the strength of the glass container, etc.

Also, using lead-free glass is preferable in consideration of environmental protection. However, there are cases in the manufacturing process of lead-free glass in which lead is included as an impurity. Therefore, glass that contains an impurity level of lead that is less than or equal to 0.1 [Wt %] is also defined as lead-free glass.
(3) In the present embodiment, the lamp is in the shape of a straight tube (see FIGS. 13 and 18). However, the present invention is applicable for a lamp that is U-shaped, squared U-shaped, or L-shaped. Also, the cross section of the glass container is not limited to having a cylindrical shape, but may have an elliptical shape or any other flat shape.
(4) Also, the present invention is not limited to an external electrode discharge lamp and a cold cathode discharge lamp, but is also applicable to a discharge lamp having a different type of electrode. In short, the present invention is applicable to any discharge lamp as long as the lamp has a conductive film formed on the outer surface of an airtight glass container and power is supplied to the lamp via the conductive film.
(5) In the embodiment described above, the fluorescent lamp 510 (FIG. 13) is used as the light source of the backlight unit. However, it is possible to use the fluorescent lamp 300 (FIGS. 18 and 19), the fluorescent lamp 402 (FIG. 20), the fluorescent lamp 412 (FIG. 22), the fluorescent lamp 416 (FIG. 23), the fluorescent lamp 422 (FIG. 24A), or the fluorescent lamp 428 (FIG. 24B), instead of the fluorescent lamp 510.
(6) Paste for forming the conductive film, which is used for the external electrodes 514 and 516, and the fired film 410, is formed from mixed metal powder including aluminum powder and silver powder. However, the paste is not limited to such, and it is possible to use atomized alloy powder of aluminum and silver whose primary component is aluminum and whose secondary component is silver. The range of weight % [Wt %] of the aluminum component in the paste and the range of weight % [Wt %] of the silver component in the paste in the case of using atomized alloy powder are the same as the above-described ranges of weight % [Wt %] in the case of using mixed metal powder. In other words, the aluminum component is included in the range of greater than or equal to 30 [Wt %], the silver component is included in the range of 5 to 30 [Wt %] inclusive, frit glass is included in the range of 15 to 25 [Wt %] inclusive, and the rest of the materials in the paste includes a dispersant, a solvent and such.

Therefore, the ratios of aluminum, silver, and glass included in the external electrode (fired material) and the fired film respectively are of course the same as the ratios when mixed metal powder is used. In other words, the aluminum is included in the range of greater than or equal to 35 [Wt %], the silver is included in the range of 6 to 40 [Wt %] inclusive, and the rest is glass and such.

Even when focusing only on the metal components of the external electrode (fired material) and the fired film, the ratios of the metal components are the same as the case where mixed metal powder is used. In other words, the ratio of aluminum is greater or equal to 50 [Wt %], and the ratio of silver is in the range of 7 [Wt %] to 50 [Wt %] inclusive.

### Embodiment 3

The embodiment 1 realizes a fluorescent lamp favorable as a light source of the backlight unit, such as a fluorescent lamp in which the color reproducibility after the light of the lamp has transmitted through the color filters is higher than that of a conventional lamp. In view of the background art described below, the embodiment 3 pertains to a technique for improving chromaticity difference in the tube ends of the lamp, the chromaticity difference being caused due to a manufacturing method of the phosphor layer.

In the fluorescent lamp, the phosphor layer is formed on the inner surface of the tube-shaped glass container in the following manner.

First, a glass tube, which is a material of the glass container, is held vertically to immerse the lower end portion of the glass tube in a suspension liquid that includes red phosphor particles, blue phosphor particles, and green phosphor particles. After the suspension liquid is suctioned from the upper end of the glass tube up to a predetermined height, the glass tube is removed from the suspension liquid. In this way, excess suspension liquid drains from the lower end of the glass tube under its own weight, and the remaining suspension liquid adheres as a film to a predetermined area of the inner surface of the glass tube. After blowing air from the upper end of the glass tube into the glass tube to dry the suspension liquid that is adhered as the film, firing is performed so as to cause the dried suspension liquid to form a phosphor layer (Japanese Patent Application Publication No. 2004-186090).

However, it is known that when a fluorescent lamp is manufactured in the above-described manner, a chromaticity difference occurs in the lengthwise direction of the tube-shaped glass container. The degree of the chromaticity difference is evaluated as a difference of chromaticity between the end portions of the glass container (tube-end chromaticity difference).

Meanwhile, due to the development of high-quality color reproduction as part of the high-quality image technique of a liquid crystal display device such as a liquid crystal television in recent years, there is a demand for expansion in the reproducible chromaticity range of a fluorescent lamp used for a backlight unit, namely a demand for expansion in an NTSC triangle whose vertices are the chromaticity coordinate values of red, blue, and green phosphors in the CIE 1931 chromaticity diagram. There is also a demand for a high quality color temperature in a fluorescent lamp due to a change in the specification of a blue color filter of a liquid crystal display device.

Here, conventionally used as a blue phosphor is europium-activated barium-magnesium aluminate [BaMg₂Al₁₆O₂₇:Eu²⁺] (abbreviation: BAM, chromaticity coordinates: x=0.148, y=0.055). However, if a compound having a higher purity than the above-mentioned BAM is used as a blue phosphor (for example, europium-activated strontium-chloroapatite [Sr₁₀(PO₄)₆Cl₂:Eu²⁺] (abbreviation: SCA, chromaticity coordinates: x=0.153, y=0.030), there occurs a difference in color that is problematic to the naked eye, although there is no significant change in the tube-end chromaticity difference. This is because the smaller chromaticity coordinates become, the smaller the chromaticity difference discrimination ellipse by the color discrimination experiment of MacAdam becomes (in this case, the coordinate value of y especially has a strong influence)

Specifically, when the suspension liquid is adhered to the inner surface of the glass container in the above-described manufacturing process, the lower the suspension liquid is adhered in the glass tube from the upper end portion, the higher the degree of blueness of the suspension liquid is.

In view of the above-described problem, it is the further object of the embodiment 3 to provide a fluorescent lamp in which the tube-end chromaticity difference has been further suppressed and a manufacturing method the fluorescent lamp, and a backlight unit and a liquid crystal display device that have the fluorescent lamp.

To achieve the above-described object, in the embodiment 3, the present invention provides a fluorescent lamp having a tubular glass container that has a phosphor layer formed on an inner surface of the glass container, wherein each of the red phosphor, the green phosphor, and the blue phosphor is composed of a plurality of particles, and in an x-y Cartesian coordinate system in which a horizontal axis x represents a diameter [μm] of each blue phosphor particle and a vertical axis y represents a volume percent [%] of said each blue phosphor particle in a total of the blue phosphor, the blue phosphor has a particle size distribution represented by a graph that intersects with a first curve represented by y=−0.000007x⁶+0.0008x⁵−0.0368x⁴+0.8326x³−9.1788x²+38.889x+7.092 in a range where x is greater than or equal to 10.8, passes through a region surrounded by the first curve and a second curve represented by y=0.0457x²−2.4896x+33.294, and converges on the horizontal axis x in a range of substantially 14≦x≦20.

Furthermore, in the embodiment 3, the present invention provides a fluorescent lamp having a tubular glass container that has a phosphor layer formed on an inner surface of the glass container, wherein each of the red phosphor, the green phosphor, and the blue phosphor is composed of a plurality of particles, and the blue phosphor includes 19 [volume %] of blue phosphor particles that each have a diameter in a range of 10 [μm] to 30 [μm] inclusive, in a total of the blue phosphor.

Also, in the embodiment 3, the present invention provides a backlight unit including the above-described fluorescent lamp as a light source.

Furthermore, in the embodiment 3, the present invention provides a liquid crystal display device including a liquid crystal display panel, wherein the backlight unit further includes an envelope for housing the fluorescent lamp, the envelope being arranged on a back surface of the liquid crystal display panel.

Also, in the embodiment 3, the present invention provides a manufacturing method of the fluorescent lamp, comprising the steps of: a first step for suctioning a suspension liquid that includes a red phosphor, a green phosphor, and a blue phosphor each of which is composed of a plurality of particles, from a first end portion of a glass tube of the fluorescent lamp while a second end portion thereof is immersed in the suspension liquid; a second step for causing part of the suspension liquid that has been suctioned to drain from the second end portion under its own weight of the suspension liquid; and a third step for (i) drying the suspension liquid that remains in a glass tube by being adhered as a film to an inner surface of the glass tube, and (ii) forming a phosphor layer by firing the remaining suspension liquid, wherein in an x-y Cartesian coordinate system in which a horizontal axis x represents a diameter [μm] of each blue phosphor particle and a vertical axis y represents a volume percent [%] of said each blue phosphor particle in a total of the blue phosphor, the blue phosphor in the suspension liquid has a particle size distribution represented by a graph that intersects with a first curve represented by y=−0.000007x⁶+0.0008x⁵−0.036x⁴+0.8326x³−9.1788x²+38.889x+7.092 in a range where x is greater than or equal to 10.8, passes through a region surrounded by the first curve and a second curve represented by y=0.0457x²−2.4896x+33.294, and converges on the horizontal axis x in a range of substantially 14≦x≦20.

Also, in order to achieve the above-described object, in the embodiment 3, the present invention provides a manufacturing method of the fluorescent lamp, comprising the steps of: a first step for suctioning a suspension liquid that includes a red phosphor, a green phosphor, and a blue phosphor each of which is composed of a plurality of particles, from a first end portion of a glass tube of the fluorescent lamp while a second end portion thereof is immersed in the suspension liquid; a second step for causing part of the suspension liquid that has been suctioned to drain from the second end portion under its own weight of the suspension liquid; and a third step for (i) drying the suspension liquid that remains in a glass tube by being adhered as a film to an inner surface of the glass tube, and (ii) forming a phosphor layer by firing the remaining suspension liquid, wherein the blue phosphor in the suspension liquid includes 19 [volume %] of blue phosphor particles that each have a diameter in a range of 10 [μm] to 30 [μm] inclusive, in a total of the blue phosphor.

As described below, conventionally, a blue phosphor scarcely include particles whose diameter is greater than or equal to 10 [μm]. However, according to the fluorescent lamp of the embodiment 3, the blue phosphor particles whose diameter is greater than or equal to 10 [μm] are included at a predetermined amount [volume %] as described above, whereby the tube-end chromaticity difference becomes even smaller.

The following describes the embodiment 3, with reference to drawings.

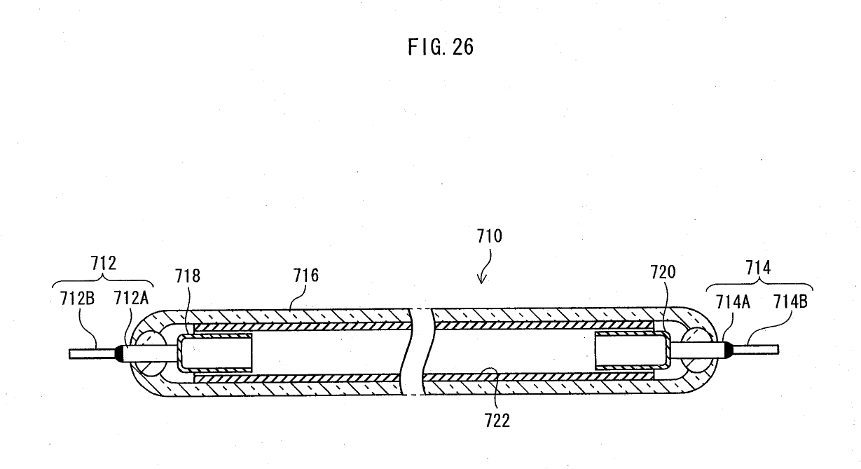

FIG. 26 is a vertical sectional view showing a schematic structure of a cold cathode fluorescent lamp 710 (hereinafter simply referred to as “fluorescent lamp 710”) according to the present embodiment. Note that in all the figures including FIG. 26, the contraction scale between each component is not unified.

The fluorescent lamp 710 includes a glass container 716 that has a tube shape. The glass tube of the glass container 716 has a circular cross section, and one end of the glass tube is sealed by a lead wire 712 and another end thereof is sealed by a lead wire 714. The glass container 716 is made of hard borosilicate glass, and has, for example, a 900 [mm] entire length, a 3.4 [mm] outer diameter, and a 2.4 [mm] inner diameter.

Also the inside of the glass container 716 is filled with a mixed gas composed of a plurality of rare gases (not shown) including approximately 3 [mg] mercury (not shown), argon (Ar) gas and neon (Ne) gas, etc.

The lead wire 712 is formed by connecting an inner lead wire 712A and an outer lead wire 712B, and the lead wire 714 is formed by connecting an inner lead wire 714A and an outer lead wire 714B. The inner lead wires 712A and 714A are made of tungsten and the outer lead wires 712B and 714B are made of nickel. Note here that the outer lead wires may be made of nickel alloy. Each end of the glass tube is sealed at a part of the inner lead wire 712A and at a part of the inner lead wire 714A, respectively. Each of the inner lead wires 712A and 714A, and the outer lead wires 712B and 714B has a circular cross section. The inner lead wires 712A and 714A each has a 1.0 [mm] diameter and a 3.0 [mm] entire length, and the outer lead wires 712B and 714B each have a 0.8 [mm] diameter and a 1.0 [mm] entire length.

The inner lead wires 712A and 714A are supported by the respective ends of the glass container 716. One end of the inner lead wire 712A is bonded to an electrode 718, and one end of the inner lead wire 714A is bonded to an electrode 720, by laser welding or the like. Here, each of the one end of the inner wire 712A and the one end of the inner wire 714A is located at a different one of inner ends of the glass container 716. Each of the electrodes 718 and 720 is a so-called hollow electrode in the shape of a tube having a closed end, and formed by processing a niobium rod. The hollow electrode is adopted for each of the electrodes 718 and 720 because the hollow electrode is effective to prevent the sputtering of the electrodes generated by discharge that occurs while the lamp is lit (see Japanese Patent Application Publication No. 2002-289138, etc. for detail).

Also, the glass container 716 has a phosphor layer 722 formed on an inner surface thereof. The average thickness of the phosphor layer 722 is, for example, approximately 20 [μm]

The phosphor layer 722 includes a red phosphor, a green phosphor, and a blue phosphor. Each of the phosphors is composed of numerous (a plurality of) particles.

The following are phosphor materials that are conventionally used for forming the respective color phosphor particles. Note that a chromaticity diagram in the present specification refers to the chromaticity diagram CIE 1931, and chromaticity coordinates indicate a value in the chromaticity diagram CIE 1931.

(1) Red Phosphor Material

Europium-activated yttrium oxide [Y₂O₃:Eu³⁺ (Abbreviation: YOX), chromaticity coordinates: x=0.643, y=0.348

(2) Green Phosphor Material

Cerium-and-terbium-activated lanthanum phosphate [LaPO₄:Ce³⁺, Tb³⁺] (abbreviation: LAP), chromaticity coordinates: x=0.351, y=0.585

(3) Blue Phosphor Material

Europium-activated barium-magnesium aluminate [BaMg₂Al₁₆O₂₇:Eu²⁺] (abbreviation: BAM-B), chromaticity coordinates: x=0.148, y=0.055

When a cold cathode fluorescent lamp is used as the light source of a backlight unit included in a liquid crystal display device, such as a liquid crystal TV, the following are used for green and blue phosphor materials in the present embodiment, so as to increase the reproducible chromaticity range, in other words, to expand the NTSC triangle in the chromaticity diagram. Note that a red phosphor material is the same as a material described in the above (1).

(1) Green Phosphor Material

Europium-and-manganese-activated barium magnesium aluminate [BaMg₂Al₁₆O₂₇:Eu²⁺,Mn²⁺] (Abbreviation: BAM-G), chromaticity coordinates: x=0.136, y=0.572

(2) Blue Phosphor Material

Europium-activated strontium chloroapatite [Sr₁₀(PO₄)₆Cl₂:Eu²⁺] (abbreviation: SCA), chromaticity coordinates: x=0.153, y=0.030

Note that the chromaticity coordinate values of the phosphor (powder) described in the present specification are values measured with use of a spectroscopic value analyzer (MCPD-7000) manufactured by Otsuka Denki Co., Ltd. that have been rounded to the fourth digit after the decimal point.

Also, the above-described chromaticity coordinate values are representative values of the respective phosphor materials, and the values may be slightly different from the above-described values, depending on a measurement method (measurement principle), etc.

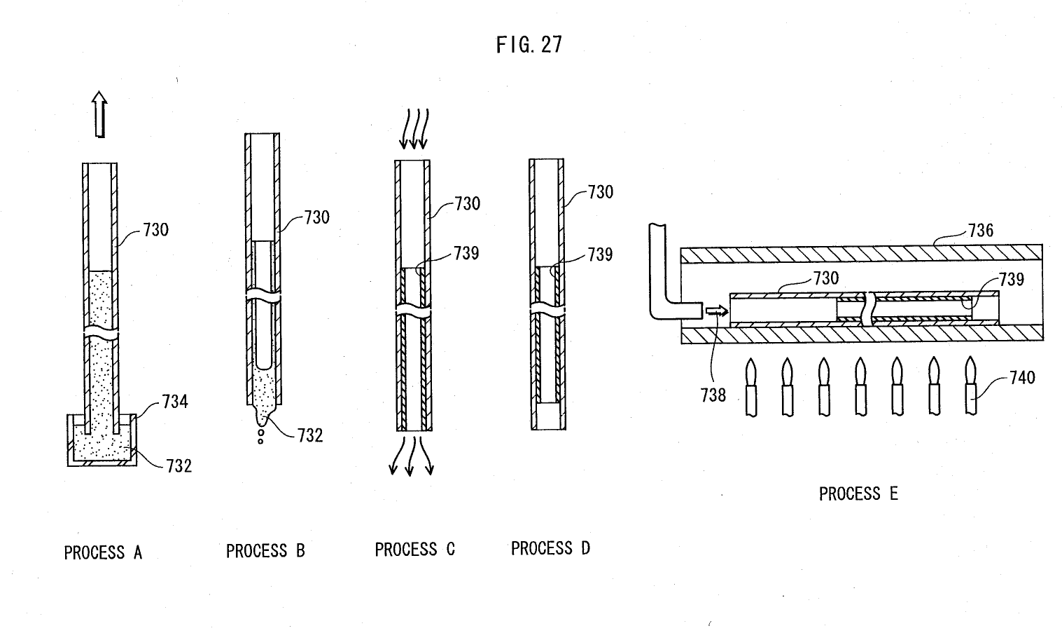

The following describes a process pertaining to the formation of the phosphor layer 722, which is included in the manufacturing process of the fluorescent lamp 710 having the above-described structure, with reference to FIG. 27.

In the process A, a suspension liquid including phosphor particles is adhered to the inner surface of the glass tube 730 which is a raw material of the glass container 716.

Specifically, a tank 734 containing a suspension liquid 732 is prepared first. The suspension liquid 732 is obtained by adding a predetermined amount of each color phosphor particle, CBB particles as a binding agent, and nitrocellulose (NC) as a thickening agent, to butyl acetate as an organic solvent. Note that the suspension liquid 732 in the tank 734 is in a state where materials thereof are uniformly mixed by being agitated by an agitator that is not shown in figures.

Then, the glass tube 730 is held vertically to immerse the lower end portion of the glass tube 730 in the suspension liquid 732. A negative pressure is created by exhausting air that exists inside the glass tube 730 from the upper end of the glass tube 730, with use of the suction power of the vacuum pump that is not shown in figures, thereby suctioning the suspension liquid 732. The suction is stopped when the liquid level in the glass tube 730 reaches partway to the upper end (a predetermined height) of the glass tube 730, and the glass tube 730 is removed from the suspension liquid 732.

In this way, the excess amount of the suspension liquid 732 drains from the lower end of the glass tube 730 under its own weight, and the suspension liquid 732 that has remained inside the glass tube 730 adheres as a film to a predetermined area of the inner peripheral surface of the glass tube 730 (process B).

After blowing hot dry air into the glass tube 730 to dry the suspension liquid 732 that is adhered as the film (process C), a portion of a dry film 739 is removed from the vicinity of the end of the glass tube 730 from which the suspension liquid 732 has been suctioned (process D).

Next, as shown in process E, the glass tube 730 is inserted into a quartz tube 736 to be tilted horizontally. While air 738 is being sent into the quartz tube 736, the glass tube 730 is fired by heating the glass tube 730 from outside the quartz tube 736 with use of a burner 740. When the firing process is completed, the phosphor layer 722 is formed on the inner surface of the glass tube 730.

In a case where the phosphor layer is formed in the above-described manner, a chromaticity difference occurs in the tube axial direction of the tube-shaped glass container 716 when the fluorescent lamp 710 is lit, which has already been mentioned above. The chromaticity difference occurs when there is an unbalance in a ratio (hereinafter referred to as a “reference ratio”) between each of the color phosphor particles, which has been predetermined in a manner that the lamp emits white light. It is considered that the unbalance of the ratio is caused because of the following reasons.

It is considered that each of the color phosphor particles in the suspension liquid that has been suctioned into the glass tube 730 in the process A exists substantially at the reference ratio. However, each of the color phosphor particles is different in size and specific gravity. Therefore, when the suspension liquid drains from the lower end of the glass tube 730 in process B, each of the color phosphor particles is adhered to a different position of the inner wall of the glass tube. Also, some color phosphor particles may remain in the vicinity of the inner wall of the glass tube, and others may not. Furthermore, the moving speeds of the respective color phosphor particles moving downward are not uniform. Because of these reasons, the ratio between each of the color phosphor particles deviates from the reference ratio.

As a result, when the suspension liquid is adhered to the inner surface of the glass tube, the suspension liquid in the upper end portion of the glass tube has a higher degree of redness, and the suspension liquid in the lower end portion thereof has a higher degree of blueness (in other words, the lower the suspension liquid is adhered in the glass tube from the upper end portion, the higher the degree of blueness of the suspension liquid is). Here, when the suspension liquid is adhered to the inner surface of the glass tube, a portion of the glass container that corresponds to the upper end portion of the glass tube is referred to as “container's upper end portion”, and a portion of the glass container that corresponds to the lower end portion of the glass tube is referred as “container's lower end portion”. Note that the chromaticity of each of the container's upper end portion and the, container's lower end portion is a measured value obtained by measuring the chromaticity at a position that is 30 [mm] closer toward the center of the glass container in the tube direction from the edge of the phosphor layer corresponding to the edge of the glass container.

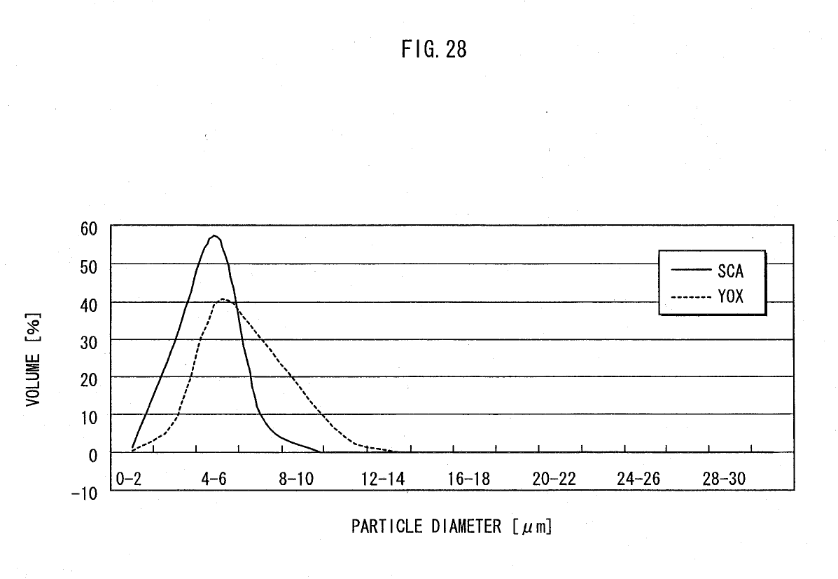

The above phenomenon, the chromaticity difference, is believed to be caused due to an unbalance in the ratio between the red phosphor particles and the blue phosphor particles. Therefore, the particle size distribution has been examined of each of the red phosphor particles (YOX) and the blue phosphor particles (SCA) that cause a problematic chromaticity difference in the tube ends of the lamp. FIG. 28 shows a result of the examination.

In the particle size distribution chart of FIG. 28, the horizontal axis of the chart represents the diameter [μm] of each of the blue phosphor particles and each of the red phosphor particles, and the vertical axis of the chart represents each of (i) the percentage by volume [%] of said each blue phosphor particles in the total of the blue phosphor and (ii) the percentage by volume [%] of said each of the red phosphor particles in the total of the red phosphor. In FIG. 28, when the number of large-diameter particles included in phosphor particles is assumed to be the same as the number of small-diameter particles included in phosphor particles, a volume % corresponding to the large-diameter particles has a higher value than a volume % corresponding to the small-diameter particles.

It can be seen from FIG. 28 that there is no significant difference among the diameters of the phosphor particles that occupy the largest volume. Also, the diameters of the red phosphor particles included in the red phosphor are larger than the diameters of the blue phosphor particles included in the blue phosphor. Here, the specific gravity of the blue phosphor material (SCA) is 4.2 [g/cm³], and the specific gravity of the red phosphor material (YOX) is 5.1 [g/cm³].

In a case where a red phosphor particle and a blue phosphor particle have the same diameter, the red phosphor particle is more likely to slide downward in the process B (FIG. 27), since the specific gravity of the red phosphor particle is heavier than that of the blue phosphor particle. Also, in a case where particles having various diameters are caused to flow freely, a particle having a larger diameter is considered to be more likely to slide downward.

When making a guess as to the present matter based on the above described points and phenomenon, the red phosphor particle is more likely to slide downward than the blue phosphor particle, since the red phosphor particle has a greater specific gravity and a larger diameter. In the process C (FIG. 27), a film made of the suspension liquid starts getting dried from the upper part of the film to the lower part thereof. This means that the closer to the lower end of the glass tube it is, the more red phosphor particles slide downward than the blue phosphor particles. Therefore, it is assumed that more red phosphor particles fall out of the glass tube as compared to the blue phosphor particles, resulting in the degree of blueness being higher at a lower part of the glass tube.

Since it is difficult to adjust the specific gravities of phosphors, the inventors of the present application thought that the above-described tube-end chromaticity difference might be reduced by increasing the number of blue phosphor particles having a large diameter.

Accordingly, three types of blue phosphor are created to be used for cold cathode fluorescent lamps, and the tube-end chromaticity differences in the respective cold cathode fluorescent lamps were measured. Note that the graphs shown in the particle size distribution chart of the three types of blue phosphor are flatter on the whole, in other words, the particles are more widely distributed toward particles each having a larger diameter, when compared to the particle size distribution chart of FIG. 28.

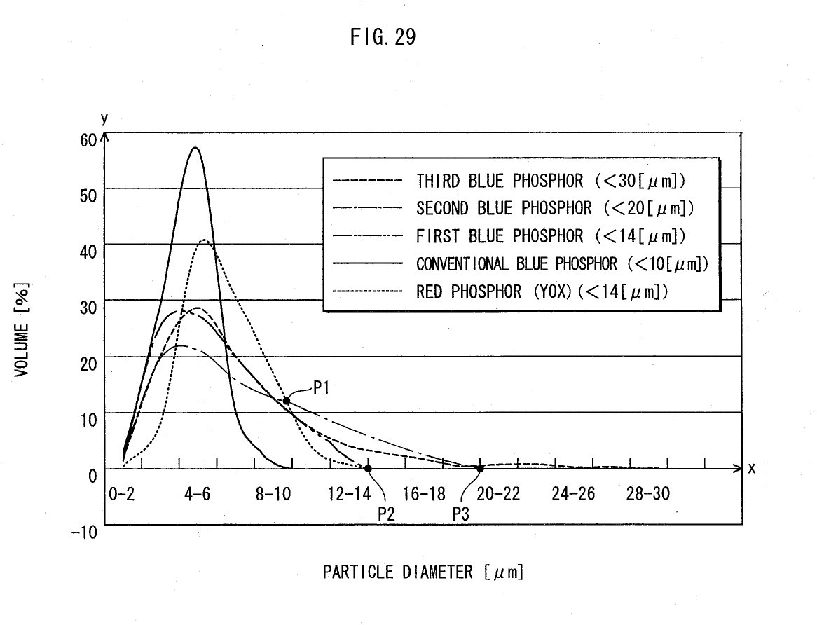

FIG. 29 shows the particle size distribution of the three types of blue phosphor described above. FIG. 29 is a particle size distribution graph, which is the same kind as the graph shown in FIG. 28, in which the horizontal axis x of the distribution chart represents the diameter [μm] of each of the phosphor particles, and the vertical axis y represents the percentage by volume [%] of said each of the phosphor particles in the respective phosphors. Note that, for comparison, FIG. 29 includes the particle size distribution of the red phosphor (YOX) and the particle size distribution of the blue phosphor that has a conventional particle size distribution (see FIG. 28).

In the particle size distribution chart shown in FIG. 29,

(i) a solid line in the graph represents a conventional blue phosphor (hereinafter referred to as “conventional blue phosphor”) composed of particles that have a diameter in the range of more than 0 [μm] and less than 10 [μm],

(ii) an alternate long and two short dashes line in the graph represents a blue phosphor (hereinafter referred to as “first blue phosphor”) composed of particles that have a diameter in the range of more than 0 [μm] and less than 14 [μm],

(iii) an alternate long and short dash line in the graph represents a blue phosphor (hereinafter referred to as “second-blue phosphor”) composed of particles that have a diameter in the range of more than 0 [μm] and less than 20 [μm], and

(iv) a thick broken line in the graph represents a blue phosphor (hereinafter referred to as “third blue phosphor”) composed of particles that have a diameter in the range of more than 0 [μm] and less than 30 [μm].

(v) A thin broken line in the graph represents a red phosphor composed of particles that have a diameter in the range of more than 0 [μm] and less than 14 [μm].

Here,

(i) the first blue phosphor includes 9.9 [volume %] of the blue phosphor particles that have a diameter in the range of more than 10 [μm] and less than 14 [μm],

(ii) the second blue phosphor includes 28.1 [volume %] of the blue phosphor particles that have a diameter in the range of more than 10 [μm] and less than 20 [μm], and

(iii) the third blue phosphor includes 19 [volume %] of the blue phosphor particles that have a diameter in the range of more than 10 [μm] and less than 30 [μm].

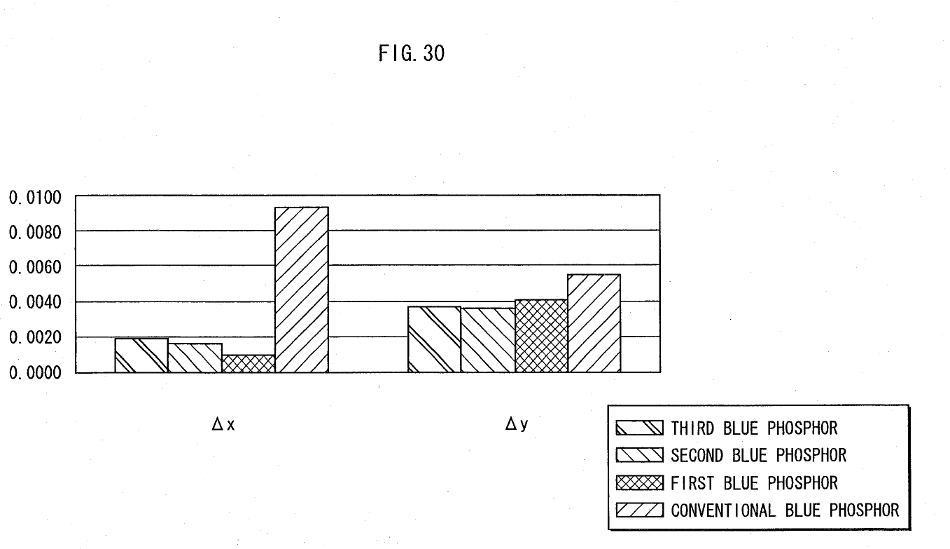

FIG. 30 shows tube-end chromaticity differences obtained by measuring the cold cathode fluorescent lamps manufactured with use of the conventional blue phosphor and the first, second, and third blue phosphors. Note that the entire length of the glass container included in each of the cold cathode fluorescent lamps provided for the measurement is 900 mm.

It can be seen from FIG. 30 that the use of each of the first to third blue phosphors reduces the tube-end chromaticity difference more than the conventional blue phosphor. In particular, a chromaticity difference pertaining to the x coordinate is reduced to a great extent. In other words, it can be seen that the use of any of the first to third blue phosphors improves a balance between the red light and blue light, compared to the case where the conventional blue phosphor is used. In fact, in each of the cold cathode fluorescent lamps manufactured with use of the respective first to third blue phosphors, the tube-end chromaticity difference in the x axial direction, in particular, is within the range of a corresponding chromaticity difference discrimination ellipse in the chromaticity diagram, and is improved to the extent where a color difference is unrecognizable.

This is considered to be because the amount of blue phosphor flowing out of the lower end of the glass tube increases to be balanced with the amount of flow of red phosphor in the process C (FIG. 27), by adding and increasing blue phosphor particles having a large diameter (while decreasing the amount of blue phosphor particles having a small diameter).

In other words, it is assumed that the tube-end chromaticity difference has been improved by including a predetermined amount [volume %] of blue phosphor particles having a diameter of more than 10 [μm] as described above, while conventional blue phosphor scarcely contains blue phosphor particles having a diameter of more than 10 [μm].

Note that the particle size distribution of the blue phosphor is not limited to those of the first, second and third blue phosphors, but can be changed as long as the distribution is within a predetermined range.

The following describes the predetermined range, with reference to FIG. 29.

As shown in FIG. 29, it is assumed that P1 represents an intersection point of the line graph of the second blue phosphor and the line graph of the red phosphor, P2 represents a point where the line graph of the red phosphor converges toward the horizontal axis x, and P3 represents a point where the line graph of the second blue phosphor converges toward the horizontal axis x. Also, part of the line graph of the red phosphor between the points P1 and P2 is referred to as “first curve”, and part of the line graph of the second blue phosphor between the points P1 and P3 is referred to as “second curve”.

In this case, the tube-end chromaticity difference is believed to improve more by using a blue phosphor having a particle size distribution shown by a line graph that intersects with the first curve, passes through an area substantially surrounded by the first and second curves, and substantially converges toward the x axis between the points P2 and P3, when compared to a case of using a conventional blue phosphor.

The following shows the coordinate values (x, y) of the points P1, P2, and P3 in FIG. 29.

P1≈(10.8, 11.7)

P2≈(0, 14)

P3≈(0, 20)

Also, the approximate expression of the line graph of the red phosphor between the points P1 and P2 (namely the first curve) is

y=−0.000007x⁶+0.0008x⁵−0.0368x⁴+0.8326x³−9.1788x²+38.889x+7.092 (1)

The approximate expression of the line graph of the second blue phosphor (namely the second curve) is

y=0.0457x²−2.4896x+33.294 (2)

Here, the above-described expression “substantially converges toward the x axis” includes the following case, in addition to the case where the line graph of blue phosphor intersects with the x axis between the points P2 and P3. Namely, the above-described expression includes a case where the line graph of blue phosphor further goes beyond the point P3, passes through a narrow area surrounded by the line graph of the third blue phosphor (hereinafter referred to as “third curve”) and the x axis, and intersects with the x axis before the intersection point of the x axis of the third curve (30, 0). Note that, in the third blue phosphor, the volume % corresponding to each range of the particle sizes ([20-22], [22-24], [24-26], [26-28], and [28-30]) between the point P3 and the intersection point (30, 0) is greater than or equal to 1 [vol %].

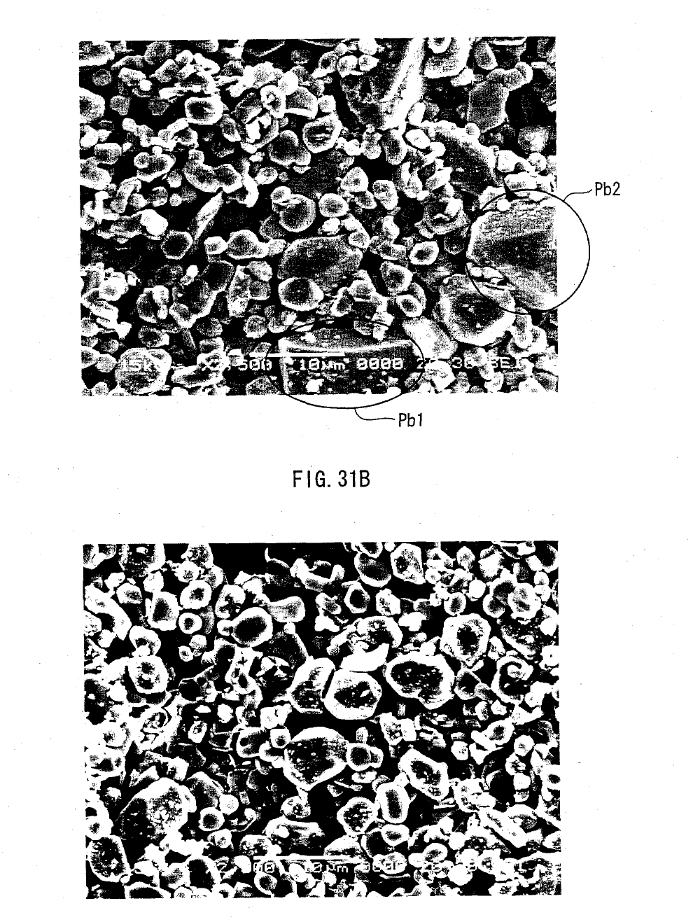

Also, the inventors, etc. of the present application took a picture of the surface of the phosphor layer in the upper end portion of the container and a picture thereof in the lower end portion of the container, with use of an electron microscope. The pictures are shown in FIGS. 31A and 31B. FIG. 31A shows the picture of the phosphor layer in the upper end portion of the container, and FIG. 31B shows the picture thereof in the lower end portion of the container, where both pictures were taken with use of the electron microscope. Note here that the phosphor layer is formed with use of red phosphor (YOX), green phosphor (BAM-G), and the second blue phosphor.

In FIG. 31A, particles surrounded by the circles Pb1 and Pb2 have relatively large diameters in the blue phosphor particles. The particles remain in the upper end portion of the container despite the large diameters. This is presumably because, as described above, the suspension liquid film is solidified before most of the particles having a large diameter move downward as the closer to the upper part of the glass tube the suspension liquid film is located, the quicker the suspension liquid dries.

On the other hand, the lower end portion of the container has very few phosphor particles having a large diameter, including blue phosphor particles, as shown in FIG. 31B. This is because, as described above, the larger the diameter of the phosphor particle is, the more the particle slides and falls out of the glass tube since the closer to the lower part of the glass tube the suspension liquid film is located, the slower the part of the suspension liquid dries, resulting in the fluidity of phosphor particles being maintained longer.

Meanwhile, the inventors, etc. of the present application discovered that the composition ratio [mol %] of europium and manganese in the green phosphor material (BAM-G) affects luminance efficiency [cd/m²·W].

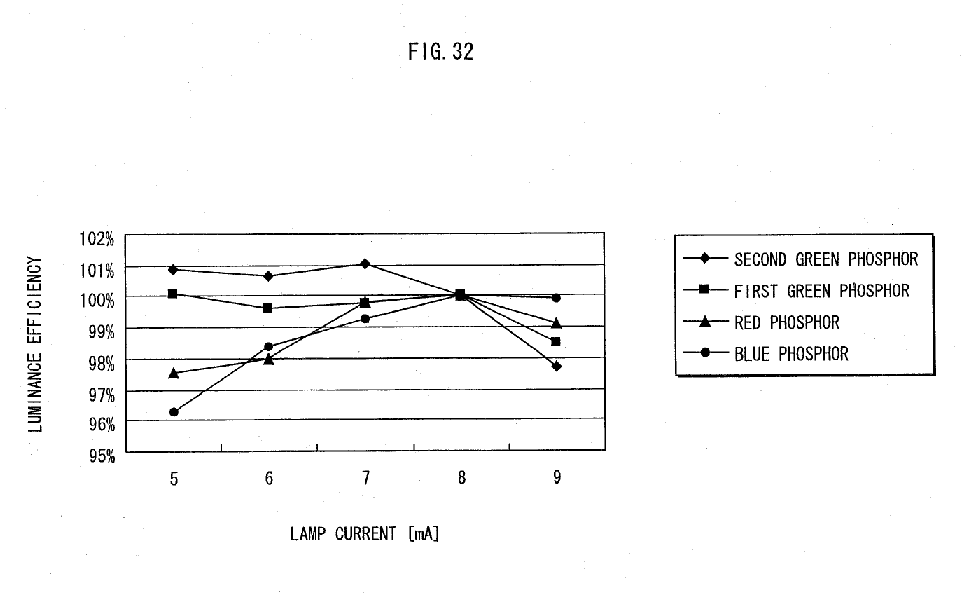

FIG. 32 is a graph showing a change of each luminance efficiency [cd/m²·W] of the respective phosphors, with respect to the lamp current [mA]. In other words, the graph shows a change of luminance efficiency when a lamp current is changed in (i) a cold cathode fluorescent lamp having only the red phosphor (YOX), (ii) a cold cathode fluorescent lamp having only the blue phosphor (SCA), and (iii) a cold cathode fluorescent lamp having only the green phosphor (BAM-G). Note that each line graph of FIG. 32 shows a relative percentage in a case where the luminance [cd/m²] is 100[%] when the lamp current is 8 [mA].

In FIG. 32, the circle “” shows the luminance efficiency of the cold cathode fluorescent lamp of the blue phosphor (SCA), the triangle “▴” shows the luminance efficiency of the cold cathode fluorescent lamp of the red phosphor (YOX), the square “▪” shows the luminance efficiency of a cold cathode fluorescent lamp having a green phosphor (hereinafter referred to as “first green phosphor”) that contains 0.714 [mol %] of europium and 0.014 [mol %] of manganese, and the rhombus “♦” shows the luminance efficiency of a cold cathode fluorescent lamp having a green phosphor (hereinafter referred to as “second green phosphor”) that contains 0.929 [mol %] of europium and 0.02 [mol %] of manganese.

It can be seen from FIG. 32 that the luminance efficiency of the first green phosphor “▪” is more stable than that of the second green phosphor “♦”, with respect to a change of the lamp current. This difference is attributed to the content ratio of europium and manganese that are activators.

It can be seen that both of the red phosphor and the blue phosphor change in accordance with a change of the lamp current, and the change of the red phosphor approximates that of he blue phosphor. Therefore, even if the lamp current is changed, a color shift caused by an unbalance between red light and blue light rarely occurs in a white fluorescent lamp having these red and blue phosphors.

On the other hand, the changes of the respective green phosphors do not approximate with the changes of the red phosphor and blue phosphor. Therefore, in a white fluorescent lamp having these green, red and blue phosphors, a color shift caused by an unbalance between (i) green lights and (ii) red and blue lights is likely to occur when the lamp current is changed. However, FIG. 32 shows that a difference of luminance efficiency between (i) the first green phosphor and (ii) the red and blue phosphors is smaller than a difference thereof between (i) the second green phosphor and (ii) the red and blue phosphors. Therefore, the first green phosphor can prevent a color shift that occurs when the lamp current is changed in a more efficient manner than the second green phosphor. In other words, a color shift that occurs when the lamp current is changed can be prevented to the maximum extent possible, by appropriately setting the value of the content amount [mol %] of europium and manganese, which are activators, in the green phosphor (BAM-G).

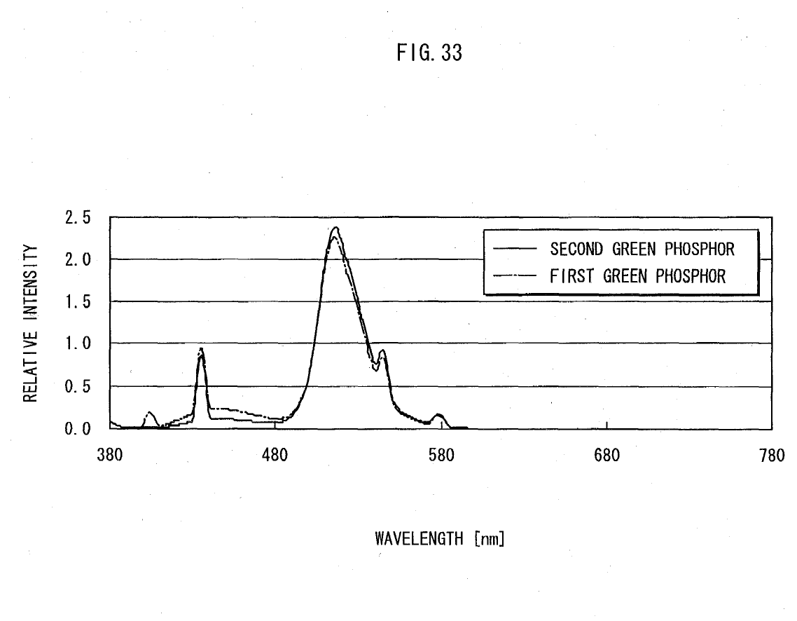

FIG. 33 shows, as a reference, the spectrum of the first green phosphor and the spectrum of the second green phosphor.

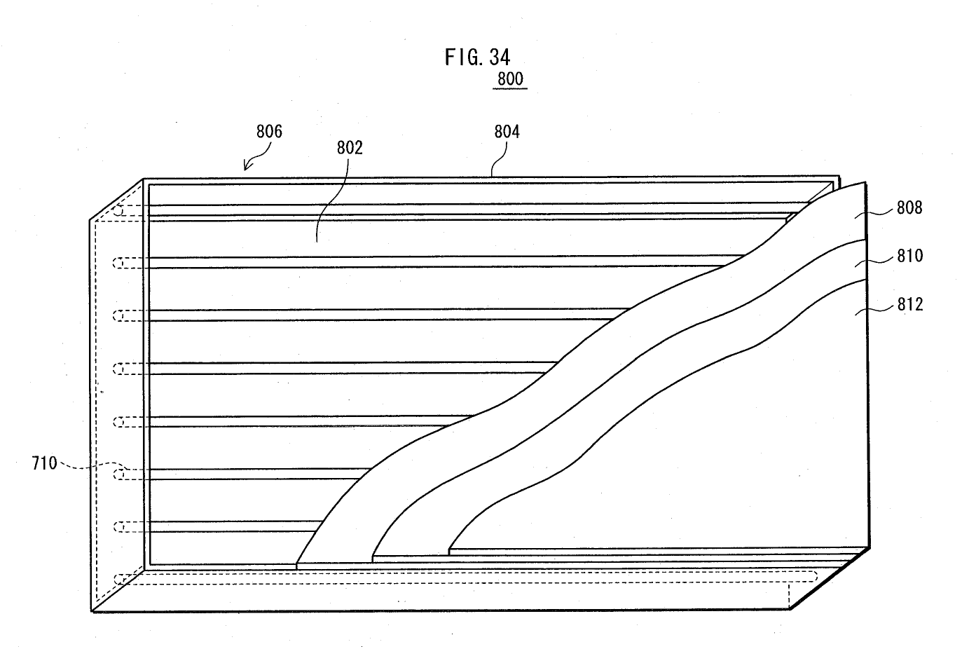

FIG. 34 is a perspective view showing a schematic structure of a backlight unit 800 having the fluorescent lamp 710 as a light source. Note that FIG. 34 is a diagram obtained by cutting away a diffusion plate 808, a diffusion sheet 810, and a lens sheet 812 that are described below.

The backlight unit 800 has a case 806 that is formed from a reflection plate 802 having a rectangular shape, and a side plate 804 surrounding the reflection plate 802. Each of the reflection plate 802 and the side plate 804 has a reflection film (not shown) that is formed on one main surface of a plate material composed of a PET (polyethylene terephthalate) resin. Here, the reflection film is formed by depositing aluminum and such, and the one main surface of the plate material is a surface located inward when the plate material is formed into the case 806.

The case 806 houses, as a light source, a plurality of (eight in this embodiment) fluorescent lamps 710 that are arranged in parallel with the long sides of the reflection plate 802 and at regular intervals in the direction of the short sides of the reflection plate 802.

Also, the opening of the case 806 is covered with the diffusion plate 808, the diffusion sheet 810, and the lens sheet 812.

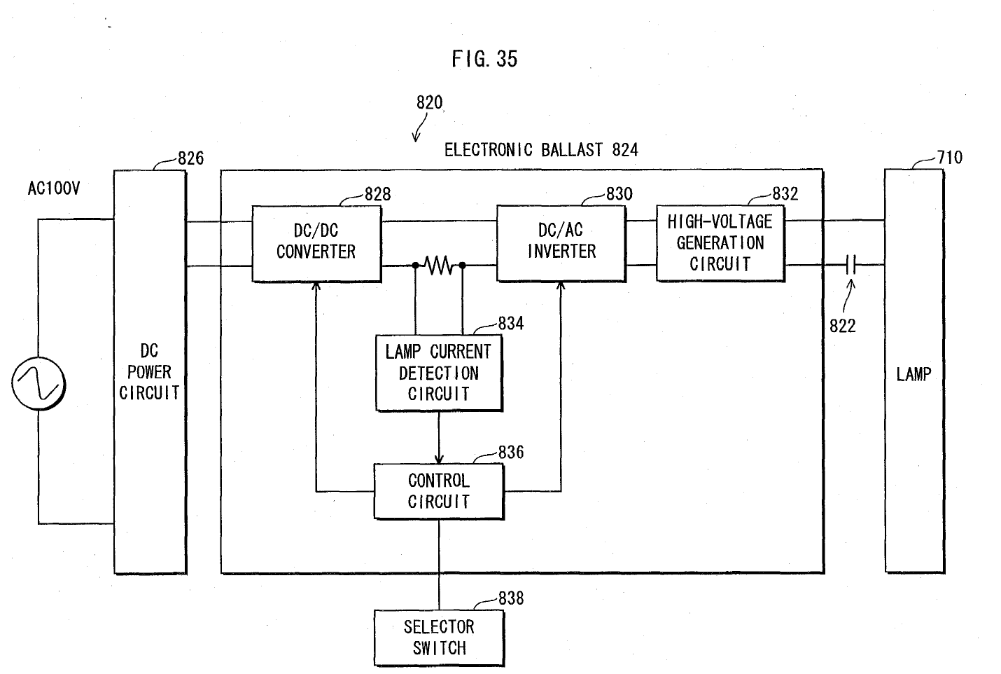

FIG. 35 is a block diagram showing the structure of a lighting device 820 for lighting the fluorescent lamps 710. Note that although FIG. 35 shows only one of the fluorescent lamps 710, the lighting device 820 is connected to the plurality of fluorescent lamps 710 in parallel. Also, a lead wire of each one end of the respective fluorescent lamps 710 is electrically connected to the lighting device 820 via a ballast capacitor 822 provided for each of the plurality of fluorescent lamps 710. These ballast capacitors 822 cause the plurality of fluorescent lamps 710 to light in parallel, with use of one electronic ballast (inverter) 824 described below.

As shown in FIG. 35, the lighting device 820 is composed of a DC power circuit 826 and the electronic ballast 824. The electronic ballast is composed of a DC/DC converter 828, a DC/AC inverter 830, a high voltage generation circuit 832, a lamp current detection circuit 834, a control circuit 836, and a selector switch 838.

The DC power circuit 826 generates direct current from commercial alternating-current power (100V), and supplies the direct current to the electronic ballast 824. The DC/DC converter 828 converts the direct current voltage into a direct current voltage having a predetermined amplitude, and supplies the direct current voltage to the DC/AC inverter 830. The DC/AC inverter 830 generates alternating rectangular current having a predetermined frequency and sends the alternating rectangular current to the high voltage generation circuit 832. The high voltage generation circuit 832 includes a transformer (not shown), and the high voltage generated by the high voltage generation circuit 832 is applied to the fluorescent lamps 710.

Meanwhile, the lamp current detection circuit 834 is connected to the input side of the DC/AC inverter 830, indirectly detects the lamp current (drive current) of the fluorescent lamps 710, and sends a detection signal thereof to the control circuit 836. In accordance with the detection signal, the control circuit 836 refers to a reference current value that is being selected from among a plurality of reference current values (for example, 6 [mA], 7 [mA], 8 [mA], and 9 [mA]) set in an internal memory (not shown), and controls the DC/DC converter 828 and the DC/AC inverter 830 so as to light the cold cathode fluorescent lamps 710 at the constant current having the reference current value. Note that the reference current values are selected by a selector switch 838.

According to the backlight unit having the above-described structure, the luminance of the light emitted from the backlight unit can be changed by operating the selector switch 838. This makes it possible to change the brightness of the screen of a liquid crystal television having the backlight unit.

Note that the backlight unit 800 can be used to form a liquid crystal display apparatus (liquid crystal television), in the same manner as the embodiment 1.

While the present invention has been described in accordance with the specific embodiments outlined above, it is evident that the present invention is not limited to such. For example, the following cases are also included in the present invention.

(1) In the above-described embodiments, descriptions are provided with an example of a cold cathode fluorescent lamp (CCFL) However, the present invention is not limited to such, and can be applied to a so-called external electrode fluorescent lamp. The external electrode fluorescent lamp (EEFL) is a dielectric barrier discharge fluorescent lamp whose glass tube wall is used as a capacitance by providing, for example, an external electrode on the outer periphery of the glass container at each end portion thereof, instead of internal electrodes.

(2) The entire length of the glass container provided for the above-described measurements pertaining to the tube end chromaticity difference is 900 [mm]. Also, as described above, the use of any of the first, second, and third blue phosphors improves the tube end chromaticity difference more than the use of the conventional blue phosphor. Although detailed data is not shown here, an improvement similar to the improvement with use of the glass container having a 900 [mm] entire length is observed after the similar measurement has been conducted with a glass container having a 720 [mm] entire length and a glass container having a 1500 [mm] entire length.

Accordingly, the entire length of the glass tube is not limited to 900 [mm], and may be 720 [mm] or 1500 [mm].

(3) In the above embodiments, the lamp is in the shape of a straight tube shape (see FIG. 26). However, the present invention is not limited to this, and may be applied to a lamp having a U-shape, a squared U-shape, or an L-shape. Also, the cross section of the glass container is not limited to a circular shape and may have a flat shape such as an ellipse.

### Embodiment 4

The embodiment 1 realizes a fluorescent lamp favorable as the light source of a backlight unit, with an increased color reproducibility range after the light of the lamp transmits through the color filters as compared to conventional lamps. As described below, when the backlight unit is used for a liquid crystal display, there is a concern that infrared rays emitted from the fluorescent lamp may affect a remote controller for the liquid crystal display. In view of the below-described background art, an embodiment 4 is related to a technique for reducing the above-described effect caused by the infrared rays emitted from the fluorescent lamp.

In recent years, commonly used liquid crystal displays usually have a cold cathode fluorescent lamp (CCFL) as a light source for a backlight. The cold cathode fluorescent lamp is filled with argon gas, thereby emitting infrared rays having a wavelength of around 910 [nm] when lit. The amount of filled argon gas has been increasing in recent years for a longer life of the cold cathode fluorescent lamp. Accordingly, the amount of infrared rays emitted from the cold cathode fluorescent lamp has been increasing as well (see Japanese Patent Application Publication Heisei 10-050261, and Japanese Patent Application Publication Heisei 03-269948).

These infrared rays are in the same wavelength region as the infrared rays used for various types of remote controllers, which raises concern about an effect on the remote controllers. In response to this concern, a technique that uses a protection plate, which is made of resin that blocks light in an infrared wavelength region, has been developed (see Japanese Patent Application Publication No. 2002-323860). However, the protection plate needs be considerably thick in order to block light in the infrared wavelength region. Furthermore, when the thickness of the protection plate is increased, light in the visible wavelength region is also blocked, resulting in the screen of the liquid crystal display being difficult to see.

Another technique that has been proposed is for reducing the amount of emitted infrared rays when the liquid crystal display is switched on, by controlling the power supplied to the cold cathode fluorescent lamp (Japanese Patent Application Publication 2005-285357). In this way, the amount of infrared rays can be reduced without blocking light in the visible wavelength region.

The cold cathode fluorescent lamp used for the backlight emits infrared rays at the time of on/off light modulation (PWM: pulse width modulation), as well as when the power of the liquid crystal display is turned on.

Upon performing the on/off light modulation on the lamp, the temperature of the lamp is lowered, resulting in the vapor pressure of mercury in the lamp being lowered. A decrease in the vapor pressure of mercury causes an increase in the rare gas emission of the fluorescent lamp. This means that, the higher the degree of the light modulation is, the more infrared rays are generated due to the rare gas emission.

According to the above-mentioned conventional technique, it is possible to accelerate a decrease in the amount of infrared rays generated during the start-up of the lamp, by increasing the temperature of the lamp quickly. However, the amount of infrared rays cannot be decreased while the lamp is in a normal lighting state, since the temperature of the lamp cannot be decreased while the lamp is in the normal lighting state.

Also, when taking into consideration various costs, it is preferable to take measures in which the lamp efficiency does not decrease even when the light in the infrared wavelength region is blocked.

In view of the above-mentioned problem, it is a further object of the embodiment 4 to provide a fluorescent lamp, a backlight unit, and a liquid crystal display device, that achieve a high lamp efficiency and block light in the infrared wavelength region even when performing the on/off modulation.

In order to achieve the above-described object, in the embodiment 4, the present invention provides a fluorescent lamp comprising: a glass container; and an infrared cut film that has been formed on a wall surface of the glass container, wherein the glass container is in a shape of a tube whose inner diameter is in a range of 2 mm to 7 mm inclusive, and is filled with a mixed gas of argon and neon, the argon included in a range of 10% to 20% inclusive, the infrared cut film is a λ/4 multilayer film that reflects light in an infrared wavelength region, and that transmits light in a visible wavelength region.

In this way, infrared rays generated due to light modulation is reflected by the infrared cut film, thereby preventing the infrared rays from leaking out of the fluorescent lamp. This makes it possible to prevent a malfunction of an apparatus that uses infrared rays, such as a remote controller. It is also possible to improve the light efficiency, since the temperature of the lamp is increased by the reflected infrared rays.

In the embodiment 4, the present invention provides a fluorescent lamp including an electrode, wherein the infrared cut film is formed closer to the center of the glass container than the electrode. A portion in the vicinity of the electrode has a high temperature and has a small generation rate of infrared rays. Therefore, the effect of infrared rays is small without the infrared cut film in the vicinity of the electrode, which makes it possible to increase the heat dissipation of the electrode portion. Also, since the area of the infrared cut film to be formed can be smaller, it is possible to lower the cost of the fluorescent lamp.

In the embodiment 4, the present invention provides a fluorescent lamp wherein the infrared cut film is formed on an outer wall surface of the glass container. In this way, the infrared cut film can be formed on the wall surface of the glass container easily and accurately. This makes it possible to manufacture the fluorescent lamp easily.

In the embodiment 4, the present invention provides a fluorescent lamp, wherein the infrared cut film has been formed by alternately laminating a low refractive material and a high refractive material, the low refractive material being one of silicon oxide and magnesium fluoride, and the high refractive material being one of tantalum oxide, titanium oxide, magnesium oxide, zirconium oxide, silicon nitride, aluminum oxide, and hafnium oxide. This prevents a malfunction of a remote controller, and improves the longevity of the fluorescent lamp.

Note that the content ratio of the iron oxide (Fe₂O₃) in the glass container is preferably in the range of 0.01 weight % to 0.1 weight % inclusive, and the valence ratio of the iron oxide is preferably Fe²⁺/Fe³⁺<2. Also, when forming the infrared cut film, the fluorescent lamp is preferably one of a cold cathode fluorescent lamp, a hot cathode fluorescent lamp, and an-external electrode fluorescent lamp.

The backlight unit according to the embodiment 4 comprises: a fluorescent lamp having a tubular shape which is filled with a mixed gas, an inner diameter of the tube being in a range of 2 mm to 7 mm inclusive, the mixed gas being a mixed gas containing argon and neon, the argon being contained at a ratio of 10% to 20% inclusive, a tubular member that is translucent and has an infrared cut film formed thereon, a dimmer circuit that performs on/off light modulation while a duty ratio of the dimmer circuit is in a range of greater than or equal to 10% and less than 100%, wherein the inner diameter of the tubular member is larger than an outer diameter of the fluorescent lamp, the fluorescent lamp is arranged on an inner side of the tubular member such that a tube axis of the fluorescent lamp substantially coincides with a tube axis of the tubular member, and the infrared cut film is a λ/4 multilayer film that reflects light in an infrared wavelength region and transmits light in a visible wavelength region.

Furthermore, the backlight unit according to the embodiment 4 may comprise: a fluorescent lamp having a tubular shape which is filled with a mixed gas, an inner diameter of the tube being in a range of 2 mm to 7 mm inclusive, the mixed gas being a mixed gas containing argon and neon, the argon being contained at a ratio of 10% to 20% inclusive, an infrared cut plate that is translucent and has an infrared cut film formed thereon, a dimmer circuit that performs on/off light modulation while a duty ratio of the dimmer circuit is in the range of greater than or equal to 10% and less than 100%, wherein the infrared cut plate has a groove in a shape that fits along an outer diameter of the fluorescent lamp, the groove being arranged so as to face the fluorescent lamp, and the infrared cut film is a λ/4 multilayer film that reflects light in an infrared wavelength region and transmits light in a visible wavelength region, the infrared cut film being formed on the groove. This makes it possible to obtain a fluorescent lamp having high lamp efficiency. This fluorescent lamp can be used to reduce the power consumption without affecting a remote controller in the vicinity of the backlight unit.

A liquid crystal display device according to the embodiment 4 has a fluorescent lamp according to the present invention or a backlight unit according to the present invention. This makes it possible to prevent a malfunction of a remote controller in the vicinity of the liquid crystal display device while suppressing the power consumption.

The following describes the embodiments of a fluorescent lamp, a backlight unit, and a liquid crystal display device according to the present invention, with an example of a liquid crystal display device, with reference to the drawings.

[1] Construction of Liquid Crystal Display Device

The following describes the construction of the liquid crystal display device.

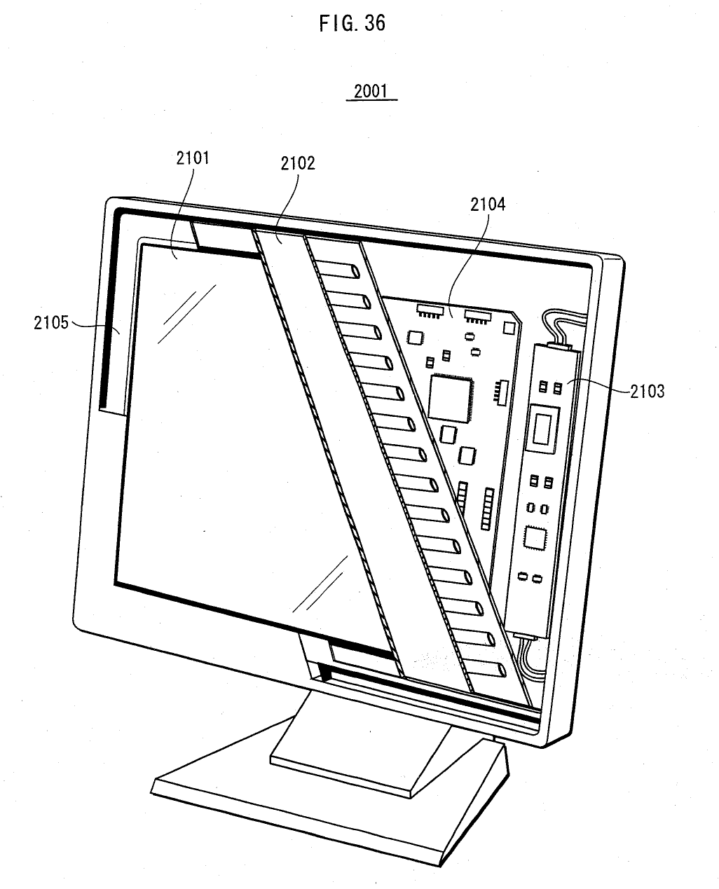

FIG. 36 is a perspective view showing the main construction of a liquid crystal display device according to the present embodiment. As shown in FIG. 36, a liquid crystal display device 2001 includes a liquid crystal panel 2101, a backlight unit 2102, a lighting circuit 2103, an interface circuit 2104, and a frame 2105.

The liquid crystal panel 2101 displays a color image according to an image signal received by the interface circuit 2104. The backlight unit 2102 is a backlight unit of a so-called directly-below type, has a cold cathode fluorescent lamp built therein as described below, and lights the liquid crystal panel 2101 from behind. The lighting circuit 2103 is built in the backlight unit 2102 and lights the cold cathode fluorescent lamp described below. The frame 2105 supports the liquid crystal panel 2101.

[2] Construction of Backlight Unit 2102

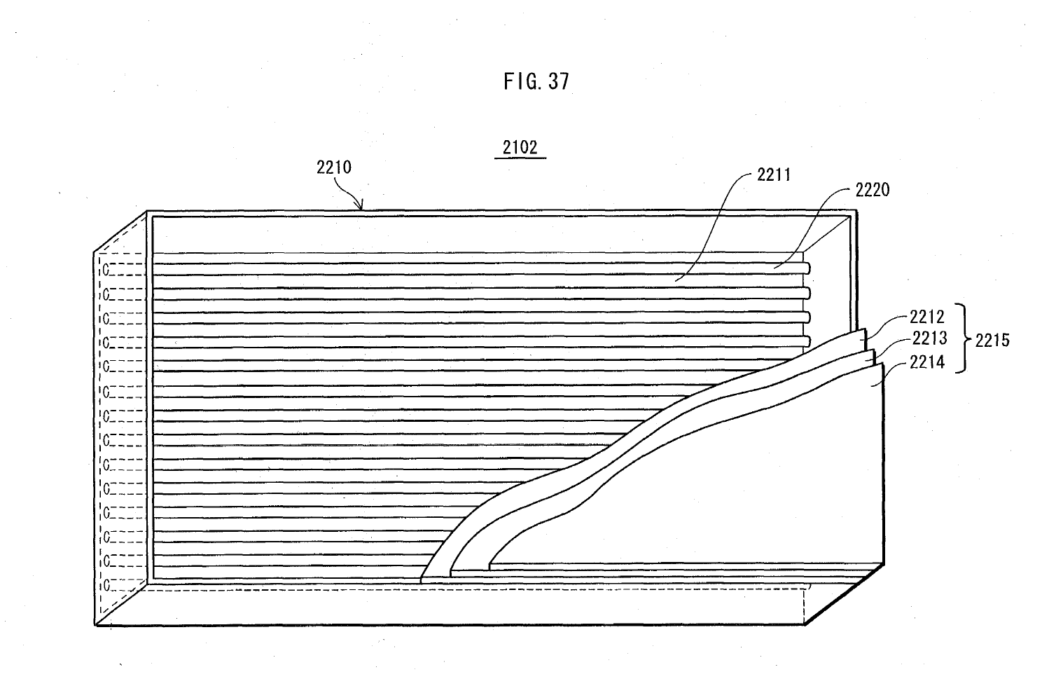

FIG. 37 is a schematic perspective view showing the construction of the backlight unit 2102 that is a light emitting device. In FIG. 37, part of the backlight unit 2102 is partially cut away so as to show the inner structure thereof.

A surface of the backlight unit 2102 of the directly-below type has an opening, which is located on the side of a plurality of cold cathode fluorescent lamps 2220 (hereinafter simply referred to as “fluorescent lamps 2220”) and the liquid crystal panel that is for extracting light. The backlight unit 2102 has a case 2210 for housing the plurality of the fluorescent lamps 2220, and a front panel 2215 that covers the opening of the case 2210.

Each of the fluorescent lamps 2220 is in the shape of a straight tube. Fourteen fluorescent lamps 2220 are arranged in the shorter direction (vertical direction) of the case 2210 at predetermined intervals, in a state where the lengthwise axis of each of the straight tubes substantially coincides with the longer direction (horizontal direction) of the case 2210.

Note that these fluorescent lamps 2220 are lit by a drive circuit that is not shown in figures.

The case 2210 is made of a polyethylene terephthalate (PET) resin, and a reflection surface is formed, by evaporating silver, etc., on an inner surface 2211 of the case 2210. Note that the case 2210 may be made of a material other than a resin. For example, the case 2210 may be made of a metal material such as aluminum.

The opening of the case 2210 is covered and sealed with the translucent front panel 2215 so as to prevent foreign substances such as dust and dirt from entering inside the case 2210. The front panel 2215 is formed by a diffusion plate 2212, a diffusion sheet 2213, and a lens sheet 2214 laminated thereon.

The diffusion plate 2212 and the diffusion sheet 2213 disperse and diffuse light emitted from the fluorescent lamps 2220, and the lens sheet 2214 aligns light in the normal direction of the lens sheet 2214. The above-described diffusion plate 2212, diffusion sheet 2213, and lens sheet 2214 cause light emitted from the fluorescent lamps 2220 to irradiate the entire surface (light-emitting surface) of the front panel 2215 evenly in the front direction. Note that it is possible to use a PC (polycarbonate) resin for a material of the diffusion plate 2212, because of its dimensional stability.

[3] Construction of Fluorescent Lamps 2220

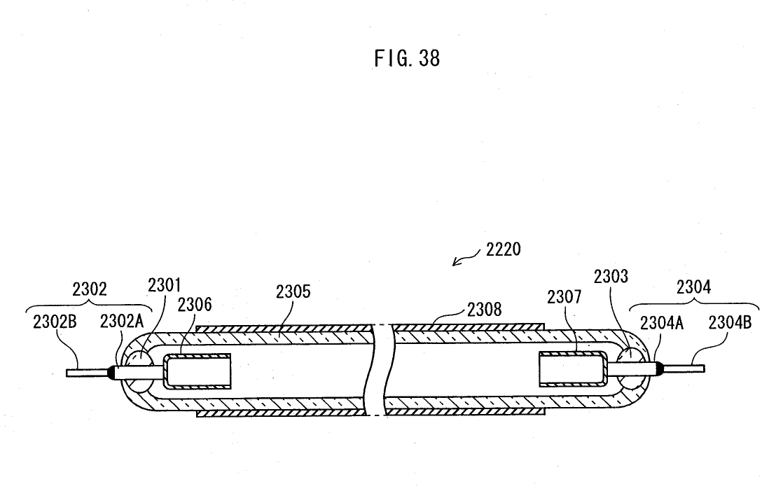

The following describes the construction of the fluorescent lamps 2220. FIG. 38 is a partial cutaway view showing a general construction of one of the fluorescent lamps 2220.

The fluorescent lamp 2220 has a glass container 2305 (i) whose cross section is substantially elliptical and (ii) that is in the shape of a straight tube. This glass container 2305 has, for example, a 2.4 [mm] outer diameter, a 2.0 [mm] inner diameter, and an approximately 350 [mm] length, and is made of borosilicate glass. The dimensions of the fluorescent lamp 2220 shown below correspond to the dimensions of the glass container 2305 that has a 2.4 [mm] outer diameter, and a 2.0 [mm] inner diameter.

Each of the above described values is, of course, just an example, and the present embodiment is not limited to such. In recent years, there has been a demand for the light source of a liquid crystal display device to have a high brightness, resulting in a lamp inrush current becoming large. When this lamp inrush current is, for example, greater than or equal to 8 mA, the life of the electrode becomes shorter. This problem can be solved by using a lamp described below.

In other words, the inner diameter of the fluorescent lamp 2220 is set to be in the range of 2.0 mm to 7.0 mm inclusive and the material thickness thereof is set to be in the range of 0.2 mm to 0.7 mm inclusive. The glass container is filled with a mixed gas of argon and neon, wherein the content ratio of the argon is in the range of 10% to 20% inclusive, but preferably in the range of 13% to 20% inclusive. The filling pressure of this mixed gas is set to be in the range of 30 Torr to 40 Torr inclusive.

However, if the above-described lamp is used while the content ratio of the argon in the mixed gas is only in the range of greater than or equal to 5% to less than 10% as seen in a conventional manner, the amount of infrared rays emitted from the light source increases, which has raised a concern over the effect on a remote controller even more.

Therefore, it is preferable that the content ratio of argon is in the range of 10% to 20% inclusive, since the brightness of the light source is improved while reducing the effect on the remote controller.

In the present embodiment, the glass container 2305a is filled with a predetermined amount of mercury, for example, 1.20 mg of mercury. Also, the glass container 2305a is filled with a rare gas such as argon or neon at a predetermined filling pressure, for example, at 40 Torr. Note that, as the above-described rare gas, a mixed gas of argon and neon (Ar—20%, Ne—80%) is used.

Also, an infrared cut film 2308, which is for reflecting infrared rays emitted from argon gas, is formed on the entire outer surface of the glass container 2305.

Furthermore, a lead wire 2302 extends outward from one end of the glass container 2305, and a lead wire 2304 extends outward from the other end of the glass container 2305. The lead wire 2302 is bonded to the one end of the glass container 2305 via a bead glass 2301, and the lead wire 2304 is bonded to the glass container 2305 via a bead glass 2303.

The lead wire 2302 connects, for example, an inner lead wire 2302A that is made of tungsten with an outer lead wire 2302B that is made of nickel. The lead wire 2304 connects, for example, an inner lead wire 2304A made of tungsten with an outer lead wire 2304B made of nickel. Each of the inner lead wires 2302A and 2304A has a 1 [mm] diameter, and a 3 [mm] entire length. Each of the outer lead wires 2302B and 2304B has a 0.8 [mm] diameter, and a 5 [mm] entire length.

One end of the inner lead wire 2302A is bonded to an electrode 2306, and another end of the inner lead wire 2304A is bonded to an electrode 2307, by laser welding or the like. Each of the electrodes 2306 and 2307 is a so-called hollow type electrode that is in the shape of a tube having a closed end. One end of each of the electrodes 2306 and 2307 has a recessed portion that has an opening and is substantially in the shape of a cup.

The electrodes 2306 and 2307 have the same shape. Each of the electrodes 2306 and 2307 has a 5.5 [mm] electrode length, a 1.70 [mm] outer diameter, a 1.50 [mm] inner diameter, and a 0.10 [mm] material thickness.

The electrodes 2306 and 2307 are formed by adding (doping), to a nickel matrix, 0.46 wt % of yttrium oxide (Y₂O₃) and 0.14 wt % of silicon (Si). Yttrium oxide is added to improve the sputter resistance of the electrodes 2306 and 2307. Silicon is added to prevent oxidation of the electrodes 2306 and 2307.

When the fluorescent lamp 2220 is lit, a discharge occurs between the electrodes 2306 and 2307.

[4] Infrared Cut Film 2308

The following describes the infrared cut film 2308.

The infrared cut film 2308 is a so-called λ/4 multilayer film formed by silicon oxide layers (SiO²) and tantalum oxide layers that are alternately laminated to eight layers. The optical film thickness of each layer is 227.5 mm, which is a quarter of the infrared wavelength of 910 nm. Here, the optical film thickness of a layer refers to an index obtained by multiplying the physical film thickness of the layer by a refractivity of the material of the layer.

Also, the λ/4 multilayer film is formed by alternately laminating a dielectric layer that is made of a material having a high refractivity and a dielectric layer that is made of a material having a low refractivity, and the optical film thickness of these dielectric layers is the same. A wavelength that is four times as long as the optical film thickness of one dielectric layer is called a “set center wavelength λ. The λ/4 multilayer film reflects light in a wavelength region centering on the set center wavelength λ.

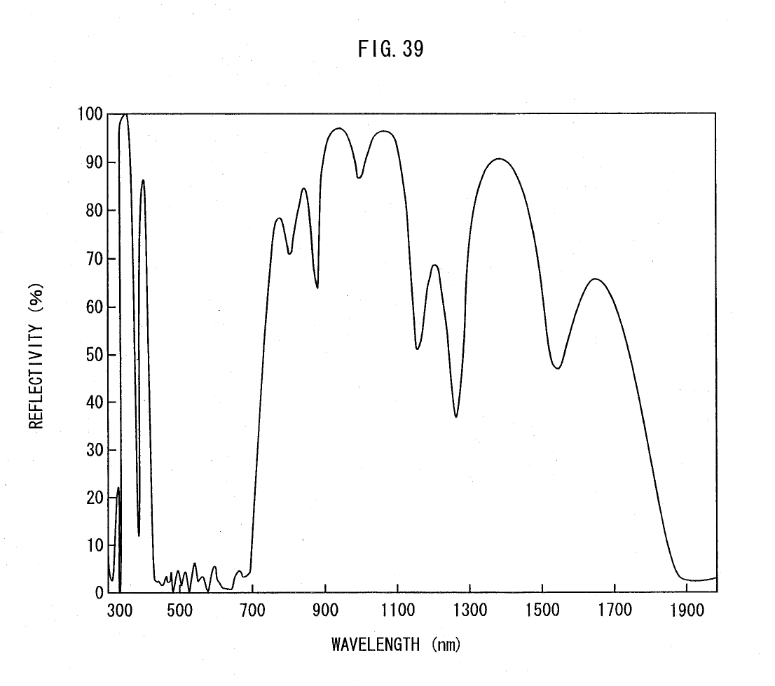

FIG. 39 is a graph showing the spectral characteristic of the infrared cut film 2308. As shown in FIG. 39, the infrared cut film 2308 reflects infrared rays that have a wavelength greater than or equal to 700 nm, and transmits light in the visible wavelength region, thereby reflecting infrared rays without sacrificing the lamp efficiency.

The above-described structure prevents the effect of infrared rays on a remote controller.

Also, the infrared rays reflected by the infrared cut film 2308 rapidly raise the temperature inside the lamp immediately after the lamp is lit, resulting in a rapid rise in the vapor pressure of mercury inside the lamp tube. This makes it possible to quickly stabilize the brightness of the lamp. In other words, providing the infrared cut film 2308 improves the start-up characteristic of the lamp.

The above-described structure also prevents the temperature of the lamp from decreasing at the time of on/off light modulation, which prevents a decrease in the vapor pressure of mercury and improves the lamp efficiency.

[5] Performance Experiment

The following describes a result of an experiment related to a performance of the infrared cut film. In the experiment, infrared rays emitted from the cold cathode fluorescent lamp are reflected by the infrared cut film under various conditions. Then, the level of the infrared rays was measured with use of an infrared sensor.

A cold cathode fluorescent lamp used in the experiment has a 2.4 [mm] outer diameter, a 2.0 [mm] inner diameter, and an approximately 35 mm entire length, and is filled with a rare gas at the pressure of 40 Torr. The rare gas mainly includes neon, and 10% of argon.

An outer tube of the lamp has the infrared cut film formed on the outer wall surface of the tube, and is made of translucent glass. An outer tube used in the present experiment has an 11 [mm] tube diameter.

The infrared sensor includes an infrared photodiode (SFH2030F) made by SIEMENS, and the distance between the cold cathode fluorescent lamp and the infrared sensor is 50 mm. The output of the infrared sensor was measured by an oscilloscope.

(1) Positional Relationship Between Cold Cathode Fluorescent Lamp and Outer Tube having Infrared Cut Film

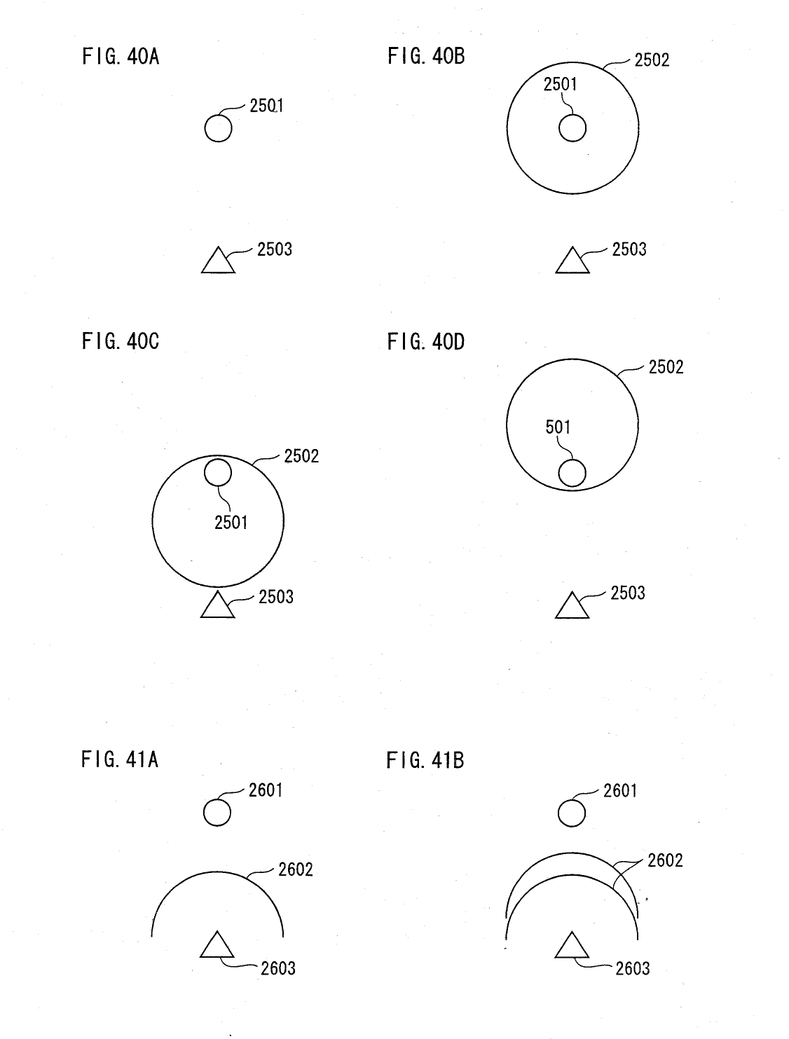

Studied first were the positional relationship between the cold cathode fluorescent lamp and the outer tube having the infrared cut film, and a relationship between the amount of infrared rays and the positional relationship. FIGS. 40A to 40D are each a schematic diagram showing the positional relationship among a cold cathode fluorescent lamp 2501, an outer tube 2502 having the infrared cut film, and an infrared sensor 2503. Each of FIGS. 40A to 40D shows a cross section perpendicular to the tube axis of the cold cathode fluorescent lamp. Note that the cold cathode fluorescent lamp used in the present experiment is a non-mercury lamp. This is because the non-mercury lamp makes it possible to conduct an experiment while infrared rays are stably generated.

FIG. 40A shows a positional relationship when the outer tube 2502 having the infrared cut film is not used, FIG. 40B shows a positional relationship when the cold cathode fluorescent lamp 2501 is located in the center of the outer tube 2502 having the infrared cut film, FIG. 40C shows a positional relationship when the outer tube 2502 having the infrared cut film is provided closer to the infrared sensor 2503, and FIG. 40D shows a positional relationship when the outer tube having the infrared cut film 2502 is provided away from the infrared sensor 2503. Note that a positional relationship between the cold cathode fluorescent lamp 2501 and the infrared sensor 2503 is the same in all of the FIGS. 40A to 40D.

The output of the infrared sensor 2503 was measured in the conditions described above. When the outer tube 2502 having the infrared cut film was not used, the output of the infrared sensor 2503 was 354 mV. When the cold cathode fluorescent lamp 2501 was located in the center of the outer tube 2502 having the infrared cut film, the output of the infrared sensor 2503 was 265 mV. When the outer tube 2502 having the infrared cut film was provided closer to the infrared sensor 2503, the output of the infrared sensor 2503 was 302 mV. When the outer tube having the infrared cut film 2502 is provided away from the infrared sensor 2503, the output of the infrared sensor 2503 was 224 mV.

The result shows that the amount of infrared rays is the least when the outer tube having the infrared cut film 2502 is provided away from the infrared sensor 2503. This is most likely because of the following reason. The angle at which an infrared ray emitted from the cold cathode fluorescent lamp 2501 enters the infrared cut film varies, depending on the positional relationship between the cold cathode fluorescent lamp 2501 and the outer tube 2502 having the infrared cut film. This changes the optical path length of the infrared ray that passes through the layers constituting the infrared cut film, causing the infrared ray to be difficult to be reflected.

Meanwhile, when the cold cathode fluorescent lamp 2501 was located in the center of the outer tube 2502 having the infrared cut film, infrared rays enter perpendicularly to the entire infrared cut film. This makes it possible to accurately reflect the infrared rays.

(2) Number of Outer Tubes having Infrared Cut Films

Subsequently, the output of the infrared sensor was measured by changing the number of the outer tubes each having the infrared cut film. Each of the outer tubes having the infrared cut films used in the present experiment is obtained by cutting the outer tube along a plane surface including the central axis of the outer tube.

FIGS. 41A and 41B are each a schematic diagram showing the conditions of the present experiment. FIG. 41A shows a structure in which only one outer tube 2602 having an infrared cut film is provided between an infrared sensor 2603 and a cold cathode fluorescent lamp 2601. FIG. 41B shows a structure in which two outer tubes 2602 each having the infrared cut film are provided between the infrared sensor 2603 and the cold cathode fluorescent lamp 2601.

The output of the infrared sensor 2603 was measured under the conditions described above. When only one outer tube 2602 having the infrared cut film was provided, the output of the infrared sensor 2603 was 185 mV. When two outer tubes 2602 each having the infrared cut film were used, the output of the infrared sensor 2603 was 95 mV, which was approximately half the value of the 185 mV. Note that the cold cathode fluorescent lamp used in the present experiment is a non-mercury lamp.

(3) Amount of Infrared Rays Immediately After Lamp is Lit

Then, the peak value was calculated of the amount of infrared rays immediately after the cold cathode fluorescent lamp was lit. Note here that the cold cathode fluorescent lamp used in the present experiment is filled with mercury.

In the case of not using the outer tube having the infrared cut film, the output of the infrared sensor was 278 mV. In the case of using the outer tube having the infrared cut film in the same manner as the above (1), and providing the cold cathode fluorescent lamp in the center of the outer tube, the output of the infrared sensor 2603 was 188 mV.

The above result shows that the peak value of the amount of infrared rays immediately after the lamp is lit is decreased by 30% when the outer tube having the infrared cut film is used.

(4) Amount of Infrared Rays at the time of On/Off Light Modulation

Next, the amount of infrared rays at the time of on/off light modulation was measured by changing the duty ratio of the on/off light modulation. Note that the present experiment was conducted while alternating current of 8 mA and 60 kHz was applied to the cold cathode fluorescent lamp filled with mercury, with the light modulation frequency of 120 Hz.

Also, the comparison was made between (i) the case of not using the outer tube having the infrared cut film and (ii) the case of providing the cold cathode fluorescent lamp in the center of the outer tube having the infrared cut film, in the same manner as the above (3), at various duty ratios.

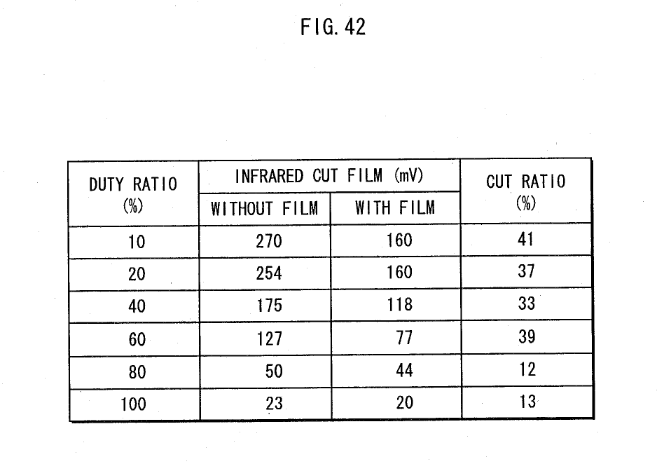

FIG. 42 is a table showing a result of the present experiment. As shown in FIG. 42, infrared rays are reflected in a high ratio between 12% and 41%, when the outer tube having the infrared cut film is used. Also, there is a tendency that the smaller the duty ratio is (from 10% to 40%), the higher the ratio is for reflecting infrared rays.

(5) Position where Infrared Rays are Generated

Next, the position of the cold cathode fluorescent lamp where the infrared rays are generated was studied, since it is effective to provide the infrared cut film in accordance with the position where infrared rays are generated, as can be seen from the above (1).

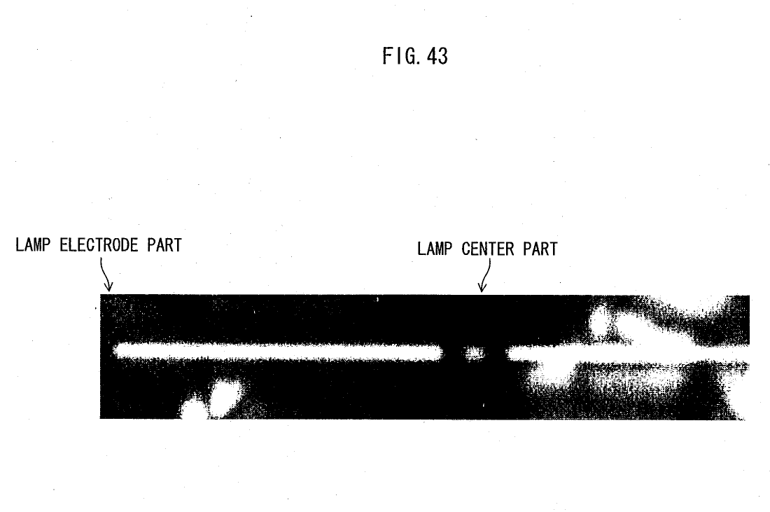

FIG. 43 is a picture of a cold cathode fluorescent lamp that is taken by an infrared camera, over a liquid crystal panel. Note that the cold cathode fluorescent lamp that is used here is a non-mercury lamp in which mercury is not filled, in order to take a picture of only an infrared component.

Also, in FIG. 43, the center part of the cold cathode fluorescent lamp is covered with the outer tube having the infrared cut film used in the above (1), and thus looks slightly darker. Also, both sides of the center part are even darker, because the light on each of the sides of the center part is blocked by a supporting member that supports the outer tube having the infrared cut film.

As shown in FIG. 43, infrared rays are emitted from the entire positive column of the cold cathode fluorescent lamp, including the vicinity of each of the electrode parts and the center part of the lamp. Therefore, in order to reflect the infrared rays with the infrared cut film, the portion between the electrodes of the cold cathode fluorescent lamp needs to be covered with the infrared cut film.

Also, the vicinity of the electrodes has a high temperature, compared to the center part of the cold cathode fluorescent lamp, and the amount of infrared rays emitted from the vicinity of the electrodes is relatively small. Therefore, it is possible to provide the infrared cut film only for the center part, and not the vicinity of the electrodes.

[6] Relationship with Infrared Sensor The following describes the relationship between the infrared cut film and the infrared sensor.

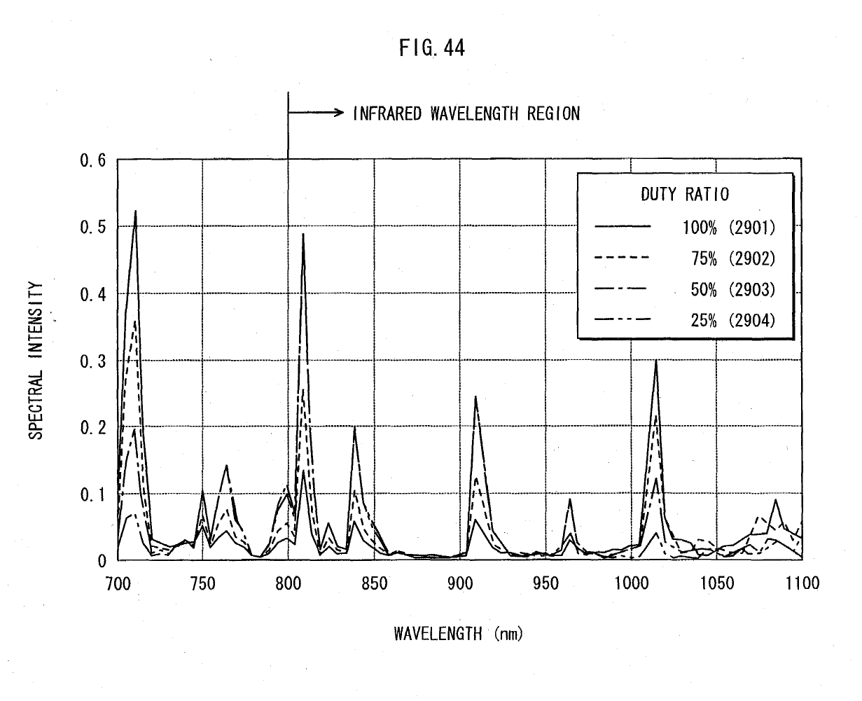

FIG. 44 is a graph showing the spectral intensity of light emitted from the cold cathode fluorescent lamp, when the infrared cut film is not used. In FIG. 44A, a solid line 2901 represents the spectral intensity when the duty ratio is 100%. Also, each of a broken line 2902, an alternate long and short dash line 2903, and an alternate long and two short dashes line 2904 represents the spectral intensity when the duty ratio is 75%, 50%, and 25%, respectively. As shown in FIG. 44, the smaller the duty ratio is, the smaller the spectral intensity tends to be of light in the visible wavelength region. On the other hand, the smaller the duty ratio is, the larger the spectral intensity tends to be of light in the infrared wavelength region having a wavelength between 800 nm and 1000 nm. Also, it can be seen that the positions of the peaks in the infrared wavelength region are substantially the same.

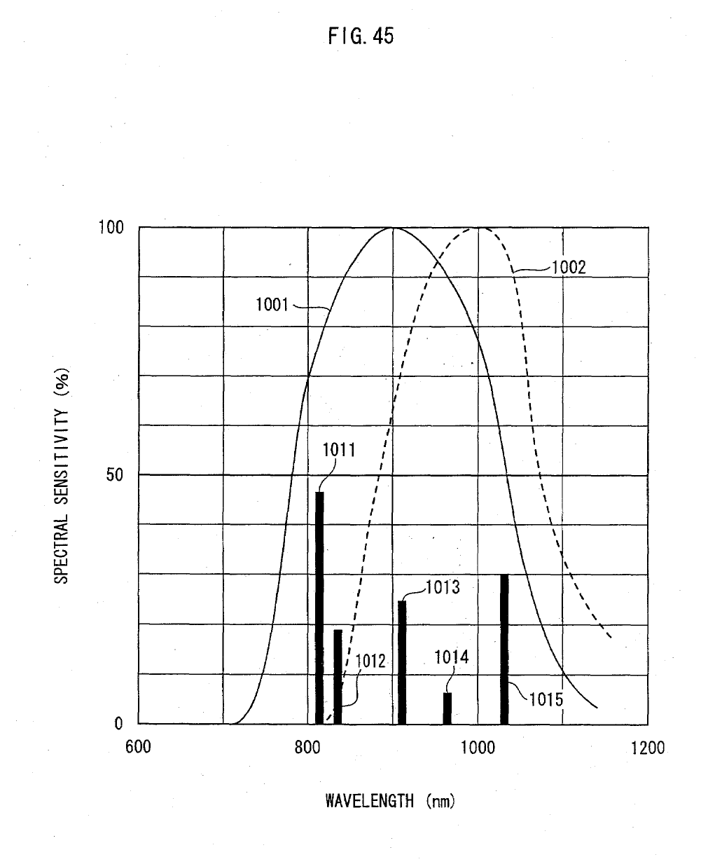

FIG. 45 is a graph showing the spectrum sensitivity of each commercial infrared sensor in the infrared wavelength region and the peak positions of the spectral intensity of the cold cathode fluorescent lamp. In FIG. 45, a graph 1001 represents the spectral sensitivity of an infrared photodiode (SFH2030F) made by SIEMENS, and a graph 1002 represents the spectral sensitivity of an infrared photodiode (PD410) made by SHARP.

Also, each of bar graphs 1011-1015 represents the peak position of the spectral intensity of the cold cathode fluorescent lamp, when the wavelength is 810 nm, 840 nm, 910 nm, 965 nm, and 1015 nm, respectively.

As shown in FIG. 45, since the peak of the spectral intensity of the cold cathode fluorescent lamp in the infrared wavelength region is included in a region where the spectral sensitivity of each of the commercial infrared photodiodes is high, a malfunction of a remote controller may occur.

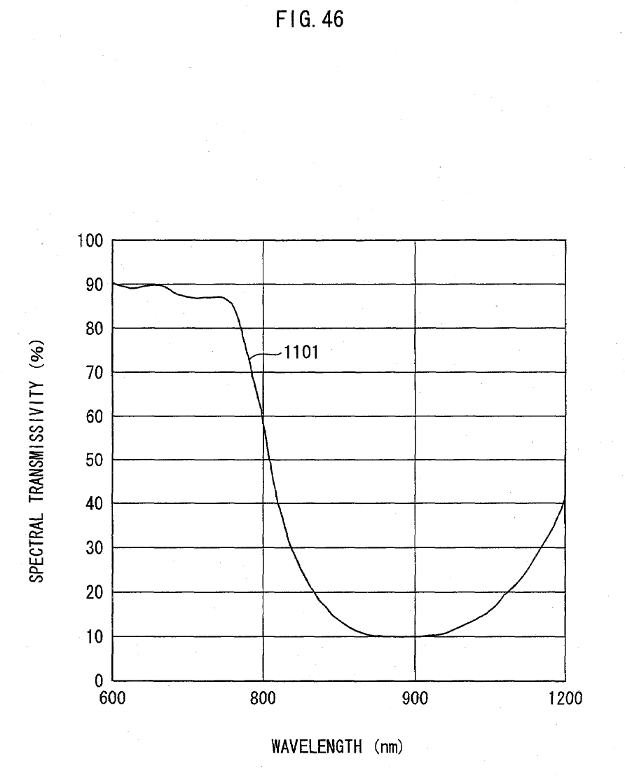

FIG. 46 is a graph representing the spectrum characteristic of the infrared cut film. As shown in FIG. 46, the spectral transmissivity of the infrared cut film is low in a wavelength region having a wavelength of greater than or equal to 800 nm, and infrared rays are reflected in this wavelength region. Therefore, using the infrared cut film can reduce the spectral intensity of each peak position of the infrared rays emitted from the cold cathode fluorescent lamp, which is shown in FIG. 45. This prevents the infrared rays detected by an infrared photodiode.

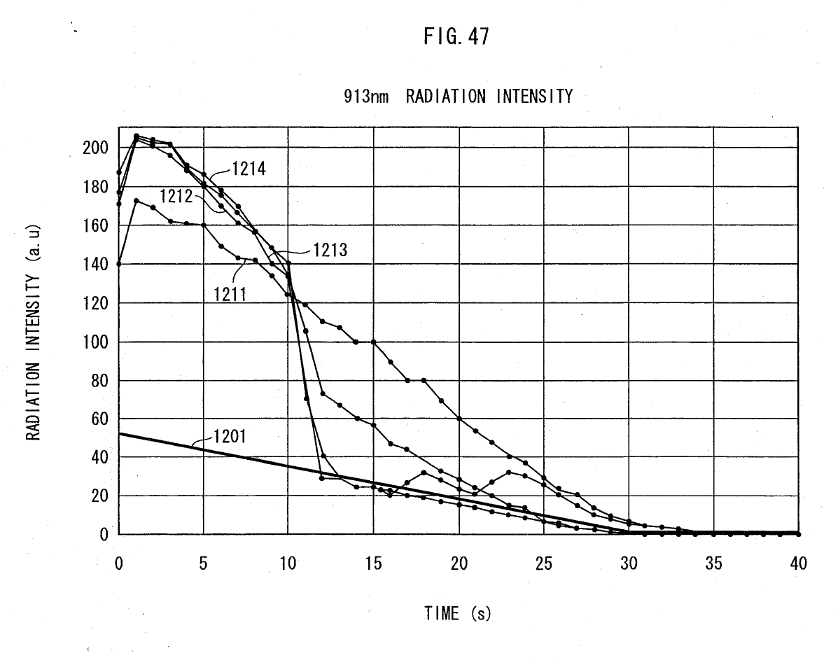

FIG. 47 is a graph that compares (i) the amount of infrared rays in a case where the amount of the infrared rays are reduced with use of a conventional technique (see Japanese Patent Application Publication No. 2005-285357), with (ii) the amount of infrared rays in a case where the amount of the infrared rays are reduced with use of the infrared cut film. In FIG. 47, a graph 1201 represents the amount of infrared rays in the case of using the infrared cut film, and graphs 1211-1214 each represent the amount of infrared rays in the case of using the conventional technique. Also, the vertical axis of the graph represents the emission intensity of an infrared ray having the wavelength of 913 nm, and the horizontal axis represents the time elapsed since the cold cathode fluorescent lamp was switched on.

As shown in FIG. 47, the amount of infrared rays is reduced about 10 seconds after the cold cathode fluorescent lamp is switched on in the conventional technique, while infrared rays are reflected immediately after the cold cathode fluorescent lamp is switched on when the infrared cut film is used.

[7] Size of Liquid Crystal Display

The following describes a relationship between the size of a liquid crystal display and the amount of emitted infrared rays.

Conventionally, the total amount of emitted infrared rays is not considerably large in a 23-inch liquid crystal display, and therefore the effect of the infrared rays on a remote controller is not seen as a problem. However, when the size of a liquid crystal display exceeds 26 inches, the total amount of infrared rays becomes a problem.

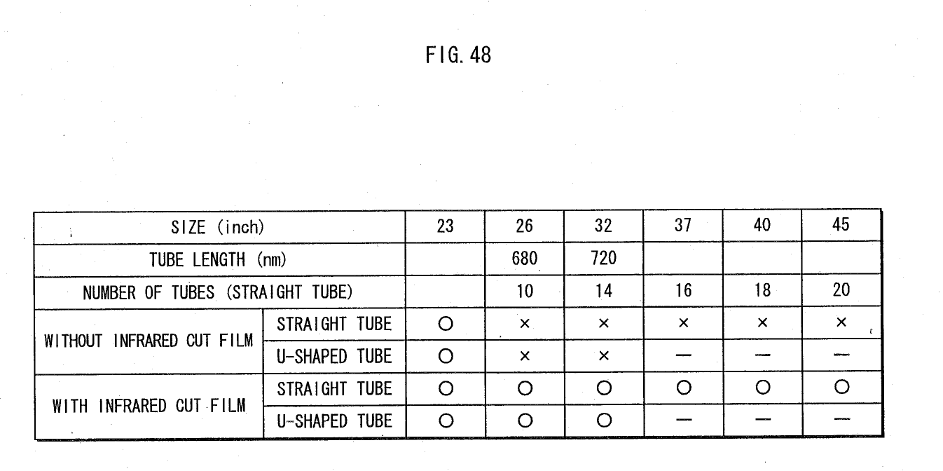

FIG. 48 is a table showing a relationship between the size of a liquid crystal display and the amount of infrared rays. FIG. 48 shows the tube length of the cold cathode fluorescent lamp used for a backlight, and the number of cold cathode fluorescent lamps, for each of the sizes of the liquid crystal display, and also shows whether each of the amount of infrared rays in a straight tube and the amount of infrared rays in a U-shaped tube is in the permissible range (◯ marker) or not (X marker), in the case of not using the infrared cut film and in the case of using the infrared cut film.

As shown in FIG. 48, when the size of a liquid crystal display is 23 inches, the amount of infrared rays is within the permissible range with or without the infrared cut film. However, when the size of a liquid crystal display exceeds 23 inches, the amount of infrared rays of a liquid crystal display that does not have the infrared cut film exceeds the permissible range, and affects a remote controller. Note here that the evaluation of the cold cathode fluorescent lamp having the U-shaped tube, with respect to a liquid crystal display having a size that is greater than or equal to 37 inches, is omitted. This is because a cold cathode fluorescent lamp having a U-shaped tube that is long enough to be applied to a liquid crystal display having a size that is greater than or equal to 37 inches has not yet been in practical use.

On the other hand, in the case of using the infrared cut film, the amount of infrared rays remains within the permissible range, even if the size of a liquid crystal display exceeds 23 inches. In this way, the construction with use of the infrared cut film is especially advantageous when the size of a liquid crystal display exceeds 23 inches.

[6] Modification

While the present invention has been described in accordance with the specific embodiments outlined above, it is evident that the present invention is not limited to such. The following modifications are also included in the present invention.

(1) The above-mentioned embodiments describe the case where the infrared cut film is formed on the outer wall of the cold cathode fluorescent lamp. However, the present invention is not limited to such. It is possible to form the infrared cut film on the inner wall of the lamp, instead of forming the infrared cut film on the outer wall of the lamp. The effect of the present invention is the same whichever wall surface of the lamp the infrared cut film is formed on.

(2) Although not particularly mentioned in the embodiments described above, the infrared cut film can be formed with use of, for example, a chemical vapor deposition (CVD) method, and more preferably with use of a low pressure CVD method. It is also possible to use a physical vapor deposition method such as sputtering or a dip method. The effect of the present invention can be obtained whichever formation method of the infrared cut film is adopted.

(3) The above-mentioned embodiments describe the construction of forming the infrared cut film on the outer wall of the cold cathode fluorescent lamp, and the construction of housing the cold cathode fluorescent lamp in the tube on which the infrared cut film has been formed. However, the present invention is not limited to such, and the following construction is also applicable.

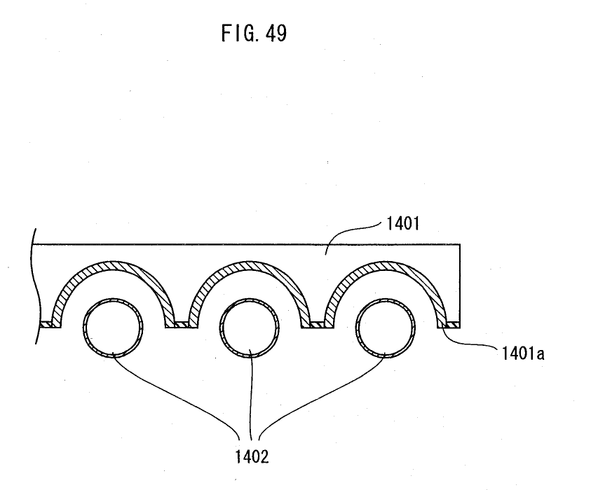

It is possible to use an infrared cut plate on which the above-mentioned multilayer film is formed. FIG. 49 is a sectional view that schematically shows the construction of the infrared cut plate according to the present modification. As shown in FIG. 49, an infrared cut plate 1401 has a groove that is parallel to the outer wall surface of the cold cathode fluorescent lamp 1402, and an infrared cut film 1401a is formed on the wall surface including the groove.

When such an infrared cut plate is used, infrared rays emitted from the cold cathode fluorescent lamp enter the infrared cut film 1401 a at an angle substantially perpendicular to the infrared cut film 1401a. This makes it possible to accurately reflect the infrared rays.

(4) The above-mentioned embodiments describe the case where a low refractive material used for the infrared cut film is silicon oxide and a high refractive material used for the infrared cut film is tantalum oxide. However, it is not limited to such. Other materials can be used for the infrared cut film, instead of the materials mentioned above. For example, it is possible to use, as a high refractive material, titanium oxide (TiO₂), magnesium oxide (MgO), zirconium oxide (ZrO₂), silicon nitride (either SiN or Si₃N₄ is acceptable), aluminum oxide (Al₂O₃), and hafnium oxide (HfO₃). Also, it is possible to use magnesium fluoride (MgF₂) as a low refractive material.

Also, the number of layers of the infrared cut film is of course not limited to the number described above, and the number of layers may be a number other than the number described above.

Furthermore, the value of the optical film thickness for each layer, which is described in the above embodiments, is just an example, and the optical film thickness may be set to a value other than the value described above. Here, the infrared cut film reflects infrared rays that are in a wavelength region centering on a wavelength that is four times as large as the optical film thickness of each layer.

Also, taking into consideration the fact that a remote controller communicates via near infrared rays, the effect of the present invention is the same even if the infrared cut film reflects only the near infrared rays out of infrared rays.

(5) The above-mentioned embodiments describe the case of blocking light that is in the infrared wavelength region, and that is emitted from the cold cathode fluorescent lamp. However, the present invention is not limited to such. It is possible to block the light that is in the infrared wavelength region, and that is emitted from a lamp other than the cold cathode fluorescent lamp, with use of the infrared cut film. In other words, the same effect is obtained by blocking the light that is in the infrared wavelength region, and that is emitted from either an external electrode fluorescent lamp (EEFL) or a hot cathode fluorescent lamp (HCFL), with use of the infrared cut film.

(6) Although not mentioned in the embodiments described above, a phosphor layer has been formed on the inner surface of the glass container 2305. It is possible to use the same phosphor as that of the embodiment 1, for a phosphor of the phosphor layer.

(7) Although not mentioned in the embodiments described above, the content ratio of iron oxide (Fe₂O₃) in the glass container of the cold cathode fluorescent lamp is preferably in the range of 0.01 weight % to 0.1 weight % inclusive. Also, the valence ratio of the iron oxide is preferably Fe²⁺/Fe³⁺<2.

### Embodiment 5

The embodiment 1 realizes a fluorescent lamp favorable as a light source of the backlight unit, wherein a range of color reproducibility of the fluorescent lamp after the light of the lamp has transmitted through the color filters is wider than that of a conventional fluorescent lamp. However, the use of the fluorescent lamp as a light source of the backlight unit is likely to cause a problem such as shortening the life of the electrodes or the occurrence of a cataphoresis phenomenon, as described below. In view of the below-described background art, an embodiment 5 is related to a technique that is for preventing the electrodes from having a shortened life, and that is for preventing the cataphoresis phenomenon.

Types of a backlight unit for a liquid crystal display device include a directly-below type. In a backlight unit of the directly-below type, a liquid crystal display panel which is provided on the front surface of a case is directly irradiated by a plurality of discharge lamps, for example, cold cathode fluorescent lamps, which are housed in the case. The discharge lamps are generally lit in a one-side high voltage lighting method. In this method, each of the lamps is lit while one of the two electrodes provided at one end of the glass tube of the discharge lamp is connected to the high-voltage side of an external power source, and the other one of the two electrodes provided at the other end of the glass tube of the discharge lamp is connected to the earth side of the external power source (hereinafter referred to as “low voltage side”).

In recent years, backlight units have been required to be thinner, resulting in the distance between a discharge lamp and the bottom surface of a case being shorter. This has caused problems, such as the electrode connected to the high voltage side of the external power source (namely, an electrode to which a high voltage is applied, which is hereinafter referred to as “high-voltage side electrode”) having a shorter life than the electrode connected to the earth side (namely, an electrode to which a low voltage is applied, which is hereinafter referred to as “low-voltage side electrode”) and the brightness in the vicinity of the one electrode being different from the brightness in the vicinity of the other electrode (so-called cataphoresis phenomenon).

Specifically, the bottom surface of the case is made of a metal material. Therefore, when the discharge lamp is arranged close to the bottom surface of the case, the parasitic capacitance is generated between the discharge lamp and the bottom surface, causing a part of the lamp current to flow on the bottom surface as leak current. As a result, the lamp current that flows through the high-voltage side electrode of the discharge lamp becomes larger than the low-voltage side electrode thereof, whereby the sputter of the high-voltage electrode becomes large, and the temperature of the high-voltage electrode also becomes large.

Note that the problems described above occur in the same manner, in a case where the distance between the discharge lamp and the surface on which the discharge lamp is placed is short and the surface on which the discharge lamp is placed has a conductivity characteristic, when the discharge lamp is used in a lighting device.

In view of the above described problems, a further object of an embodiment 5 is to provide a discharge lamp, a backlight unit, and a liquid crystal display device that prevent the electrodes from having a shortened life, and that prevent the cataphoresis phenomenon, while the backlight unit, the lighting device, etc. are designed to be thin.

In order to achieve the above-described object, in the embodiment 5, the present invention provides a discharge lamp having a glass tube, wherein each end of the glass tube is provided with a different one of electrodes, a high voltage is applied to one of the electrodes, and a low voltage is applied to an other one of the electrodes, and each end of the discharge lamp has a heat release structure that releases heat from the respective electrodes, a heat resistance of the heat release structure on a side of the electrode to which the high voltage is applied is smaller than a heat resistance of the heat release structure on a side of the electrode to which the low voltage is applied.

The above-described “each end of the discharge lamp” is used under the concept that includes a case where the ends of the discharge lamp are the ends of the glass tube, and where the ends of the discharge lamp are parts of electrodes that are each provided on the respective ends of the glass tube.

Also, the discharge lamp further comprises bushings each of which covers a periphery portion of a different one of electrodes in the glass tube, and fixes the discharge lamp to a fixing apparatus, wherein a heat release structure releases heat by conducting the heat from the bushings to the fixing apparatus, and an area of contact between one of the bushings and the fixing apparatus is larger than an area of contact between an other one of the bushings and the fixing apparatus, the one of the bushings being on a side of the electrode to which a high voltage is applied, and the other one of the bushings being on a side of the electrode to which a low voltage is applied. The above-described “mounting apparatus” is used under the concept where the mounting apparatus may be, for example, the backlight unit, the lighting device, etc.

Furthermore, the discharge lamp further comprises covering members each of which covers a periphery portion of a different one of electrodes in the glass tube, wherein a heat release structure releases heat by emitting the heat from the covering members to an outside air, and an area of the heat emission of one of the covering members is larger than an area of the heat emission of an other one of the covering members, the one of the covering members being on a side of the electrode to which a high voltage is applied, the other one of the covering members being on a side of the electrode to which a low voltage is applied.

The discharge lamp further comprises lead wires made of metal, each of which is connected to a different one of electrodes and extends from a different one of ends of the glass tube, wherein a heat release structure releases heat by emitting the heat from a portion of each lead wire to an outside air, each of the portions positioned outside the glass tube, and an area of the heat emission of one of the lead wires is larger than an area of the heat emission of an other one of the lead wires, the one of the lead wires being on a side of the electrode to which a high voltage is applied, the other one of the lead wires being on a side of the electrode to which a low voltage is applied.

Also, in order to achieve the above-described object, one backlight unit according to the embodiment 5 is lit by applying a high voltage to an electrode and a low voltage to another electrode, in a state where one or more discharge lamps are housed in a case, the one or more discharge lamps each having the electrode at one end of a glass tube and the other electrode at another end of the glass tube, and at least a part of a bottom plate of the case having a conductivity characteristic, wherein the backlight unit has a heat release structure for releasing heat from each electrode, and in the heat release structure, a heat resistance of the heat release structure on the side of the electrode of the discharge lamp to which the high voltage is applied is smaller than a heat resistance of the heat release structure on the side of the electrode of the discharge lamp to which the low voltage is applied.

The above-described “at least a part of a bottom plate of the case having a conductivity characteristic” is used under the concept of including (i) a case where the entire bottom plate has the conductivity characteristic by forming the whole bottom plate with a conductive material, (ii) a case where the entire surface of the bottom plate, which faces the discharge lamp, has the conductivity characteristic by attaching the conductive material (a conductive sheet, for example) to the surface of a bottom plate base, which faces the discharge lamp, or by forming the surface of the bottom plate base, which faces the discharge lamp, to be conductive (by plating the surface with a metal, example), and (iii) a case where a part of the surface of the bottom plate, which faces the discharge lamp, has the conductivity characteristic by attaching the conductive material (a conductive sheet, for example) to only the part of the bottom plate base, which faces the discharge lamp, or by forming only the part of the bottom plate base, which faces the discharge lamp, to be conductive (by plating the surface with a metal, example), etc., for example.

Furthermore, the discharge lamp further comprises bushings each of which covers a periphery portion of a different one of electrodes in the glass tube, and is fixed to the case, wherein a heat release structure releases heat by conducting the heat from the bushings to the case, and an area of contact between one of the bushings and the case is larger than an area of contact between an other one of the bushings and the case, the one of the bushings being on a side of the electrode to which a high voltage is applied, and the other one of the bushings being on a side of the electrode to which a low voltage is applied.

Also, in order to achieve the above-described object, one liquid crystal display device according to the embodiment 5 includes the above-described backlight unit.

In the discharge lamp according to the embodiment 5, each end of the lamp has the heat release structure for releasing heat from each electrode, and the heat resistance of the heat release structure on the side of the electrode to which the high voltage is applied is smaller than the heat resistance of the heat release structure on the side of the electrode to which the low voltage is applied. Therefore, the side of the electrode to which the high voltage is applied can release more heat than the side of the electrode to which the low voltage is applied. This prevents a rise in the temperature of the electrode to which the high voltage is applied, and a difference in temperature between the vicinity of the electrode to which the high voltage is applied and the vicinity of the electrode to which the low voltage is applied, resulting in preventing the electrode to which the high voltage is applied from having a shortened life and preventing the cataphoresis phenomenon.

Also, the backlight unit according to the embodiment 5 has the heat release structure for releasing heat from each electrode, and the heat resistance of the heat release structure on the side of the electrode to which the high voltage is applied is smaller than the heat resistance of the heat release structure on the side of the electrode to which the low voltage is applied. Therefore, the side of the electrode to which the high voltage is applied can release more heat than the side of the electrode to which the low voltage is applied. This prevents a rise in the temperature of the electrode to which the high voltage is applied, and a difference in temperature between the vicinity of the electrode to which the high voltage is applied and the vicinity of the electrode to which the low voltage is applied, resulting in preventing the electrode of the discharge lamp to which the high voltage is applied from having a shortened life and preventing the cataphoresis phenomenon.

Furthermore, the liquid crystal display device according to the embodiment 5 includes the above-described backlight unit, thereby preventing the electrode of the discharge lamp to which the high voltage is applied from having a shortened life and preventing the cataphoresis phenomenon.

The following is a detailed description of the embodiment 5, with reference to the drawings.

### Embodiment 5-1

The following describes an embodiment of a backlight unit and a liquid crystal display unit that include a discharge lamp according to the present invention.

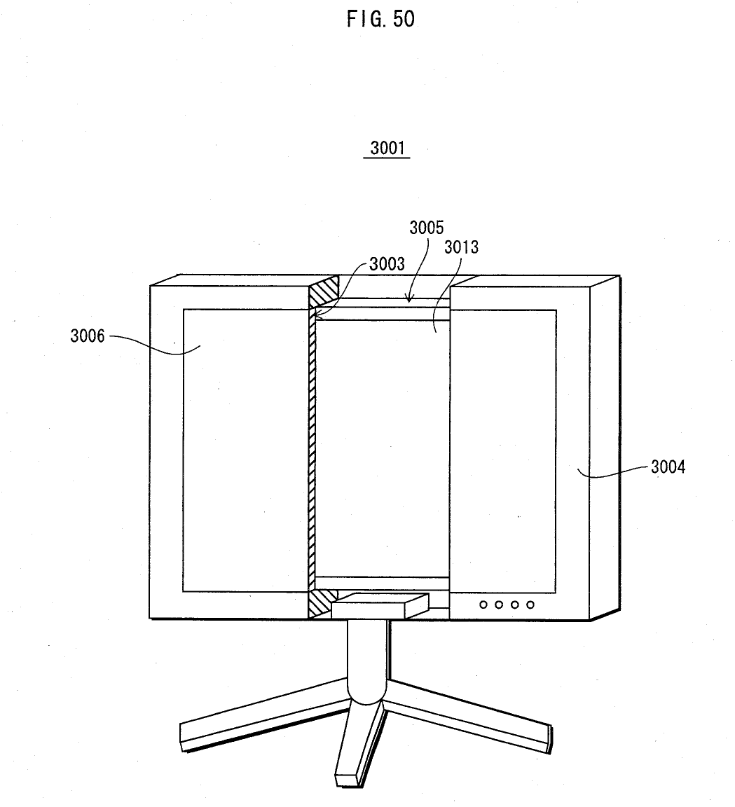

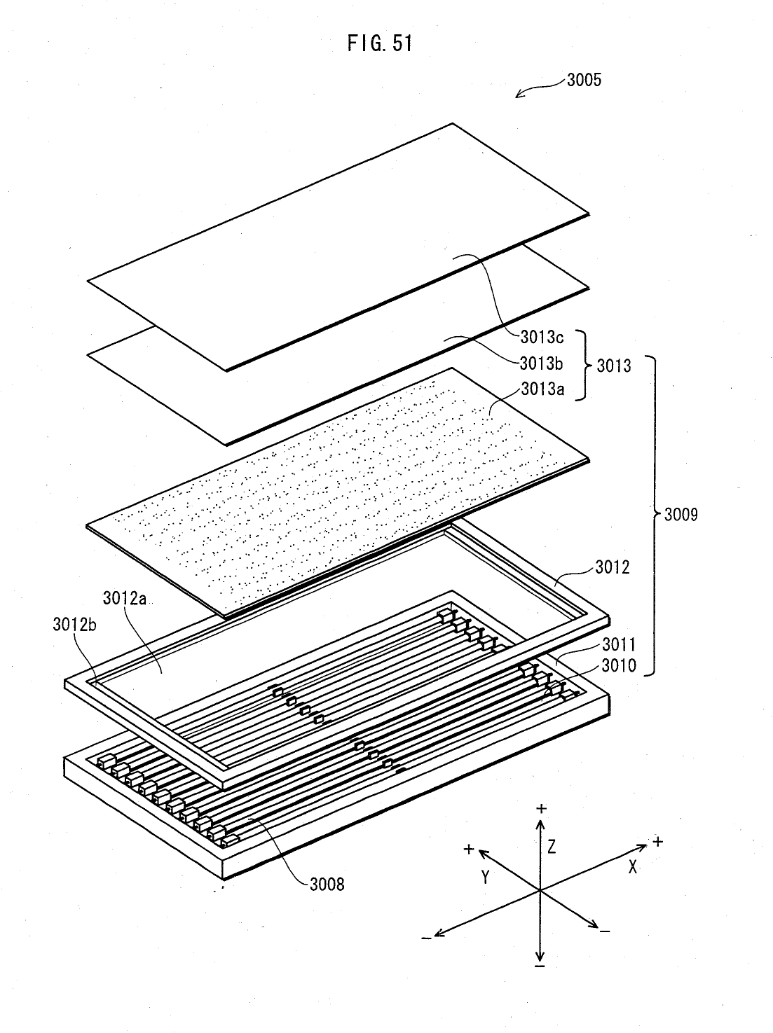

FIG. 50 shows a liquid crystal display device according to the present embodiment, part of which is cut away so as to show the inside.

A liquid crystal display device 3001 is a liquid crystal color television for example, and is formed by a liquid crystal display unit 3003 and a backlight unit 3005 being incorporated into a case 3004. The liquid crystal display unit 3003 includes, for example, a color filter substrate, a liquid crystal, a TFT substrate, a drive module (not shown), etc., and displays a color image on a display 3006 of the liquid crystal display unit 3003, based on an image signal.

FIG. 51 is an exploded perspective view showing a general construction of a backlight unit according to the present embodiment. The backlight unit 3005 is for a liquid crystal display device, and is provided on the backside of the liquid crystal display unit 3003 (not shown) for use. In the backlight unit 3005, the X-axis direction in FIG. 51 is the horizontal direction (the + side being the right side, and the − side being the left side) in FIG. 50, the Y-axis direction in FIG. 51 is the vertical direction (the + side being the upper side, and the − side being the lower side) in FIG. 50, and the Z-axis direction in FIG. 51 is the cross direction (the +side being the front side, namely the side of the liquid crystal display unit 3003, and the side being the back side) in FIG. 50.

The backlight unit 3005 includes a plurality of (ten, for example) discharge lamps 3008, and a case 3009 that houses the discharge lamps 3008. Each of the discharge lamps 3008 is a fluorescent lamp of an inner electrode type that has an electrode provided in a glass tube, and more specifically, a so-called cold cathode fluorescent lamp whose electrode is of a cold cathode type, which is described below.

The case 3009 includes a reflection plate 3010, a side plate 3011, a fixing frame 3012, a translucent plate 3013, etc.

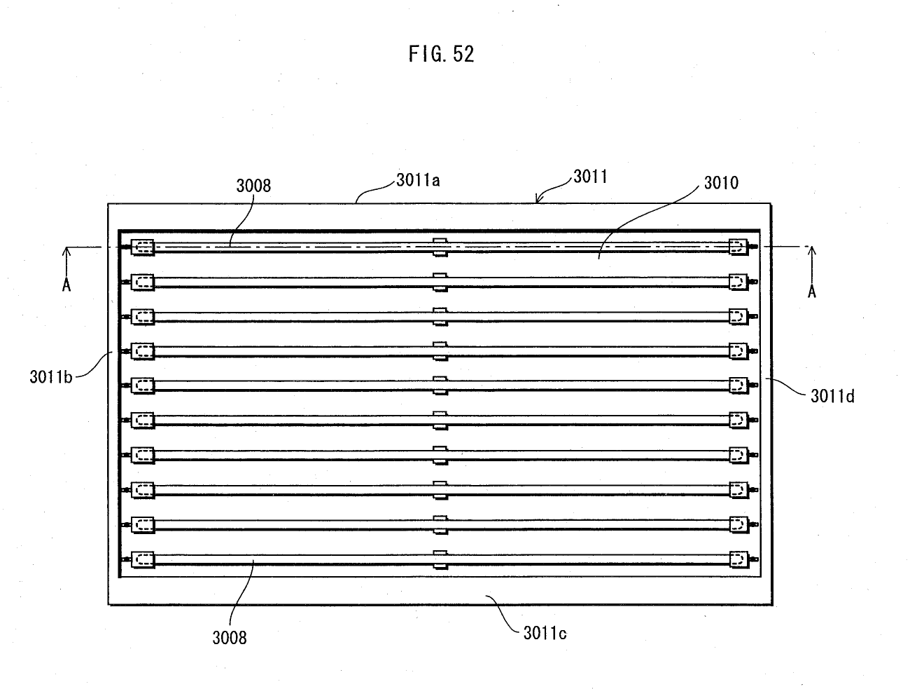

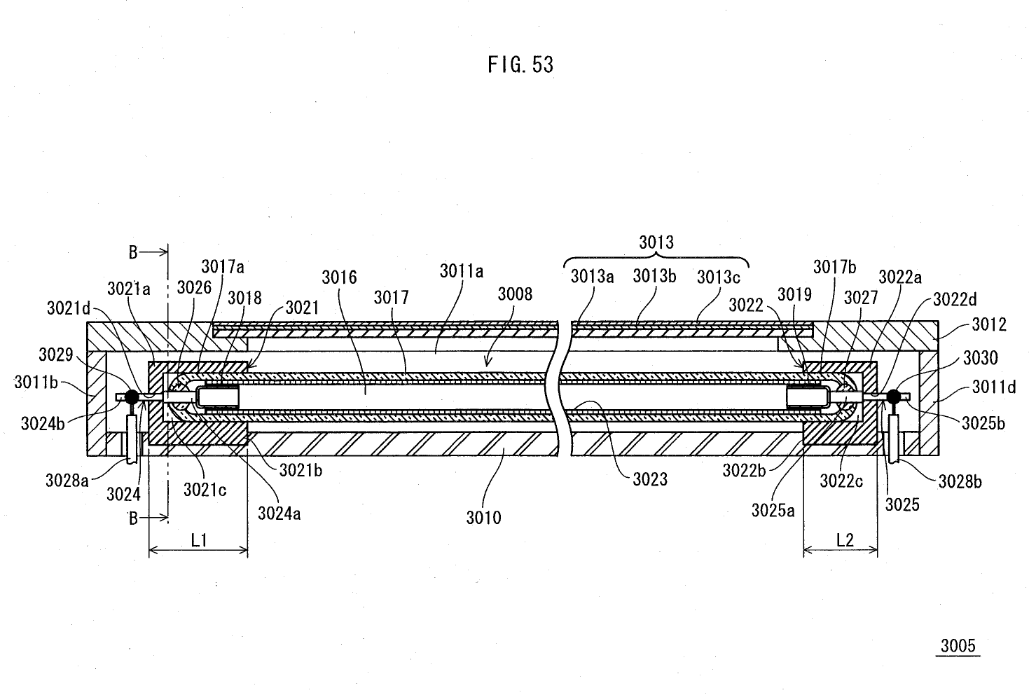

FIG. 52 is a plane view showing the backlight unit without the fixing frame and the translucent plate, and FIG. 53 shows a cross section seen from the arrow direction, the cross section being taken along the line A-A in FIG. 52.

The reflection plate 3010 is equivalent to a bottom plate of the case 3009 having a box shape, and is made of a conductive material, for example, a metal material such as iron and aluminum. The main surface of the reflection plate 3010 on the side of the discharge lamps 3008 is a reflection surface having a mirror surface finish. Note here that the bottom plate is not necessarily made of a metal material so that the entire bottom plate has a conductivity characteristic. Instead, it is possible to form the bottom plate base with an insulation material such as resin, and attach an aluminum foil on the entire inner surface (the surface facing the discharge lamp) of the bottom plate base or only on part facing the discharge lamps.

As shown in FIG. 52, the side plate 3011 is in the shape of a frame having four sides, namely sides 3011a, 3011b, 3011c, and 3011d, and is provided so as to surround the plurality of (ten) discharge lamps 3008 in four directions, along the outer peripheral edge of the reflection plate 3010.

The fixing frame 3012 is, for example, in the shape of a frame, which is formed with non-translucent material, and has an opening 3012 a having a rectangular shape, for taking out light. The front surface of the fixing frame 3012 has a recessed portion 3012b that is slightly larger than the opening 3012a, and the translucent plate 3013 is fit into the recessed portion 3012b so as to cover the opening 3012a.

Note that the fixing frame 3012 is not necessarily in the shape of a frame. For example, the fixing frame 3012 maybe formed by combining a pair of L-shaped fixing materials or combining a pair of squared U-shaped fixing materials, so that the fixing materials form an open square shape.

The translucent plate 3013 is formed by a diffusion plate 3013a, a diffusion sheet 3013b, and a lens sheet 3013c laminated thereon, starting from the back side of the translucent plate 3013 (the side where the discharge lamps 3008 are located). The diffusion plate 3013a is, for example, a plate material formed with a polycarbonate (PC) resin. The diffusion sheet 3013b is, for example, a sheet material formed with the same polycarbonate (PC) resin as the diffusion plate 3013a. The lens sheet 3013c is, for example, a sheet material formed with an acrylic resin.

The translucent plate 3013 having the above-described construction diffuses light emitted from the discharge lamps 3008 when the light transmits through the diffusion plate 3013a, whereby the diffused light is emitted from the entire surface of the diffusion plate 3013a as a parallel light that has been averaged (equalized).

As shown in FIG. 53, each of the discharge lamp 3008 includes a glass tube 3017 having a discharge space 3016 inside, electrodes 3018 and 3019 provided in positions equivalent to the ends of the discharge space 3016, and bushings 3021 and 3022 provided at ends 3017a and 3017b of the glass tube 3017, respectively. Each of the discharge lamps 3008 is mounted in the case 3009 via the bushings 3021 and 3022, and is lit in a one-side high voltage lighting method with use of a lighting circuit (not shown), which is described below.

The glass tube 3017 is formed with, for example, borosilicate glass (SiO₂—B₂O₃—Al₂O₃—K₂O—TiO₂), has a substantially circular cross section, and has a 3 [mm] outer diameter, 2 [mm] inner diameter, and a 0.5 [mm] material thickness.

Note that the material, shape, dimensions, etc. of the glass tube 3017 are not limited to the specific examples given above. For example, the glass tube 3017 may be formed with soda glass, and the cross section of the glass tube 3017 may have a polygonal shape, an elliptical shape, or a flat shape. However, as for the dimensions of the glass tube 3017, it is preferable that the inner diameter (maximum dimension of the cross section) is in the range of 1 [mm] to 8 [mm] inclusive, and the thickness of the glass tube is in the range of 0.2 [mm] to 0.7 [mm] inclusive, in terms of thinning the backlight unit 3005.

The inner surface of the glass tube 3017 has formed thereon a phosphor layer 3023 composed of a plurality of kinds of phosphor particles. It is possible to use the same phosphor as the embodiment 1, for a phosphor used for the phosphor layer 3023.

The inside of the glass tube 3017 is filled with, for example, approximately 3 [mg] of mercury (not shown), and a neon-argon mixed gas (Ne 95[%]+Ar 5[%]) at the gas pressure of 60 [Torr] as a rare gas.

Note that the constructions of the phosphor layer 3023, mercury, and rare gas are not limited to those described above. For example, the inside of the glass tube 3017 may be filled with a neon-krypton mixed gas (Ne 95[%]+Kr 5[%]) as a rare gas. When the neon-krypton mixed gas is used as a rare gas, the lamp start-up performance is improved, enabling the discharge lamps 3008 to be lit at a low voltage.

The end 3017a of the glass tube 3017 is bonded to a lead wire 3024, and the end 3017b of the glass tube 3017 is bonded to a lead wire 3025. The lead wire 3024 connects, for example, an inner lead wire 3024a that is made of tungsten with an outer lead wire 3024b that is made of nickel. The lead wire 3025 connects, for example, an inner lead wire 3025a that is made of tungsten with an outer lead wire 3025b that is made of nickel. The inner lead wires 3024a and 3025a are hermetically threaded through substantially the center of a bead glass 3026 and substantially the center of a bead glass 3027, respectively. Then, in this state, the bead glass 3026 is bonded to the end 3017a of the glass tube 3017, and the bead glass 3027 is bonded to the end 3017b of the glass tube 3017. This causes the inside of the glass tube to be airtight, resulting in the discharge space 3016 being formed inside the glass tube 3017.

Each of the inner lead wires 3024a and 3025a has a substantially circular cross section, so as to improve the adhesion (airtightness) with the bead glasses 3026 and 3027, respectively. Note that the cross section of each of the outer lead wires 3024b and 3025b may have a circular shape, a polygonal shape, an elliptical shape, or a flat shape. Also, the inner lead wires 3024a and 3025a used here are thicker than the outer lead wires 3024b and 3025b.

The end of the inner lead wire 3024a on the side of the discharge space is bonded to the electrode 3018, and the end of the inner lead wire 3025a on the side of the discharge space is bonded to the electrode 3019, by laser welding or the like. Each of the electrodes 3018 and 3019 is, for example, a so-called hollow type electrode that is in the shape of a tube having a closed end, and is formed by processing a niobium (Nb) rod. Each of the electrodes 3018 and 3019 has, for example, a 5.5 [mm] entire length, a 1.7 [mm] outer diameter, a 1.5 [mm] inner diameter, and a 0.1 [mm] material thickness.

Note that the dimensions of each of the electrodes are not limited to the values described above. Furthermore, although the hollow type electrodes that are each in the shape of a tube having a closed end are used as the electrodes 3018 and 3019, the shape of the electrodes is not limited to such. For example, it is possible to use electrodes having a cylindrical shape or a narrow plate shape. Here, the hollow type electrode is adopted as each of the electrodes because it is effective to prevent the sputtering of each electrode generated by discharge that occurs while the lamp is lit (see Japanese Patent Application Publication No. 2002-289138, etc. for detail).

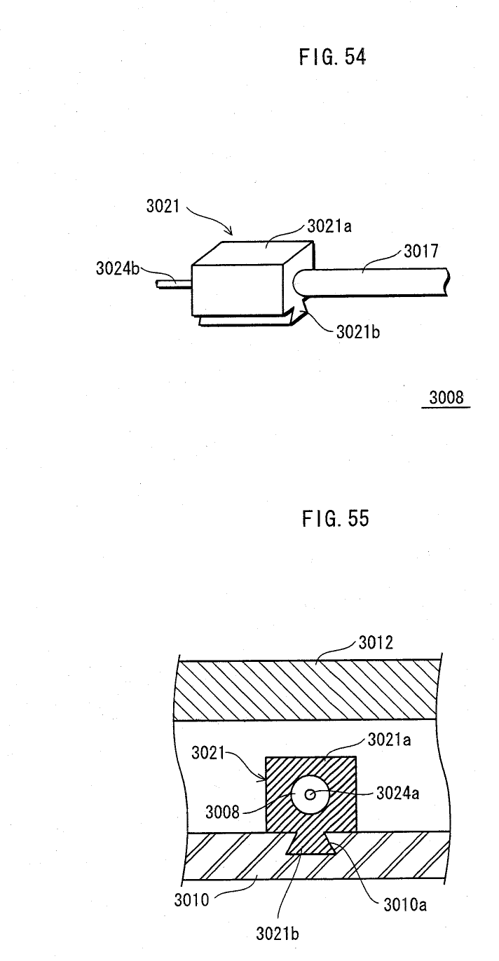

FIG. 54 is a perspective view showing the bushing 3021 provided at one end of the discharge lamp 3008.

As shown in FIGS. 53 and 54, the bushing 3021 (, 3022) is provided at the end 3017a (, 3017b) of the glass tube 3017. The bushing 3021 is formed with, for example, a silicon rubber material, and has a cap shape that covers the end 3017a (, 3017b) of the glass tube 3017 such that the bushing 3021 is attached firmly to the end 3017a (, 3017b). Note that the bushing 3022 basically has the same construction as the bushing 3021.

Each of the bushings 3021 and 3022 is a bush as one example according to the present embodiment. The bushing 3021 includes a bushing body 3021a and a fixing part arranged on the bushing body 3021a, and the bushing 3022 includes a bushing body 3022a and a fixing part arranged on the bushing body 3022a. Each of the bushing bodies 3021a and 3022a is in the shape of a rectangular parallelepiped. One surface of the bushing body 3021a has formed thereon an insertion hole 3021c (see FIG. 53) into which the end 3017a of the glass tube 3017 is inserted, and one surface of the bushing body 3022a has formed thereon an insertion hole 3022c (see FIG. 53) into which the end 3017b of the glass tube 3017 is inserted. Also, each of the fixing parts is provided on one surface of the peripheral surfaces (four surfaces parallel to the shaft center of the end 3017a of the glass tube 3017) of the bushing body 3021a, and one surface of the peripheral surfaces (four surfaces parallel to the shaft center of the end 3017b of the glass tube 3017) of the bushing body 3022a, respectively.

The bottom of the insertion hole 3021c in the bushing body 3021a has a through-hole 3021d through which the lead wire 3024 is inserted (external lead wire 3024b in FIG. 53), and the bottom of the insertion hole 3022c in the bushing body 3022a has a through-hole 3022d through which the lead wire 3025 is inserted (external lead wire 3025b in FIG. 53). With the ends 3017a and 3017b of the glass tube 3017 being covered, the external lead wires 3024b and 3025b pass through the through-holes 3021d and 3022d, respectively. The external lead wire 3024b is connected to a power supply line 3028a outside the bushing 3021 of the external lead wire 3024b via soldering 3029 or the like, and the external lead wire 3025b is connected to a power supply line 3028b outside the bushing 3022 of the external lead wire 3025b via soldering 3030 or the like. Here, the power supply lines 3028a and 3028b are connected to a lighting circuit that is for lighting each of the discharge lamps 3008.

In the present embodiment, the discharge lamps 3008 are mounted in the case 3009 by utilizing an engagement structure between (i) each of the bushings 3021 and 3022 and (ii) the reflection plate 3010.

FIG. 55 shows a cross section seen from the arrow direction, the cross section being taken along the line B-B in FIG. 53.

In the engagement structure, a dovetail groove 3010a is formed in the reflection plate 3010 of the case 3009, and an engagement part 3021b that engages with the dovetail groove 3010a is formed on the bushing body 3021a, by being pressed into the dovetail groove 3010a. Note that the same is applied to the bushing 3022.

As shown in FIG. 55, the cross section of the dovetail groove 3010a formed in the reflection plate 3010 has a shape in which the width of the cross section becomes larger with increasing depth from the surface of the reflection plate 3010, such as a trapezoidal shape. Also, the cross section of the engagement part 3021b that engages with the dovetail groove 3010a has a shape in which the width of the cross section becomes larger with increasing amount of protrusion from the bushing body 3021a (with increasing distance from the bushing body 3021a), in accordance with the shape of the cross section of the dovetail groove 3010a.

As shown in FIG. 54, the length of (the dimension of the glass tube 3017 in the lengthwise direction) the engagement part 3021b is formed to be substantially the same as the length of the bushing body 3021a.

As shown in FIGS. 53 and 54, the size of the bushing 3021 is larger than the size of the bushing 3022, since the bushing 3021 is on the side to which a high voltage is applied (hereinafter referred to as “high voltage side”) and the busing 3022 is on the side to which an earth voltage is applied (hereinafter referred to as “low voltage side”). The area of contact between the engagement part 3021b and the reflection plate 3010 is larger than the area of contact between the engagement part 3022b and the reflection plate 3010, since the engagement part 3021b is on the high voltage side and the engagement part 3022 is on the low voltage side.

Note that the present embodiment has a heat release structure in which the heat of the electrodes 3018 and 3019 is released by heat conduction from the bushings 3021 and 3022 to the case 3009 via the reflection plate 3010.

Specifically, the shape of the cross section of the bushing 3021 on the high voltage side is the same as that of the bushing 3022 on the low voltage side. Here, the cross sections of the bushings 3021 and 3022 include the cross sections of the engagement parts 3021b and 3022b, respectively. The length of the bushing 3021 on the high voltage side in the lengthwise direction (L1 in FIG. 53) is greater than the length of the bushing 3022 on the low voltage side in the lengthwise direction (L2 in FIG. 53). The length of the engagement part 3021b on the high voltage side is greater than the length of the engagement part 3022b on the low voltage side. This construction makes it possible to efficiently conduct heat to the case 3009 (reflection plate 3010), from the electrode 3018 on the high voltage side whose temperature is likely to be higher than the temperature of the electrode 3019 on the low voltage side.

Note here that the material, shape, and fixing part of each of the bushings 3021 and 3022 are not limited to those described above. As the fixing part, the material of the bushing 3021 described here is required to have resilience, so as to press the engagement part 3021b into the dovetail groove 3010a. However, in a case of not being required to have resilience as the fixing part, the bushing can be made of a metal material, a resin material, or such.

However, in the embodiment 5-1, it is preferable that the bushings 3021 and 3022 are made of a material having a high heat conductivity, since the heat conduction from the bushings 3021 and 3022 to the case 3009 is made easier (in other words, the heat resistance is made smaller) by increasing the area of contact between the bushings 3021, 3022 and the case 3009.

The backlight unit 3005 in the embodiment 5-1 has a construction in which the heat from the electrode 3018 on the high voltage side is conducted to the side of the case 3009 via the bushing 3021. Therefore, the area of contact between the bushing 3021 and the case 3009 is larger than the area of contact between bushing 3022 and the case 3009, since the bushing 3021 is on the high voltage side and the bushing 3022 is on the low voltage side.

From this point of view, the bushings 3021 and 3022 may have the same length and different cross section shapes, thereby changing the area of contact with the case, instead of having the same cross section shape and different lengths.

### Embodiment 5-2

In the embodiment 5-1, the heat from the electrode 3018 on the high voltage side is conducted to the case 3009, by differentiating the size of the bushing 3021 from that of the bushing 3022, especially the area of contact between the bushing 3021 and the case 3091 and the area of contact between the bushing 3022 and the case 3091.

In the embodiment 5-2, a description is provided below of an example in which the heat release characteristic of a part of the discharge lamp on the high voltage side is greater than that of a part of the discharge lamp on the low voltage side.

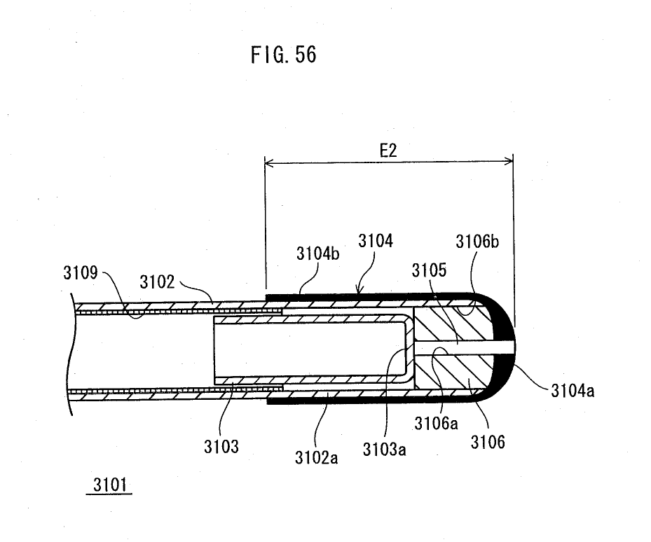

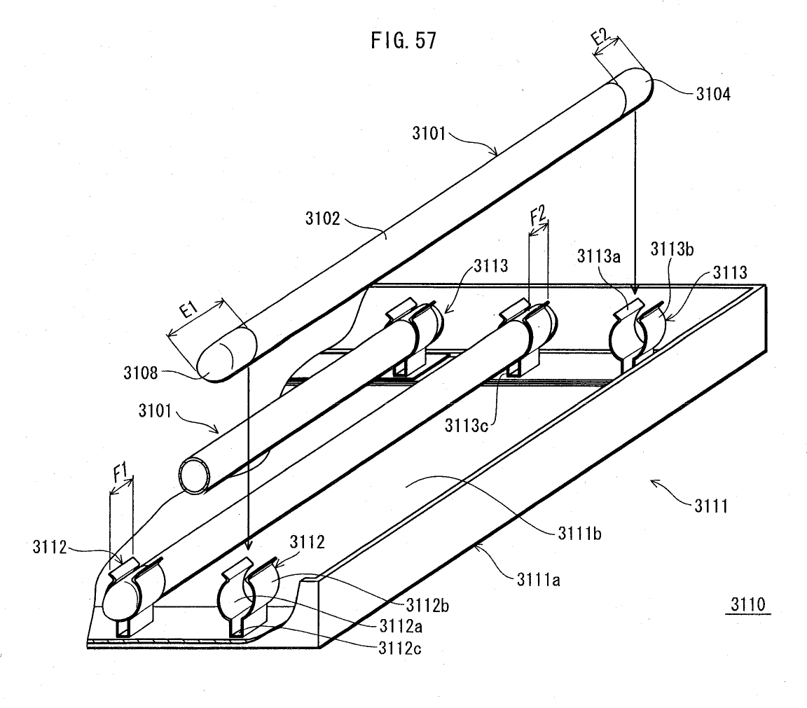

FIG. 56 is a magnified sectional view of an end portion of a discharge lamp according to the embodiment 5-2, and FIG. 57 is a backlight unit according to the embodiment 5-2.

As shown in FIGS. 56 and 57, a discharge lamp 3101 includes a glass tube 3102, electrodes 3103 and 3107 (not shown for the convenience of drawings) that are each provided at a respective one of end portions 3102a and 3102b of the glass tube 3102 (not shown for the convenience of drawings), feed terminals 3104 (equivalent to the “covering member” in the present invention) and 3108 (not shown for the convenience of drawings) that are connected to the electrodes 3103 and 3107 respectively, and that are provided on the outside of the end portion 3102a and on the outside of the end portion 3102b respectively.

The following describes the electrode 3103, and not the electrode 3107, since the electrode 3107 has the same construction as the electrode 3103 shown in FIG. 56.

The electrode 3103 is a hollow type electrode in the shape of a tube having a closed end, in the same manner as the embodiment 5-1. A lead wire 3105 is bonded to a bottom 3103a of the electrode 3103 by welding. The lead wire 3105 is inserted into a through-hole 3106a of a bead glass 3106 until the bottom 3103a of the electrode 3103 is in contact with the bead glass 3106, whereby the outer peripheral surface 3106b of the bead glass 3106 is welded to the inner peripheral surface of the glass tube 3102. In this way, the glass tube 3102 is sealed hermetically.

Note that the discharge lamp 3101 in the embodiment 5-2 also has a phosphor layer 3109 formed on the inner surface of the glass tube 3102, and the inside (discharge space) of the glass tube 3102 is filled with mercury, a rare gas, etc., in the same manner as the discharge lamp 3008 described in the embodiment 5-1.

The feed terminals 3104 and 3108 are provided at the ends 3102a and 3102b of the sealed glass tube 3102 respectively, so as to cover the ends 3102a and 3102b. Here, the end 3102b is at the opposite end of the end 3102a of the glass tube 3102 shown in FIG. 56, and not shown for the convenience of drawings). The feed terminals 3104 (, 3108) is, for example, made of solder, and is composed of a bonded part 3104a that is bonded to the lead wire 3105 as shown in FIG. 56, and a tube part 3104b that is a part excluding the bonded part 3104a.

The bonded part 3104a is a part where the feed terminal 3104 is electrically connected to the lead wire 3105, and has a substantially hemispherical shape in appearance. Therefore, the bonded part 3104a is in a perfect contact with the entire outer surface of the lead wire 3105 that extends from the bead glass 3106, and thereby conducts heat from the electrode 3103 whose temperature has become high, to the feed terminal 3104 via the lead wire 3105, the conducted heat being emitted from the feed terminal 3104 to the outside air.

Not that the embodiment 5-2 has a heat release structure in which the heat of the electrodes 3103 and 3107 is released by heat conduction from the feed terminals 3104 and 3108 to the outside air (air).

As shown in FIG. 57, in the discharge lamp 3101 having the above-described construction, an entire length E1 of the feed terminal 3108 provided on the high voltage side is longer than an entire length E2 of the feed terminal 3104 provided on the low voltage side. This means that the area of contact (equivalent to the “heat emission area” in the present application) between the feed terminal 3108 on the high voltage side and the outside air is larger than the area of contact between the feed terminal 3104 on the low voltage side and the outside air (equivalent to the “heat emission area” in the present application).

This enables the amount of heat emission from the electrode 3107 on the high voltage side to the outside air to be larger than the amount of heat emission from the electrode 3103 on the low voltage side to the outside air (namely, the heat resistance on the high voltage side being smaller than the heat resistance on the low voltage side). As a result, the temperature of the electrode 3107 on the high voltage side can be closer to the temperature of the electrode 3103 on the low voltage side.

Also, the bottom 3103 a of the electrode 3103 is in contact with the bead glass 3106. When comparing a discharge lamp in a case where the bottom of each electrode is in contact with the respective bead glasses, with a discharge lamp in a case where the bottom of each electrode is out of contact with the respective bead glasses, under the condition that the distance between the pair of electrodes is the same, the entire length of the discharge lamp in the case where the bottom of each electrode is in contact with the respective bead glasses is shorter.

To put it the other way around, when comparing the two discharge lamps under the condition that the entire length of the lamps is the same, the distance between a pair of electrodes is longer in a case where the bottom of each electrode is in contact with the respective bead glasses.

Furthermore, when, for example, the bottom of the electrode on the high voltage side is in contact with the bead glass and the bottom of the electrode on the low voltage side is out of contact with the bead glass, the heat of the electrode on the high voltage side can be more directly conducted from the bottom of the electrode to the bead glass. This makes it possible to minimize a difference in temperature between the electrode on the high voltage side and the electrode on the low voltage side.

In view of the heat emission of the electrode on the high voltage side, heat is conducted from the bottom of the electrode to the bead glass. Therefore, it is possible to reduce the amount of heat conducted via the lead wire, by the amount of heat conducted from the bottom of the electrode. In other words, the heat release effect is the same between (i) an electrode having a thin wire, the bottom of the electrode being in contact with the bead glass and (ii) an electrode having a thick lead wire, the bottom of the electrode being out of contact with the bead glass.

The following describes a backlight unit in which the discharge lamp 3101 having the above-described construction is used.

A backlight unit 3110 includes a case 3111, the plurality of discharge lamps 3101, and a lighting circuit (not shown) for lighting the plurality of discharge lamps 3101, as seen in the embodiment 5-1.

The case 3111 includes a case body 3111 a formed in the shape of a box, with use of a flat plate made of metal, and a translucent plate (not shown) that covers an opening of the case body 3111 a having a box shape.

As shown in FIG. 57, a bottom plate 3111b of the case body 3111a is provided with pairs of U-shaped lamp holders 3112 and 3113. The pairs of lamp holders 3112 and 3113 are arranged on the bottom plate 3111b in correspondence with the positions where the plurality of discharge lamps 3101 are mounted. Each of the discharge lamps 3101 is mounted in the case 3111, by the lamp holders 3112 and 3113 holding the feed terminals 3104 and 3108 provided at the ends of each lamp.

The lamp holders 3112 and 3113 are formed by bending a conductive material, such as a plate material made of stainless or phosphor bronze. Each of the discharge lamps 3101 are fed with power via the lamp holders 3112 and 3113. Even when the power is being fed, a high voltage is applied to one of the electrode pair of each discharge lamp 3101, which is the electrode 3107 in this embodiment, via the lamp holder 3112 and the feed terminal 3108, and, an earth voltage is applied to the other one of the electrode pair, which is the electrode 3103, via the lamp holder 3113 and the feed terminal 3104.

Each of the lamp holders 3112 (, 3113 ) is composed of pinch plates 3112a and 3112b (3113a, 3113b), and a connection member 3112c (3113c) that connects the lower edge of the pinch plate 3112a (3113a) with the lower edge of the pinch plate 3112b (3113b).

Each of the pinch plates 3112a, 3112b, 3113a, and 3113b is provided with a concave part that is formed along the outlines of the feed terminals 3104 and 3108 of each discharge lamp 3101. When the feed terminals 3104 and 3108 of each discharge lamp 3101 are fixed in the concave parts, each discharge lamp 3101 is held by the lamp holders 3112 and 3113 by the plate spring function of the pinch plates 3112a, 3112b, 3113a, and 3113b, and the lamp holders 3112 and 3113 are electrically connected to the feed terminals 3104 and 3108.

A width F1 of a holding part of the lamp holder 3112 on the high voltage side is set to be substantially the same as a width F2 of a holding part of the lamp holder 3113 on the low voltage side.

In the embodiment 5-1, the area of contact between the case 3009 and the bushing 3021 provided on the high voltage side of the discharge lamp 3008 is larger than the area of contact between the case 3009 and the bushing 3022 provided on the low voltage side thereof, so as to increase the amount of heat conduction from the discharge lamp 3008 to the case 3009.

Therefore, in the embodiment 5-2, the size of each of the feed terminals (3104, 3108) provided at the respective ends of the discharge lamp (3101) may be the same, and the width F1 of the holding part of the lamp holder 3112 on the high voltage side may be wider than the width F2 of the holding part of the lamp holder 3113 on the low voltage side, in the same manner as the embodiment 5-1. This makes it possible to increase the amount of heat conducted from the feed terminal 3104 to the lamp holder 3112 (in other words, the heat resistance is smaller on the high voltage side than the low voltage side). As a result, a rise in the temperature of the electrode (3107) on the high voltage side can be prevented, thereby minimizing a difference between the temperature of the electrode (3107) on the high voltage side and that of the electrode (3103) on the low voltage side.

Also, in the embodiment 5-2, the feed terminals 3104 and 3108 are formed with solder. However, it is possible to use a metal cap instead of solder.

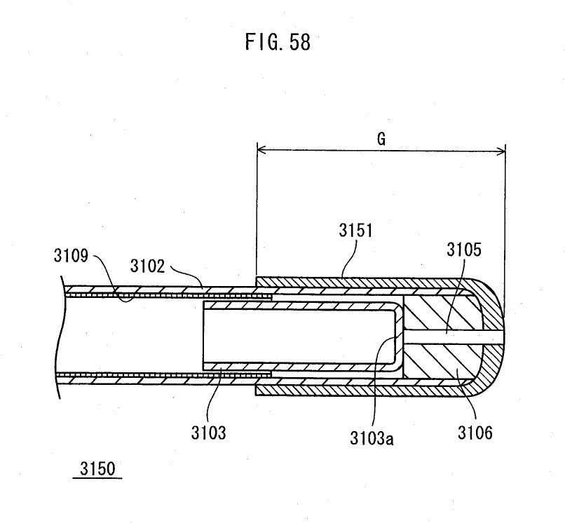

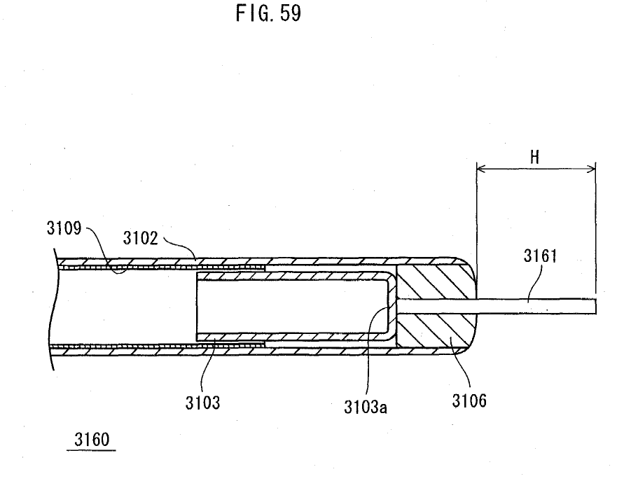

FIG. 58 shows a modification (1) of the embodiment 5-2.

In the discharge lamp 3150, one end of the glass tube 3102 is sealed with the bead glass 3106, with the lead wire 3105 that is welded to the bottom 3103a of the electrode 3103 being inserted through a substantially through hole of the bead glass 3106. The one end of the glass tube 3102 is provided with a metal cap 3151 (equivalent to the “covering member” in the present invention) that covers the end, and that connects to the lead wire 3106. A length G of the metal cap 3151 on the high voltage side is longer than that of the metal cap 3151 on the low voltage side.

Even when such metal caps are used, the amount of heat emission of the electrode on the high voltage side is larger than that of the electrode on the low voltage side (in other words, the heat resistance on the high voltage side is smaller than the low voltage side), whereby a rise in the temperature of the electrode on the high voltage side can be prevented. Note that the metal cap can be made of a material such as silver (Ag), copper (Cu), Gold (Au), Aluminum (Al), or an alloy of these metals.

Also, in the modification (1), a structure that utilizes the heat emission of the metal cap is adopted as the heat release structure. However, it is possible to adopt a structure that uses other members to emit the heat of the electrode to the outside air. Note that, in the modification (1), the metal cap is used as the cover member according to the present invention. However, the same effect as the metal cap can be obtained with a metal sleeve, as long as the metal sleeve is thermally and directly bonded to the lead wire. In other words, the covering member may have any shape, as long as the covering member is thermally connected to the lead wire and is exposed to the outside air.

FIG. 59 shows a modification (2) of the embodiment 5-2.

In the discharge lamp 3160, the lead wire 3161 that is bonded to the bottom 3103a of the electrode 3103 extends from the end of the glass tube (including the bead glass) 3102. In the modification (2), a structure is adopted in which the heat of the electrode 3103 is emitted to the outside air via the lead wire 3161. As for a length H of each lead wire connected to the respective electrodes (3103), the length H of the lead wire on the high voltage side is longer than that of the lead wire on the low voltage side. In other words, the area that is exposed to the outside air is larger in the lead wire on the high voltage side than the lead wire on the low voltage side.

The present invention has been explained based on various embodiments, but the present invention are of course not limited to the embodiments described above. For example the following variations are possible.

1. Kinds of Discharge Lamp

In the above-described embodiments, the discharge lamp includes electrodes of a cold cathode type that are each provided inside the respective ends of the glass tube. However, it is possible to use a discharge lamp of a different kind.

A discharge lamp of a different kind may be a so-called external electrode discharge lamp, which includes an electrode provided on the outer periphery of each end of the glass tube. In this case, the side of the external electrode is the high voltage side, and the side of the cold cathode electrode described in the above-described embodiment is the low voltage side.

2. Shape of Discharge Lamp

In the above-described embodiments, the glass tube of the discharge lamp has a straight tube shape. However, the glass tube thereof may of course have another shape. For example, the glass tube may have a squared U-shape, a U-shape, an L-shape, a V-shape, or a ring shape.

Furthermore, the shapes of the cross sections of the glass tube may be substantially the same or may be different in the lengthwise direction. When different, the shape of the cross section in a part where the electrode is provided may be circular, and the shape of the cross section in the middle part of the discharge lamp where the electrode is not provided may be flat, and vice versa. It is also possible that the shapes of the cross sections are polygonal.

3. Structure of Electrode of Discharge Lamp

In the above-described embodiment, the electrodes are made of niobium. However, it is possible to use a material other than niobium. For example, the electrodes may be made of nickel (Ni), tantalum (Ta), molybdenum (Mo), etc. In particular, it is preferable that the electrodes are made of a material having high heat conductivity. Materials having high heat conductivity include molybdenum (138 [W/m·K]), niobium (53.7 [W/m K]), nickel (90.5 [W/m·K]), etc.

Also, a material of the electrode on the high voltage side maybe different from a material of the electrode on the low voltage side. Note that when different materials are used, for example, in a case where nickel and niobium are used for the electrodes, the discharge lamp can be formed at lower cost than the discharge lamp formed with only niobium. However, the cathode fall voltage becomes different between the high voltage side and the low voltage side, causing a problem where a direct-current bias is superimposed on the lamp current (alternating-current). In this case, a reverse bias can be applied to the lighting circuit that is for lighting the discharge lamp in advance, so that the direct-current component becomes 0. This makes it possible to eliminate the imbalance of mercury in the discharge space (in other words, occurrence of the cataphoresis phenomenon can be prevented).

Furthermore, in a case where a different material is used for each one of an electrode pair, a material having a high melting point may be used for the electrode on the high voltage side. Specifically, it is possible to use niobium or molybdenum for the electrode on the high voltage side, and nickel for the electrode on the low voltage side.

The above-described case also causes a problem of the occurrence of the direct-current bias. However, the problem can be solved with use of the reverse bias, as described above. Also, the electrode on the high voltage side may be made of niobium or molybdenum that has a small cathode fall voltage and that is resistant to sputtering, so as to prevent the electrode on the high voltage side that has a large lamp current from being worn out due to sputtering, resulting in preventing a rise in the temperature of the electrode. It is also possible in this case to obtain a discharge lamp at low cost by using nickel for the electrode on the low voltage side.

4. Heat Release Structure

As a structure for releasing heat from the electrodes, the embodiment 5-1 utilizes a heat conduction mechanism in which the heat of the electrodes is conducted toward the case, and the embodiment 5-2 utilizes a heat emission mechanism in which the heat of the electrodes is emitted from the feed terminals or the metal caps.

However, it is possible to combine these mechanisms. For example, it is possible to cover, with the bushings, the solder layers or the metal caps that are formed at the respective ends of the glass tube. Conversely, it is possible to cover, with metal, the bushings that cover the ends of the glass tube. It is of course possible to combine the contents described in the modifications of the embodiment 5 described above.

The above describes the present invention based on the embodiments 1-5. However, the present invention is of course not limited to the embodiments described above. Any combination of the components described in the embodiments 1-5 is possible for forming the fluorescent lamp, the backlight unit, and the liquid crystal display device.

### INDUSTRIAL APPLICABILITY

The present invention provides a fluorescent lamp whose high color reproducibility does not deteriorate even after the light of the lamp has transmitted through the color filters of a liquid crystal display device, etc. It is possible to provide a display device having high color reproducibility, by forming a light emitting device with use of a plurality of the fluorescent lamps of the present invention and using the light emitting device for the liquid crystal display device, etc.

1. A fluorescent lamp having a glass container that has a phosphor layer formed on an inner surface of the glass container, and that is hermetically sealed, wherein
phosphors of the phosphor layer include a blue phosphor, a green phosphor, and a red phosphor, a main luminescence peak of the blue phosphor exists in a wavelength region in a range of 430 nm to 460 nm inclusive, a half-value width of a spectrum of the main luminescence peak of the blue phosphor is less than or equal to 50 nm, a main luminescence peak of the green phosphor exists in a wavelength region in a range of 510 nm to 530 nm inclusive, a half-value width of a spectrum of the main luminescence peak of the green phosphor is less than or equal to 30 nm, and a main luminescence peak of the red phosphor exists in a wavelength region in a range of 600 nm to 780 nm inclusive, and
a difference between a wavelength of the main luminescence peak of the blue phosphor and a wavelength of the main luminescence peak of the green phosphor is in a range of 70 nm to 90 nm inclusive.

2. The fluorescent lamp of claim 1, wherein
the green phosphor is an europium-and-manganese-activated barium magnesium aluminate, and a mole ratio of europium and manganese that are included in the europium-and-manganese-activated barium magnesium aluminate is in a range of 4:6 to 1:9 inclusive.

3. The fluorescent lamp of claim 1, wherein
each of the red phosphor, the green phosphor, and the blue phosphor is composed of a plurality of particles, and
particles included in at least one of the blue phosphor, the green phosphor, and the red phosphor are each covered with an yttrium oxide or a lanthanum oxide.

4. The fluorescent lamp of claim 1, comprising
a conductive film that has been formed on an outer surface of the glass container, wherein
the conductive film is a fired material applied to the outer surface of the glass container, the fired material obtained by firing a paste and including (i) one of mixed metal powder and atomized alloy powder and (ii) glass frit, the mixed metal powder including aluminum powder as a primary material and silver powder as a secondary material, the atomized alloy powder including aluminum as a main component and silver as a secondary component.

5. The fluorescent lamp of claim 4, wherein
the conductive film includes silver in a range of 6 to 40 [Wt %] inclusive.

6. The fluorescent lamp of claim 1, wherein
the glass container is made of soft glass.

7. The fluorescent lamp of claim 1, wherein
each of the red phosphor, the green phosphor, and the blue phosphor is composed of a plurality of particles, and
in an x-y Cartesian coordinate system in which a horizontal axis x represents a diameter [μm] of each blue phosphor particle and a vertical axis y represents a volume percent [%] of said each blue phosphor particle in a total of the blue phosphor,
the blue phosphor has a particle size distribution represented by a graph that
intersects with a first curve represented by y=−0.000007x6+0.0008x5−0.0368x4+0.8326x3−9.1788x2+38.889x+7.092 in a range where x is greater than or equal to 10.8,
passes through a region surrounded by the first curve and a second curve represented by y=0.0457x2−2.4896x+33.294, and
converges on the horizontal axis x in a range of substantially 14≦x≦20.

8. The fluorescent lamp of claim 1, wherein
each of the red phosphor, the green phosphor, and the blue phosphor is composed of a plurality of particles, and
the blue phosphor includes 19 [volume %] of blue phosphor particles that each have a diameter in a range of 10 [μm] to 30 [μm] inclusive, in a total of the blue phosphor.

9. The fluorescent lamp of claim 1 comprising
an infrared cut film that has been formed on a wall surface of the glass container,
wherein
the glass container is in a shape of a tube whose inner diameter is in a range of 2 mm to 7 mm inclusive, and is filled with a mixed gas of argon and neon, the argon included in a range of 10% to 20% inclusive,
the infrared cut film is a λ/4 multilayer film that reflects light in an infrared wavelength region, and that transmits light in a visible wavelength region.

10. The fluorescent lamp of claim 9, wherein
the infrared cut film has been formed by alternately laminating a low refractive material and a high refractive material, the low refractive material being one of silicon oxide and magnesium fluoride, and the high refractive material being one of tantalum oxide, titanium oxide, magnesium oxide, zirconium oxide, silicon nitride, aluminum oxide, and hafnium oxide.

11. The fluorescent lamp of claim 10, wherein
each end of the glass container, which has the phosphor layer formed on the inner surface of the glass container, is provided with a different one of electrodes, a high voltage is applied to one of the electrodes, and a low voltage is applied to an other one of the electrodes, and
each end of the fluorescent lamp has a heat release structure that releases heat from the respective electrodes, a heat resistance of the heat release structure on a side of the electrode to which the high voltage is applied is smaller than a heat resistance of the heat release structure on a side of the electrode to which the low voltage is applied.

12. The fluorescent lamp of claim 10 further comprising
bushings each of which covers a periphery portion of a different one of electrodes in the glass container, and fixes the discharge lamp to a fixing apparatus, wherein
a heat release structure releases heat by conducting the heat from the bushings to the fixing apparatus, and
an area of contact between one of the bushings and the fixing apparatus is larger than an area of contact between an other one of the bushings and the fixing apparatus, the one of the bushings being on a side of the electrode to which a high voltage is applied, and the other one of the bushings being on a side of the electrode to which a low voltage is applied.

13. The fluorescent lamp of claim 10, further comprising
covering members each of which covers a periphery portion of a different one of electrodes in the glass container, wherein
a heat release structure releases heat by emitting the heat from the covering members to an outside air, and
an area of the heat emission of one of the covering members is larger than an area of the heat emission of an other one of the covering members, the one of the covering members being on a side of the electrode to which a high voltage is applied, the other one of the covering members being on a side of the electrode to which a low voltage is applied.

14. The fluorescent lamp of claim 10, further comprising
lead wires made of metal, each of which is connected to a different one of electrodes and extends from a different one of ends of the glass container, wherein
a heat release structure releases heat by emitting the heat from a portion of each lead wire to an outside air, each of the portions positioned outside the glass container, and
an area of the heat emission of one of the lead wires is larger than an area of the heat emission of an other one of the lead wires, the one of the lead wires being on a side of the electrode to which a high voltage is applied, the other one of the lead wires being on a side of the electrode to which a low voltage is applied.

15. A light emitting device comprising a plurality of the fluorescent lamps according to claim 1.

16. A display device including a screen unit and the light emitting device according to claim 15.
